(19) United States
(12) Patent Application Publication
(10) Pub. No.: US 2025/0191135 A1
(43) Pub. Date: Jun. 12, 2025

(54) SYSTEMS FOR SOFTWARE-DEFINED TELESCOPES

(71) Applicant: ExoAnalytic Solutions, Inc., Foothill Ranch, CA (US)

(72) Inventors: Douglas Lee Hendrix, Ladera Ranch, CA (US); William Alexander Therien, Upland, CA (US)

(21) Appl. No.: 19/061,887

(22) Filed: Feb. 24, 2025

Related U.S. Application Data
(63) Continuation of application No. PCT/US2023/031763, filed on Aug. 31, 2023.
(60) Provisional application No. 63/403,646, filed on Sep. 2, 2022.

(51) Int. Cl. G06T 5/50; G06T 5/70; G06T 7/246; G06T 7/292

(52) U.S. Cl. CPC G06T 5/50; G06T 5/70; G06T 7/246; G06T 7/292; G06T 2200/24; G06T 2207/10032; G06T 2207/20092; G06T 2207/30204; G06T 2207/30241

(57) ABSTRACT

A system can use a plurality of co-located telescopes to generate enhanced telescopic imagery of space objects. The system may be configured to receive telescopic imagery data of a plurality of space objects obtained from the plurality of co-located telescopes. The system can receive at least two imaging criteria. The available imaging criteria can include a target signal sensitivity comprising a minimum signal to noise ratio (SNR), a target number of spectral bands comprising a minimum number of spectral bands, a spectral range associated with one or more of the spectral bands, a location of the plurality of co-located telescopes, a target data cadence comprising a minimum number of frames per minute, a target number of space objects to be tracked, a target minimum spatial resolution, among others. The system can transmit instructions to the plurality of telescopes and generate enhanced telescopic imagery.

### INCORPORATION BY REFERENCE OF RELATED APPLICATIONS

This application claims the benefit of priority under 35 U.S.C. § 111(a) to International Application No. PCT/US2023/031763, filed on Aug. 31, 2023, which claims the benefit under 35 U.S.C. § 119(e) of U.S. Provisional Patent Application Nos. 63/403,646, filed Sep. 2, 2022. The entire contents of these applications are incorporated by reference herein and are made a part of this specification.

### BACKGROUND

### Field

This disclosure relates generally to tracking space objects such as satellites and visual interfaces and computer configurations used in such tracking.

### Description of Related Art

Visualization interfaces can be used to allow a user to view, manipulate, and adjust data representing tracked orbital objects (e.g., satellites). Tracking orbital objects involves taking in an amount of data and incorporating that data into a workable and usable interface.

Tracking orbital objects may be done using photographs of objects in space and tracking their positions using a plurality of photographs. Visualization systems have been developed in various fields that provide some functionality with regard to portraying various information. However, many features are lacking and many problems exist in the art for which this application provides solutions.

### SUMMARY

Example embodiments described herein have innovative features, no single one of which is indispensable or solely responsible for their desirable attributes. Without limiting the scope of the claims, some of the advantageous features will now be summarized.

In some embodiments, a system for determining and displaying path parameters can include a display interface. The display interface can be configured to receive, via a user interface, a first identifier associated with a first space object and determine a first maneuver of the first space object. The first maneuver can include a perturbation of the path of the first space object. Based on the first identifier and the first maneuver, the display system can identify one or more path parameters associated with a path of the first space object and generate a display interface. The display interface can include a longitude-time graph having a longitude axis spanning from a lower-longitude limit to an upper-longitude limit and a time axis spanning from the lower-time limit to the upper-time limit and an indication of the one or more path parameters.

### BRIEF DESCRIPTION OF THE DRAWINGS

The following drawings and the associated descriptions are provided to illustrate embodiments of the present disclosure and do not limit the scope of the claims.

FIG. 1A schematically shows a network configuration that allows for the passing of data to a visualization system.

FIG. 1B shows a schematic of an example visualization display.

FIG. 2 shows an example visualization display with a longitude-time graph, scalar-time graph, a longitude-latitude graph, and a display area.

FIG. 3 shows a detail view of an example longitude-time graph that may be a part of the visualization display described in FIG. 2.

FIG. 4 shows a detail view of an example longitude-latitude graph that may be a part of the visualization display described in FIG. 2.

FIG. 5 shows a detail view of an example scalar-time graph that may be a part of the visualization display described in FIG. 2.

FIG. 6 shows a zoomed-in and panned view of the visualization display of FIG. 2.

FIG. 7 shows the same view as FIG. 6 after the first longitude axis and the synchronized second longitude axis have been zoomed in.

FIG. 8 shows the same view as FIG. 7 after the first time axis and the synchronized second time axis have been zoomed in.

FIG. 9 shows a zoomed-in and panned view of a longitude-time graph and scalar-time graph at a current time horizon.

FIG. 10A shows a tagging interface comprising a stitching tool interface and an analysis plot interface.

FIG. 10B shows a selection by a user of a collection of first longitude-time source points.

FIG. 10C shows a selection by a user of a collection of second longitude-time source points.

FIG. 10D shows the visualization display of FIG. 10C after a user has selected the stitch selector.

FIG. 11 shows a representation of an orbit of a space object superimposed on a longitude-time graph and longitude-latitude graph.

FIG. 12 shows the visualization display of FIG. 11 with highlighted longitude-time points and longitude-latitude points indicating a selection of multiple tracks associated with a space object.

FIG. 13 shows a visualization display comprising a photograph selected from a set of photographs based on a specified latitude range, a specified longitude range, and a specified time range.

FIG. 14 shows the visualization display of FIG. 13 comprising a photograph modified relative to the photograph shown in FIG. 13.

FIG. 15 shows a visualization display comprising an indication of a user-selected primary object in a photograph.

FIG. 16 shows a visualization display comprising an indication of a secondary object detected by a space object detection system.

FIG. 17 shows a visualization display comprising a plurality of tracks selected by a user.

FIG. 18 shows a visualization display comprising an orbit of a space object determined using a destination track and source tracks.

FIG. 19 shows a visualization display comprising longitude, time, and selected track labels.

FIG. 20 shows a visualization display comprising selected tracks of a space object, an orbit for the space object, and a graph of residuals between the selected tracks and the orbit.

FIG. 21 shows an interface displaying an initial track.

FIG. 22 shows an interface displaying an initial track and a target track.

FIG. 23 shows an interface displaying an initial track, a target track, and a transfer selection interface.

FIG. 24 shows an example intercept transfer via the user interface.

FIG. 25 shows an example rendezvous transfer via the user interface.

FIG. 26 shows a characterization of a maneuver that has moved an object from a first path to a second path.

FIG. 27 shows a panned and zoomed display of FIG. 24.

FIG. 28 shows a panned and zoomed display of FIG. 25.

FIG. 29 shows a panned and zoomed display of FIG. 26.

FIG. 30 shows another example rendezvous transfer via the user interface.

FIG. 31 shows another example rendezvous transfer between the same orbits as shown in FIG. 30 but with different time constraints.

FIG. 32 shows an example visualization with a proximity spot report and a maneuver spot report.

FIG. 33 shows two example conjunction spot reports within a visualization display.

FIG. 34 shows an example first proximity spot report showing a conjunction between Satellite A and Satellite B.

FIG. 35 shows a second proximity spot report in response to a maneuver performed by Satellite C.

FIG. 36 shows an example telescopic imagery system.

FIG. 37 shows an example co-located telescope network that includes a plurality of sensors.

FIG. 38 schematically shows a cross section of an example sensor, such as is shown in FIG. 37.

FIG. 39 shows an example method performed by one or more of the systems described herein.

FIG. 40 shows an example method that may be performed by one or more of the systems described herein, according to some embodiments.

FIG. 41 shows an example of converting raw images into a stacked image. The raw images 1604 can be obtained by one or more sensors, such as telescopes.

FIG. 42A shows a plurality of images of one or more RSOs along an orbit of a region of space, as indicated by an orbit indicator.

FIG. 42B shows another aspect of the graphical user interface shown in FIG. 42A.

FIG. 42C shows another aspect of the graphical user interface shown in FIG. 42A.

FIG. 43 shows an example method performable by a system herein, such as the telescopic imagery system and/or the visualization system.

FIG. 44 shows another example method, according to some embodiments.

FIG. 45 shows another example method, according to some embodiments.

FIG. 46 shows another example method, according to some embodiments.

FIG. 47 shows another example method, according to some embodiments.

FIG. 48 shows another example method, according to some embodiments.

FIG. 49 shows another example method, according to some embodiments.

FIG. 50 shows another example method, according to some embodiments.

FIG. 51 shows another example method, according to some embodiments.

These and other features will now be described with reference to the drawings summarized above. The drawings and the associated descriptions are provided to illustrate embodiments and not to limit the scope of any claim. Throughout the drawings, reference numbers may be reused to indicate correspondence between referenced elements. In addition, where applicable, the first one or two digits of a reference numeral for an element can frequently indicate the figure number in which the element first appears.

### DETAILED DESCRIPTION

Although certain embodiments and examples are disclosed below, inventive subject matter extends beyond the specifically disclosed embodiments to other alternative embodiments and/or uses and to modifications and equivalents thereof. Thus, the scope of the claims appended hereto is not limited by any of the particular embodiments described below. For example, in any method or process disclosed herein, the acts or operations of the method or process may be performed in any suitable sequence and are not necessarily limited to any particular disclosed sequence. Various operations may be described as multiple discrete operations in turn, in a manner that may be helpful in understanding certain embodiments; however, the order of description should not be construed to imply that these operations are order dependent. Additionally, the structures, systems, and/or devices described herein may be embodied as integrated components or as separate components. For purposes of comparing various embodiments, certain aspects and advantages of these embodiments are described. Not necessarily all such aspects or advantages are achieved by any particular embodiment. Thus, for example, various embodiments may be carried out in a manner that achieves or optimizes one advantage or group of advantages as taught herein without necessarily achieving other aspects or advantages as may also be taught or suggested herein.

Described herein are methodologies and related systems for visualizing data (e.g., tracks, orbits, photographs, measurements, maneuvers, transfer actions, etc.) from tracked satellites and other space objects. It will be understood that although the description herein is in the context of satellites, one or more features of the present disclosure can also be implemented in tracking objects other than satellites like, for example, aircraft, watercraft, projectiles, and other objects. Some embodiments of the methodologies and related systems disclosed herein can be used with various tracking systems, including, for example, those based on government databases.

Unless explicitly indicated otherwise, terms as used herein will be understood to imply their customary and ordinary meaning.

Disclosed herein are methods and systems relating generally to the tracking of objects in orbit (e.g., satellites), other space objects, and related systems and methods of providing an interactive user interface to interact with data related to the tracking of these objects. The information therein can be stored in one or more databases (e.g., as an ephemeris).

Tracking objects in orbit and other space objects can include receiving image data (e.g., photographs) of portions of the sky from one or more sensors, such as telescopes, positioned at various positions across the globe. For example, the data may be collected from a network of telescopes (e.g., over 300 telescopes) that includes telescopes on every populated continent. The photograph data can be used to map out the entirety or near entirety of the sky. Various altitudes above sea level may be tracked. The data can be tracked and processed in real-time. For example, a contemporary database may be configured to receive real-time image data. Images collected by the telescopes may be processed in situ with observations being received with a latency of less than about 1 minute and within about 15-30 seconds in some embodiments. A historical database may be configured to store data received before a threshold time. The threshold time may be a specified amount of time (e.g., years, months, days, etc.). Alternatively, the threshold time may refer to a time based on a user action. For example, the historical database may be configured to store data received before a user causes the system to display the user interface. Using an algorithm, the received data may be consolidated and categorized. For example, the algorithm may be configured to determine whether objects that appear in a plurality of photographs correspond to the same object over time and space. A gap in exposure of certain objects may be small. For example, a mean solar exclusion gap may be less than about 7 hours and may be about 6 hours in some embodiments. The term “about” may refer to a slight margin above or below the value. The margin value may be 5% or 10%, depending on the level of specificity of the value.

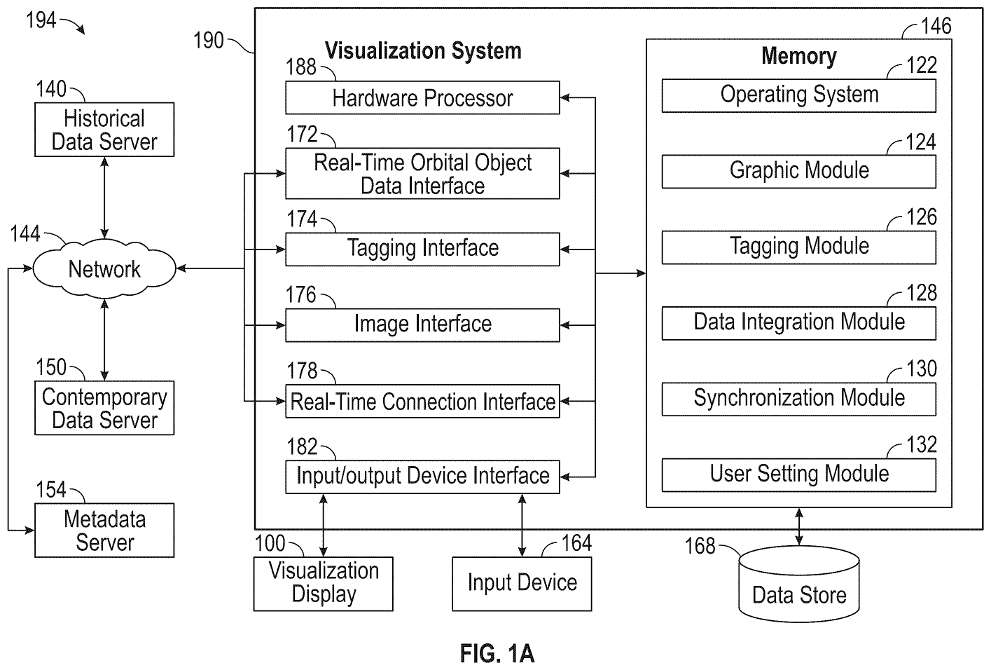

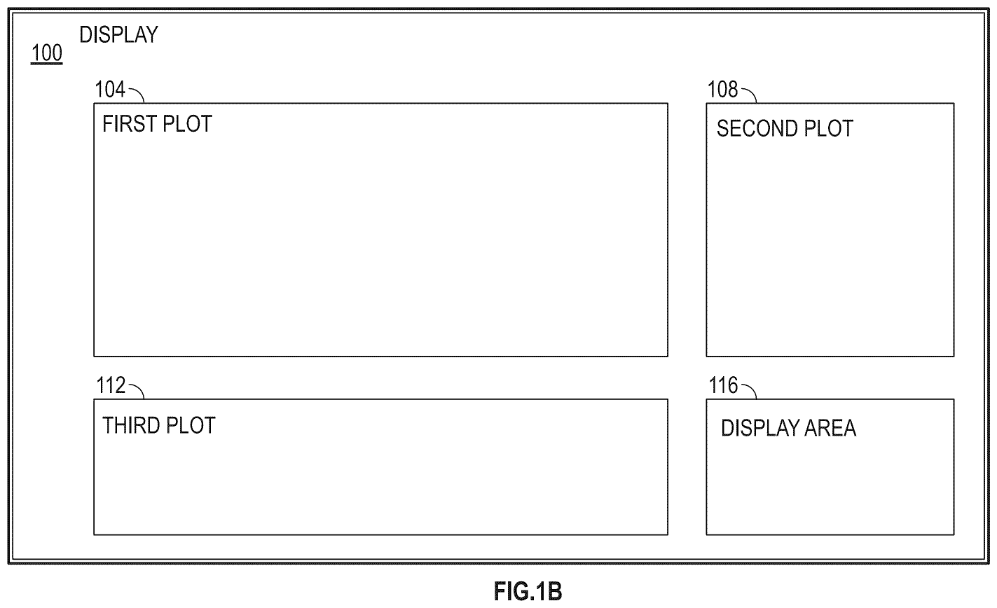

FIG. 1A is an example network configuration 194 for a visualization system 190. The architecture of the visualization system 190 can include an arrangement of computer hardware and software components used to implement aspects of the present disclosure. The visualization system 190 may include more or fewer elements than those shown in FIG. 1A. It is not necessary, however, that all of these elements be shown in order to provide an enabling disclosure. In some embodiments, the visualization system 190 is an example of what may be referred to under different names.

As illustrated, the visualization system 190 can include a hardware processor 188, a memory 146, a real-time orbital object data interface 172, a tagging interface 174, a image interface 176, a real-time connection interface 178, and/or an real-time connection interface 178, each of which can communicate with one another by way of a communication bus 142 or any other data communication technique. The hardware processor 188 can read and write to the memory 146 and can provide output information for the visualization display 100. The real-time orbital object data interface 172, tagging interface 174, image interface 176, and/or real-time connection interface 178 can be configured to accept input from an input device 164, such as a keyboard, mouse, digital pen, microphone, touch screen, gesture recognition system, voice recognition system, and/or another input device capable of receiving user input. In some embodiments, the visualization display 100 and the input device 164 can have the same form factor and share some resources, such as in a touch screen-enabled display.

In some embodiments, the real-time orbital object data interface 172, the tagging interface 174, the image interface 176, and/or the real-time connection interface 178 can be connected to a historical data server 140, a contemporary data server 150, and/or a metadata server 154 via one or more networks 144 (such as the Internet, 3G/Wi-Fi/LTE/5G networks, satellite networks, etc.). The real-time orbital object data interface 172 can receive graphical data information related to orbital objects via the network 144 (the network 144 can provide one-way communication or two-way communication). In some embodiments, the real-time orbital object data interface 172 may receive, where applicable, object data information or information that can be used for location determination (such as a cellular and/or Wi-Fi signal that can be used to triangulate a location) and determine the position of one or more objects.

The tagging interface 174 can receive tagging data from a user via the input/output device interface 182. The metadata server 154 can provide an application programming interface (API) that the tagging interface 174 can access via the network 144 (such as, for example, a 3G, Wi-Fi, LTE, or similar cellular network). The metadata server 154 may comprise data from one or more third-party providers. For example, the metadata server 154 may comprise government information (e.g., received from a United States Air Force satellite database). The image interface 176 may receive track information (such as, for example, an ordered list of known location coordinates) from a historical data server 140, contemporary data server 150, and/or metadata server 154 via the network 144. The track information can also include track-related information, such as photos, videos, or other data related to orbiting objects. In some embodiments, instead of receiving the track information over a network 144 from a historical data server 140, the system can receive such track information from a user via a computer-readable storage device, such as, for example, a USB thumb drive. The image interface 176 can also receive images (e.g., photographs, video) from a contemporary data server 150. In some embodiments, the map data can provide longitude, latitude, altitude information, and any other information related to orbiting objects.

The memory 146 can contain computer program instructions (grouped as modules or components in some embodiments) that the hardware processor 188 can execute in order to implement one or more embodiments described herein. The memory 146 can generally include RAM, ROM and/or other persistent, auxiliary or non-transitory computer-readable media. The memory 146 can store an operating system 122 that provides computer program instructions for use by the hardware processor 188 in the general administration and operation of the visualization system 190.

The memory 146 can include computer program instructions and other information for implementing aspects of the present disclosure including a graphic module 124, a tagging module 126, a data integration module 128, a synchronization module 130, a user settings module 132, other modules, and/or any combination of modules.

In some embodiment, the memory 146 may include the graphic module 124 that generates a track from the received ordered list of known locations using algorithms, such as interpolation or extrapolation algorithms. Additionally, the graphic module 124 may, in response to a user determination, alter the format (e.g., axes, labels, values) of the graphical display. Examples of functionality implemented by the graphic module 124 are more fully described, for example, with reference to FIGS. 1A-5.

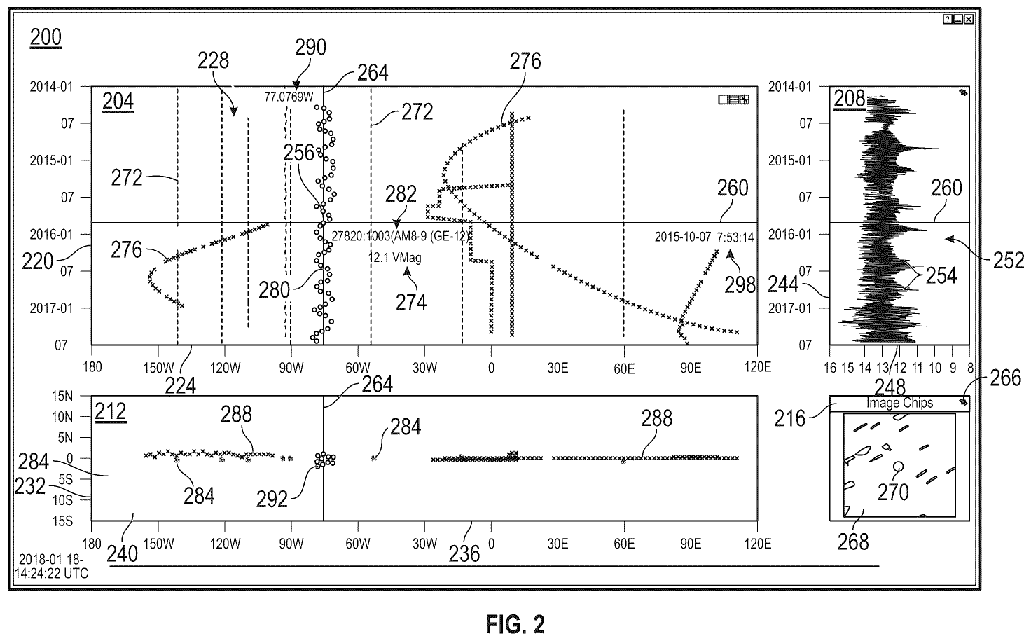

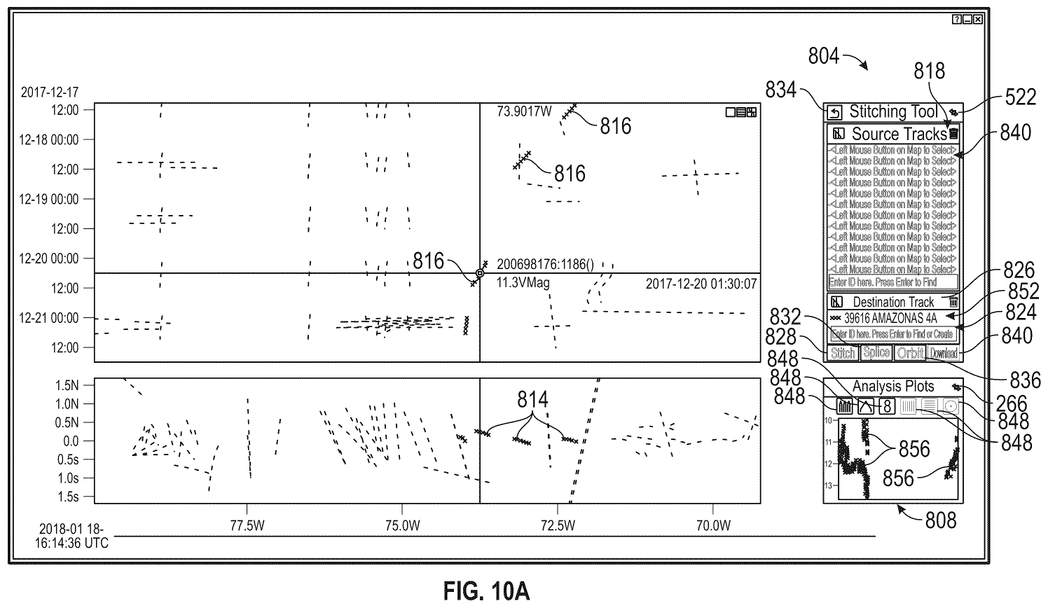

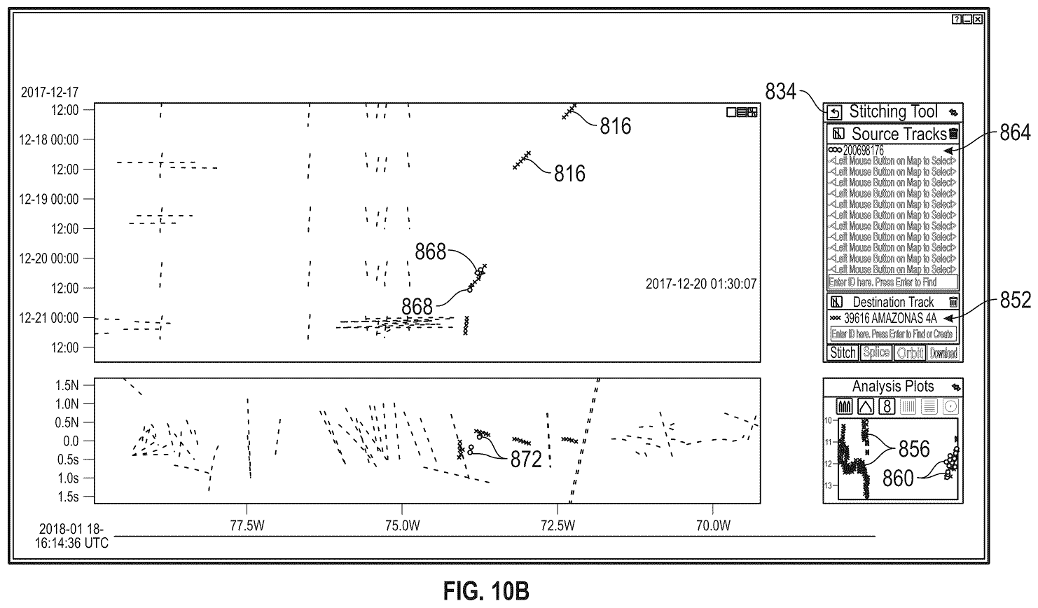

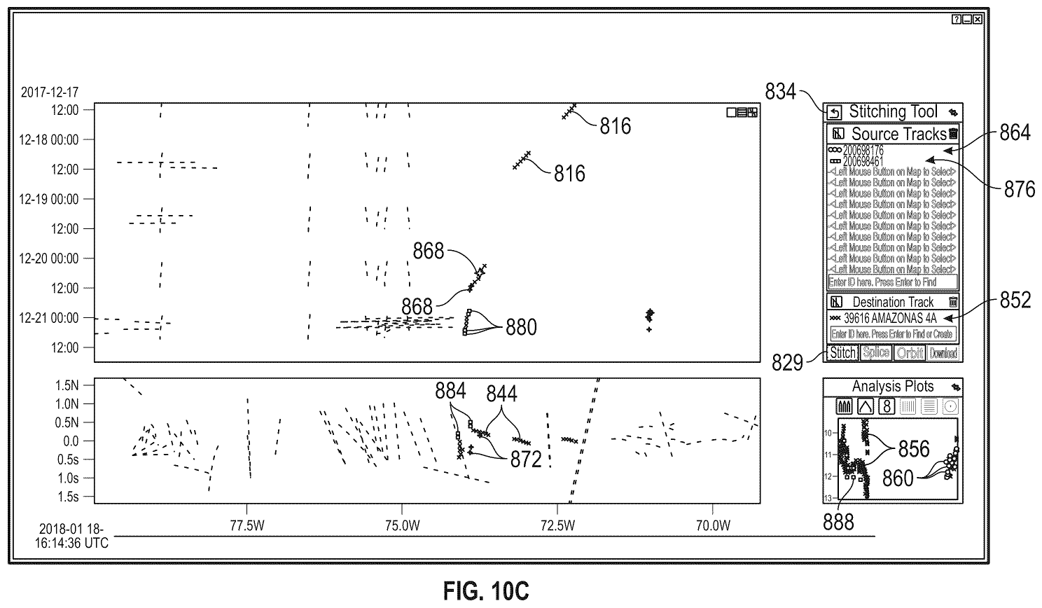

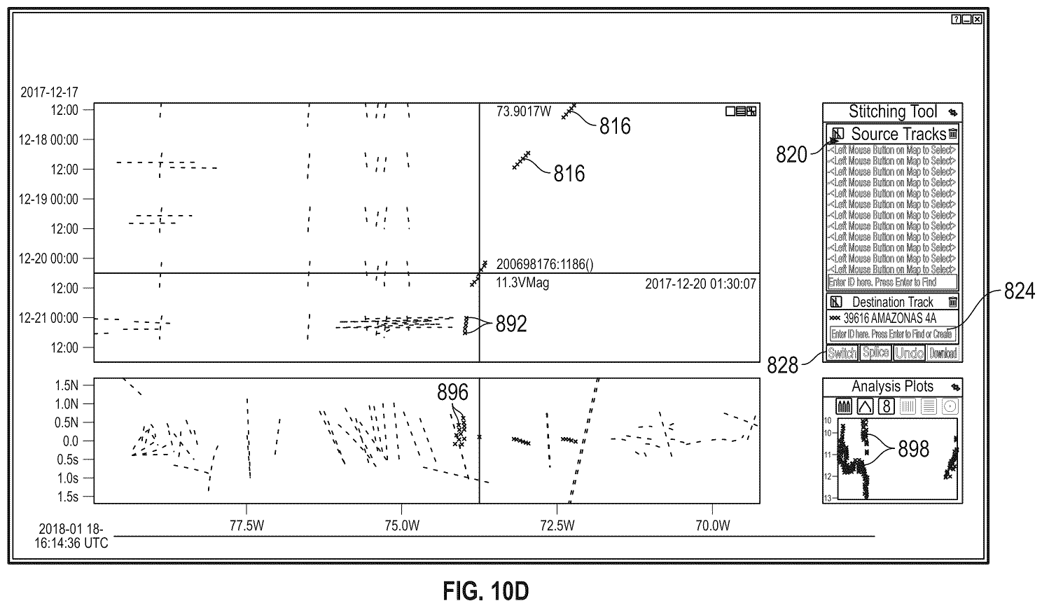

In some embodiments, the memory 146 includes a tagging module 126 that the hardware processor 188 executes in order update, in response to a user action, aspects (e.g., metadata, values) of the underlying data. Accordingly, the tagging module 126 can provide data (e.g., updates) to the synchronization module 130. Examples of functionality implemented by the tagging module 126 are more fully described, for example, with reference to FIGS. 10A-10D. The data integration module 128 can correlate various data automatically or in response to a user input. For example, the data integration module 128 can combine data from the one or more servers (e.g., the historical data server 140, the contemporary data server 150, and the metadata server 154) that may be used for displaying on the visualization display 100. Examples of functionality implemented by the data integration module 128 are more fully described, for example, with reference to FIGS. 2-9.

In some embodiments, the memory 146 includes a synchronization module 130 that can be configured to correlate various aspects of data from the one or more servers. For example, the synchronization module 130 can be configured to synchronize the display of a data set on multiple graphs or to synchronize elements (e.g., axes, labels, dimensions, alignments, etc.) of one or more graphs of the visualization display 100. The synchronization module 130 can update data based on inputs from the tagging module 126 (such as stitched objects or elements), guidance parameters from the user settings module 132, and/or inputs from the data integration module 128. Examples of functionality implemented by the synchronization module 130 are more fully described, for example, with reference to FIGS. 2-9.

In some embodiments, the memory 146 includes a user settings module 132. The user settings module 132 can provide access to various user settings related to user preferences, including graph parameters, graph configurations (e.g., layout, orientation, formatting, etc.) and modes (e.g., display mode, tag mode, etc.). For example, the threshold values used for determination of the direction guidance mode may be accessed through the user settings module 132. In some instances, the user settings module 132 may provide connectivity to a data store 168 and access user settings from or store user settings to the data store 168. Examples of functionality implemented by the user settings module 132 are more fully described, for example, with reference to FIGS. 2-10D. In some embodiments, other interfaces and modules, such as the real-time orbital object data interface 172, the tagging interface 174, the image interface 176, real-time connection interface 178, and/or input/output device interface 182 may have access to the data store 168.

The historical data server 140 may communicate via the network 144 with a historical data interface. The historical data interface may include one or more of the real-time orbital object data interface 172, the tagging interface 174, the image interface 176, and the real-time connection interface 178. The historical data interface may be configured to receive historical data of objects in orbit around a planet from a historical data set. The historical data may comprise a time, a latitude, a longitude, a scalar, and/or an object identifier (e.g., name) for each object. The historical data can comprise data collected over a period of time greater than a threshold time (e.g., a year).

The amount of historical data can be unusually immense. For example, the amount of historical data may include billions of data identifiers derived from petabytes or even exabytes of photographic data. The historical data obtained may be increasing over time. Such an immense amount of data can cause serious challenges related to, for example, maintaining, sorting, extracting, transmitting, and/or displaying that data, particularly in a timely and organized fashion. This data may be supplemented from other databases (e.g., the metadata server 154), such as third-party databases. Such third-party databases may include government organizations, such as military groups (e.g., the United States Air Force), but may include private (e.g., commercial) sources additionally or alternatively.

The contemporary data server 150 may communicate via the network 144 with a real-time (e.g., contemporary) data interface configured to receive contemporary data of objects in orbit around a planet from a contemporary data set. The contemporary data may comprise a time, a latitude, a longitude, an object identifier, and/or a scalar for each object. The contemporary data may comprise data collected after the historical data available from the historical data set. The contemporary data may include data received within a few minutes or even seconds of a current time. The contemporary data may be data stored after a user has initiated a particular action, such as causing the system to generate a visualization display 100. In such a case, the system can be configured to update the visualization display 100 with pixels associated with the data collected after the generation of the visualization display 100.

FIG. 1B shows a schematic of an example visualization display 100. Such a visualization display 100 may operate within the network configuration 194 of FIG. 1A, for example. The visualization display 100 may be displayed on any type of digital display device, such as a desktop computer, a laptop computer, a projection-style device, a smartphone, a tablet, a wearable device, or any other display device. The visualization display 100 may include a first plot 104, a second plot 108, a third plot 112, and/or a display area 116.

The first plot 104 and second plot 108 may be displayed with similar (e.g., within a few pixels) vertical dimensions and/or similar vertical alignment. For example, the first plot 104 may be disposed directly left of the second plot 108. The third plot 112 may have similar vertical dimensions and/or similar vertical alignment as the display area 116. The first plot 104 may have similar horizontal dimensions and/or similar horizontal alignment as the third plot 112. In some embodiments, the second plot 108 may have similar horizontal dimensions and/or similar horizontal alignment as the display area 116. In some designs, the second plot 108 may include a tagging interface (e.g., a stitching and/or splicing interface).

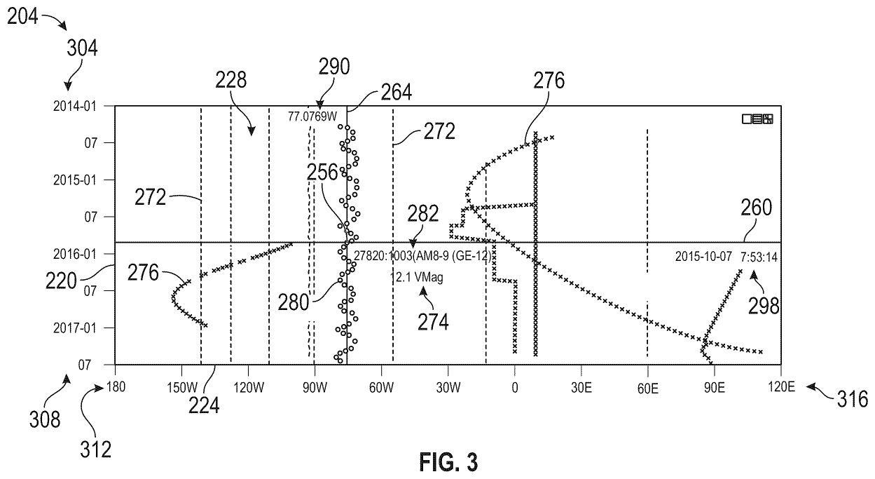

FIG. 2 shows an example visualization display 200 with a longitude-time graph 204, scalar-time graph 208, a longitude-latitude graph 212, and a display area 216. The visualization display 200 may correspond in some or all respects with the visualization display 100 of FIG. 1B. FIGS. 3-5 may provide further details related to one or more portions of FIG. 2.

The visualization display 200 can include a longitude-time graph area 228. In some embodiments, the longitude-time graph area 228 is bounded by a first longitude axis 224 and a first time axis 220. Each of the first longitude axis 224 and/or first time axis 220 can include one or more axis labels. In some designs, the axis labels of the first longitude axis 224 are not shown in relation to the longitude-time graph 204 but in relation only to, for example, the longitude-latitude graph 212 (see, e.g., FIGS. 10A-10D). The axis labels of the first longitude axis 224 and/or first time axis 220 may be equidistant from one another to portray equal intervals of the respective longitude or time. The first longitude axis 224 may span any portion of longitudes found on a planet (e.g., Earth). For Earth, the range may be from 180 W (e.g., 180° West or −180°) to 180 E (e.g., 180° East or +180°) or any range therein. For example, as shown in FIG. 2, the first longitude axis 224 spans from 180 W to 120 E. However, other ranges are possible, examples of which are described below. The first longitude axis 224 may run eastern-most to western-most from left to right (e.g., as shown in FIG. 2), but other configurations are possible.

The first time axis 220 may span any time from a historical time to nearly a current time of a user. For example, as shown by FIG. 2, the first time axis 220 may span from 2014-07 (e.g., July 2014) to 2017-07 (e.g., July 2017). The displayed time may correspond to a universal time, such as the coordinated universal time (UTC). Stored time values may similarly be in UTC. The latest time may be labeled “current time,” “now,” or a similar label and/or may indicate to a user that data from the most current time available are displayed. The most current time available may include time within a few seconds (e.g., 1-60 seconds) or a few minutes (e.g., 1-30 minutes) of a present time at which a viewer is observing the data. The first time axis 220 may span from a historical time from an earliest time when a database (e.g., a historical data server 140, a miscellaneous data server 154) has available data. The earliest time when the database has data may be as far back as the year 2010. In some embodiments, the historical data server 140, the contemporary data server 150, and/or the metadata server 154, may be configured to store some or all of the corresponding data in short-term memory storage (e.g., Random Access Memory (RAM)). The first time axis 220 may include axis labels that run earliest to most recent from top to bottom (e.g., as shown in FIG. 2), but other variations are possible. Axis labels may be spaced equidistant from each other to indicate equal time intervals therebetween. An axis label may show a corresponding time to include a year, a month, a day, an hour, a minute, and/or a second, depending on the level of specificity that is available, the span of the first time axis 220, and/or the level of detail that is needed for a particular display. As shown in FIG. 2, each axis label may not include superfluous detail (e.g., not show a year at each interval) in order to reduce clutter and to increase clarity for a viewer.

Each axis label of the first longitude axis 224 and/or first time axis 220 may include gridlines. For example, the longitude-time graph 204 may include one or more horizontal gridlines 296 and/or vertical gridlines 294 (not shown in FIG. 2). The vertical gridlines 294 and horizontal gridlines 296 may aid a viewer in identifying a particular point within one or more of the graphs. To further aid a user in visualizing the orbital object information, in some embodiments, the longitude-time graph 204 may display a longitude-time map (not shown in FIG. 2). The longitude-time map may be a geographical map of a portion of the planet. For example, the longitude-time map may identify the contours and/or limits of various landmasses (e.g., continents, islands). This information may help a user quickly ascertain over which landmass or body of water, for example, an orbital object may be located. For example, it may be useful to a viewer to see that a satellite orbits above a portion of Africa (or other planetary location). Points displayed on the corresponding graph (e.g., the longitude-time graph 204) may be superimposed over the geographic map (e.g., the longitude-time map).

The longitude-latitude graph 212 may include a longitude-latitude graph area 240 that is bounded by a second longitude axis 236 and a latitude axis 232. Each of the second longitude axis 236 and/or the latitude axis 232 can include one or more axis labels. The second longitude axis 236 and the first longitude axis 224 may be identical. For example, first longitude axis 224 may respond to a user input in the same way as the second longitude axis 236. In some embodiments, the axis labels of the second longitude axis 236 represent the values of the axis labels for the longitude-time graph 204. The axis labels of the second longitude axis 236 and/or the latitude axis 232 may be equidistant from one another to portray equal intervals of the respective longitude or latitude. Like the first longitude axis 224, the second longitude axis 236 may span any portion of longitudes found on the planet. For example, as shown in FIG. 2, the second longitude axis 236 spans from 180 W to 120 E. However, other ranges are possible. Like the first longitude axis 224, the second longitude axis 236 may run eastern-most to western-most from left to right (e.g., as shown in FIG. 2), but other configurations are possible.

The latitude axis 232 may span any latitude found on the planet. For example, the latitude axis 232 may span from 90 S (e.g., 90° South) to 90 N (e.g., 90° North) or any range therein. For example, as shown in FIG. 2, the latitude axis 232 may range from 15 S (e.g., 15° South) to 15 N (e.g., 15° North). The latitude axis 232 may include axis labels that run western-most to eastern-most from left to right (e.g., as shown in FIG. 2), but other variations are possible. Axis labels may be spaced equidistant from each other to indicate equal latitude intervals therebetween.

Each axis label of the first longitude axis 224 and/or latitude axis 232 may include gridlines. For example, the longitude-latitude graph 212 may include one or more horizontal gridlines 296 and/or vertical gridlines 294. In some designs, the vertical gridlines 294 may correspond to gridlines found in the longitude-time graph 204. If the first longitude axis 224 and the second longitude axis 236 span the same values, then the same vertical gridlines 294 may appear to run through both the longitude-time graph 204 and the longitude-latitude graph 212. In some embodiments, the longitude-latitude graph 212 may display a longitude-latitude map. In some designs, the longitude-latitude map may include a portion of the same features in the longitude-time map. The longitude-latitude map may be a geographical map of a portion of the planet. For example, the longitude-latitude map may identify the contours and/or limits of various landmasses (e.g., continents, islands). This information may help a user quickly ascertain over which landmass or body of water, for example, an orbital object may be located. For example, it may be useful to a viewer to see that a satellite orbits above a portion of Africa (or other planetary location). Points displayed on the corresponding graph (e.g., the longitude-latitude graph 212) may be superimposed over the geographic map (e.g., the longitude-latitude map).

The scalar-time graph 208 may include a scalar-time graph area 252 that is bounded by a scalar axis 248 and a second time axis 244. Each of the scalar axis 248 and/or the second time axis 244 can include one or more axis labels. The second time axis 244 and the first time axis 220 may be identical. For example, first time axis 220 may respond to a user input in the same way as the second time axis 244. In some embodiments, the axis labels of the first time axis 220 represent the values of the axis labels for the scalar-time graph 208. The axis labels of the scalar axis 248 and/or the second time axis 244 may be equidistant from one another to portray equal intervals of the respective longitude or latitude. Like the first time axis 220, the second time axis 244 may span any time from a historical time to nearly a current time of a user. Additional details on the historical and (nearly) current times are discussed above in regard to the longitude-time graph 204.

Like the first time axis 220, the second time axis 244 may include axis labels that run earliest to most recent from top to bottom (e.g., as shown in FIG. 2), but other variations are possible. Axis labels may be spaced equidistant from each other to indicate equal time intervals therebetween. An axis label may show a corresponding time to include a year, a month, a day, an hour, a minute, and/or a second, depending on the level of specificity that is available, the span of the first time axis 220, and/or the level of detail that is needed for a particular display. As shown in FIG. 2, each axis label may not include superfluous detail (e.g., not show a year at each interval) in order to reduce clutter and to increase clarity for a viewer.

The scalar axis 248 may span any value of scalars associated with scalars within a database. Each scalar displayed may correspond to a magnitude or other value. For example, the magnitude may represent an intensity (e.g., of light from the orbital object). However, other scalar values are also possible, such as a size, a projected area, a temperature, a mass, a radar cross section, an altitude, an inclination, a delta-V, a time until a certain event, a probability of a certain event, etc. Many variants are possible. The scalar axis 248 may include axis labels that run greatest to smallest from left to right (e.g., as shown in FIG. 2), but other variations are possible. Axis labels may be spaced equidistant from each other to indicate equal scalar intervals therebetween.

Each axis label of the scalar axis 248 and/or the second time axis 244 may include gridlines. For example, the scalar-time graph 208 may include one or more horizontal gridlines 296 and/or vertical gridlines 294. In some designs, the horizontal gridlines 296 may correspond to gridlines found in the longitude-time graph 204. If the first time axis 220 and the second time axis 244 span the same values, then the same horizontal gridlines 296 may appear to run through both the longitude-time graph 204 and the scalar-time graph 208.

The visualization display 200 may further include a display area 216. The display area 216 may be configured to display an image chip 268. This may offer a viewer an opportunity to see an underlying photograph from which image data were extracted that correspond to a set of data or identifiers that are associated with one or more points displayed by the visualization display 200. The image chip 268 may correspond to a photograph of one or more orbital objects. For example, the image chip 268 may be a representation of the photograph. In some cases, the image chip 268 may display an object image 270 that represents an orbital object. The image chip 268 may include multiple object images 270 (e.g., sequential images, summated images (see below), etc.). The display area 216 may also include an interface toggle 266, which is described in more detail below.

The visualization display 200 may further include a point marker 256. The point marker 256 may be used to identify a pixel associated with one or more points (e.g., longitude-time points) indicated by a user within the display currently. For example, the point marker 256 may comprise a highlighted pixel (or cluster of pixels around the highlighted pixel) to identify the current pixel/point. The one or more points displayed by the visualization display 200 may be received from one or more databases (e.g., the historical data server 140, the contemporary data server 150, the metadata server 154) via one or more data interfaces (e.g., the real-time orbital object data interface 172, the tagging interface 174, the image interface 176, the real-time connection interface 178). The data interfaces may be referred to as application program interfaces (e.g., APIs). The user may use an input device (e.g., a keyboard, a mouse, a digital pen, a microphone, a touch screen, etc.) to indicate the currently identified pixel. The point marker 256 may further be indicated by a horizontal tracking line 260 and/or vertical tracking line 264. As shown in FIG. 2, each of the horizontal tracking line 260 and vertical tracking line 264 may be visible in multiple graphs. For example, if the point marker 256 is displayed in the longitude-time graph 204, the horizontal tracking line 260 may be displayed in both the longitude-time graph 204 and the scalar-time graph 208. Similarly, the vertical tracking line 264 may be visible in both the longitude-time graph 204 and the longitude-latitude graph 212.

The point marker 256 may be associated with one or more point marker metadata stamps. The one or more point marker metadata stamps may display one or more data types not evident from a graph in which the point marker 256 is currently displayed. For example, in the longitude-time graph 204, a scalar stamp 274 and/or object identifier stamp 282 may be displayed. This may be because the longitude-time graph 204 is not configured to display scalar and/or object identifier information. Similarly, a time value, scalar value, and/or object identifier may be displayed for an identified pixel within the longitude-latitude graph 212. Moreover, a longitude value, latitude value, and/or object identifier may be displayed for an identified pixel within the scalar-time graph 208. As shown in FIG. 2, the scalar stamp 274 and/or object identifier stamp 282 may be displayed near (e.g., within a few pixels of) the point marker 256. The scalar stamp 274 can display a scalar value corresponding to a point associated with the identified (e.g., highlighted) pixel. As shown, the scalar value could be, for example, “12.1 VMag.” Similarly, the object identifier stamp 282 may display an object identifier (e.g., object name) corresponding to the point associated with the identified pixel. As shown, the object identifier could be, for example, 27820:11003 (AMC-9 (GE-12)). In some embodiments, as noted above, a latitude stamp (not shown) can be displayed. The latitude stamp may be displayed near the point marker 256 and may display a latitude value corresponding to the point associated with the identified pixel.

One or more of the horizontal tracking line 260 and/or the vertical tracking line 264 may have corresponding tracking line metadata stamps. The one or more tracking line metadata stamps may correspond to data types displayed by the corresponding graph in which the identified pixel is displayed. For example, as shown in FIG. 2, an identified pixel within the longitude-time graph 204 may include a horizontal tracking line 260 and/or the vertical tracking line 264 that correspond, respectively, to a tracking line time stamp 298 and/or a tracking line longitude stamp 290. Similarly, an identified pixel within the longitude-latitude graph 212 may include a horizontal tracking line 260 and/or vertical tracking line stamp 290 that correspond, respectively, to a tracking line latitude stamp and/or a tracking line longitude stamp 290. Moreover, an identified pixel within the scalar-time graph 208 may correspond to a horizontal tracking line 260 and/or vertical tracking line stamp 290 that correspond, respectively, to a tracking line time stamp and/or a tracking line scalar stamp. In this way, a user can quickly identify one or more values associated with the pixel identified by the point marker 256. The horizontal tracking line stamp (e.g., tracking line time stamp 298) and/or the vertical tracking line stamp (e.g., tracking line longitude stamp 290) may be displayed near the corresponding tracking line.

As shown in FIG. 2, the longitude-time graph 204 may include one or more unhighlighted collections 272 of longitude-time points, highlighted collections 276 of longitude-time points, and/or selected collections 280 of longitude-time points. Similarly, the longitude-latitude graph 212 may include one or more unhighlighted collections 284 of longitude-latitude points, highlighted collections 288 of longitude-latitude points, and/or selected collections 292 of longitude-latitude points. Moreover, the scalar-time graph 208 may include various scalar-time points 254 within the scalar-time graph area 252. The scalar-time points 254 may include points that are highlighted, unhighlighted, and/or selected.

### Object Tracking

The visualization display 200 described herein can be used to track orbital objects and present that data to a user/viewer in a meaningful way. The systems displayed herein provide a novel way of presenting high-dimensional (e.g., four-dimensional, five-dimensional, or higher dimensional) data in a way that is understandable by a human viewer.

For additional detail related to FIG. 2, reference will now include reference to FIGS. 3-5. FIG. 3 shows a detail view of an example longitude-time graph 204 that may be a part of the visualization display 200 described in FIG. 2. The first longitude axis 224 may span from a lower-longitude limit 312 to an upper-longitude limit 316. Similarly, the first time axis 220 may span from a lower-time limit 304 to an upper-time limit 308. Within the longitude-time graph area 228, the visualization display 200 may include one or more sets of longitude-time points. The one or more sets of longitude-time points may correspond to one or more pixels. Each set of longitude-time points may correspond to data on one or more orbital objects around the planet. For example, each of the one or more longitude-time points may correspond to a data set comprising historical data and/or contemporary data. Each set of longitude-time points may correspond to a set of identifiers. The set of identifiers may include a longitude value, a latitude value, a time value, a scalar value, and/or an object (e.g., name) identifier. Each set of identifiers may be obtained from one or more photographs. The photographs may contain image data from which one or more identifiers of the set of identifiers can be obtained (e.g., through algorithm).

The longitude-time points displayed within the longitude-time graph area 228 may be points that have a time value between the lower-time limit 304 and the upper-time limit 308. Additionally or alternatively, the displayed longitude-time points may have a longitude value between the lower-longitude limit 312 and the upper-longitude limit 316.

As shown in FIG. 3, the point marker 256 may comprise one or more highlighted pixels that can help a user determine which pixel is identified by a user input device. If the pixel is associated with object data, the scalar stamp 274 and/or object identifier stamp 282 may be displayed within the longitude-time graph area 228. One or both of the scalar stamp 274 and the object identifier stamp 282 may be displayed in an area easily associated with the point marker 256. If the identified pixel does not contain corresponding object data, then the respective scalar stamp 274 and/or object identifier stamp 282 may not be displayed. As shown the pixel currently identified by the point marker 256 is a pixel that includes a selected collection 280 of longitude-time points.

In order to further aid a user, an interface toggle 320 may be included in the longitude-time graph 204. The interface toggle 320 may be manipulated by a user from an input device (e.g., function keys on a keyboard, a mouse, etc.). The interface toggle 320 may communicate with the user settings module 132 (see FIG. 1A) to determine, for example, display settings for the longitude-time graph 204. A user may be able to adjust the display settings using the interface toggle 320. For example, the user may be able to click a box to switch a view type. The user may be able to filter what types of points (e.g., unhighlighted, highlighted, selected) are displayed. The interface toggle 320 may allow a user to toggle the display of the longitude-time map on and off. For example, as shown in FIG. 3, the longitude-time map is toggled off while in FIG. 2 it is toggled on.

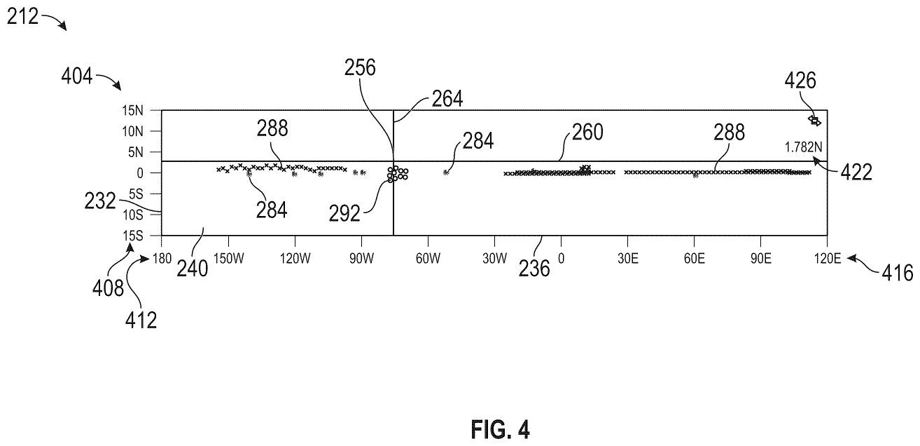

FIG. 4 shows a detail view of an example longitude-latitude graph 212 that may be a part of the visualization display 200 described in FIG. 2. The second longitude axis 236 may span from a lower-longitude limit 412 to an upper-longitude limit 416. Similarly, the latitude axis 232 may span from a lower-latitude limit 408 to an upper-latitude limit 404. The longitude-latitude points displayed within the longitude-latitude graph area 240 may be points that have a latitude value between the lower-latitude limit 408 and the upper-latitude limit 404. Additionally or alternatively, the displayed longitude-latitude points may have a longitude value between the lower-longitude limit 412 and the upper-longitude limit 416.

The longitude-latitude graph area 240 may include various displayed longitude-latitude points. For example, the longitude-latitude graph 212 may display one or more unhighlighted collections 284 of longitude-latitude points, highlighted collections of longitude-latitude points (not shown), and/or selected collections 292 of longitude-latitude points. In some cases, the one or more selected collections 292 of longitude-latitude points may include highlighted longitude-latitude points. FIG. 4 shows the point marker 256 over a point in a selected collection 292 of longitude-latitude points.

As shown in FIG. 4, the point marker 256 may be displayed within the longitude-latitude graph 212. For example, a user may use an input device to indicate where and/or in which graph the point marker 256 is located. As noted above, if the point marker 256 is displayed within the longitude-latitude graph 212, a tracking line latitude stamp 422 may be displayed. The tracking line latitude stamp 422 displays a latitude value associated with a longitude-latitude point corresponding to the pixel identified by the point marker 256. Additionally or alternatively, a tracking line longitude stamp 290 may be displayed. One or more point marker metadata stamps (e.g., the scalar stamp 274, the object identifier stamp 282, a latitude stamp, a longitude stamp, a time stamp) may be displayed, as described above.

An interface toggle 426 may be included to aid a user in interacting with the longitude-latitude graph 212. For example, the interface toggle 426 may allow a user to toggle a view of the longitude-latitude map on or off. The interface toggle 426 may be manipulated by a user from an input device (e.g., function keys on a keyboard, a mouse, etc.). As shown in FIG. 4, the longitude-latitude map is toggled on. Other functionality is also possible.

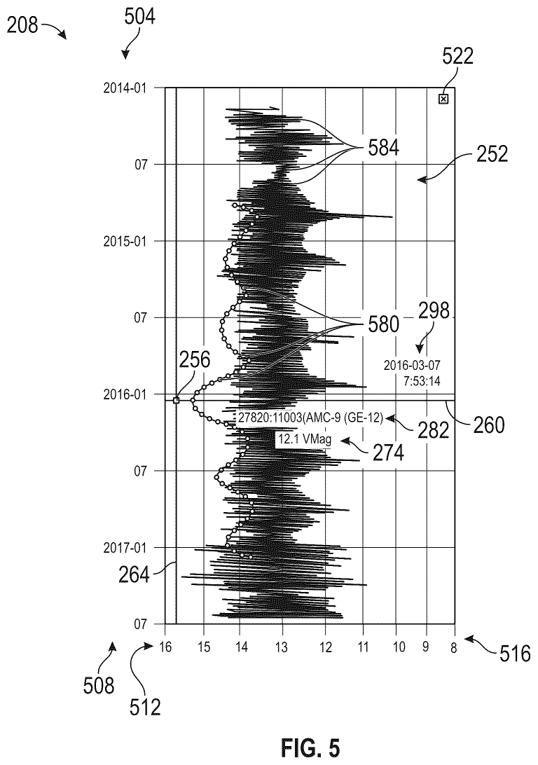

FIG. 5 shows a detail view of an example scalar-time graph 208 that may be a part of the visualization display 200 described in FIG. 2. The scalar-time graph 208 may show one of a number of possible scalar values. For example, the scalar may refer to a magnitude, such as an intensity of reflected light. However, a number of other scalar values are possible, such as a size, a projected area, a temperature, a mass, a radar cross section, an altitude, an inclination, a delta-V, a time until a certain event, a probability of a certain event, etc.

The scalar axis 248 may span from a lower-scalar limit 512 to an upper-scalar limit 516. Similarly, the second time axis 244 may span from a lower-time limit 504 to an upper-time limit 508. The scalar-time points displayed within the scalar-time graph area 252 may be points that have a scalar value between the lower-scalar limit 512 and the upper-scalar limit 516. Additionally or alternatively, the displayed scalar-time points may have a time value between the lower-time limit 504 and the upper-time limit 508.

As shown in FIG. 5, the point marker 256 may be displayed within the scalar-time graph 208. As noted above, if the point marker 256 is displayed within the scalar-time graph 208, one or more metadata stamps may be displayed. For example, the tracking line time stamp 298 may indicate a time value of a scalar-time point corresponding to the pixel identified by the point marker 256. Similarly, a tracking line scalar stamp (not shown) may indicate a scalar value of a scalar-time point corresponding to the pixel identified by the point marker 256 Additionally or alternatively, one or more point marker metadata stamps (e.g., the scalar stamp 274, the object identifier stamp 282, a latitude stamp, a longitude stamp, a time stamp) may be displayed, as described above.

The scalar-time graph 208 may display one or more unhighlighted collections 584 of scalar-time points, highlighted collections 584 of scalar-time points (not shown), and/or selected collections 580 of scalar-time points. As shown, the point marker 256 identifies a pixel associated with a point in a selected collection 580 of scalar-time points. An interface toggle 522 may be included to aid a user in interacting with the scalar-time graph 208. For example, the interface toggle 522 may allow a user to toggle which type(s) (e.g., unhighlighted, highlighted, selected) points are displayed. Additionally or alternatively, the interface toggle 522 may allow a user to toggle between a stitching panel and a graph and/or to toggle which type of scalar is displayed by the scalar-time graph 208. Other functionality is also possible.

With reference generally to FIGS. 2-5, the system may allow a user to interact with the visualization display 200 in a variety of beneficial ways. For example, a user may be able to pan and zoom within one or more graphs in the visualization display 200. Panning may be up, down, left, right, or any other direction along an axis. Zooming may include zooming in and/or out. The user may give a panning input and/or a zooming input via an input device. The panning input and/or zooming input may comprise a scrolling of a mouse wheel, a click of a mouse, a pinch motion, a flick motion, a swipe motion, a tap, and/or any other input identifying a pan or zoom action. The visualization display 200 may be configured to allow simultaneous manipulation of multiple graphs. For example, in response to a user input to pan or zoom the first time axis 220 or the second time axis 244, the system may set the lower-time limit 304 equal to the lower-time limit 504 and/or set the upper-time limit 308 equal to the upper-time limit 508. Similarly, in response to a user input to pan or zoom the first longitude axis 224 or the second longitude axis 236, the system may set the lower-longitude limit 312 equal to the lower-longitude limit 412 and set the upper-longitude limit 316 equal to the upper-longitude limit 416.

A user may be able to set the upper and/or lower limits of a given axis. Additionally or alternatively, the user may be able to set axis spacing, axis intervals, axis labels, axis formatting, axis length, and or other aspects associated with one or more axes. Once set, the system may be configured to automatically update that axis. In some embodiments, the system may be configured to automatically update a corresponding axis. For example, automatically updating a corresponding axis may include setting a common alignment for both of the two axes, setting a common length for both of them, and/or disposing them parallel to one another. The first longitude axis 224 and second longitude axis 236 may be corresponding axes. Similarly, the first time axis 220 and second time axis 244 may be corresponding axes.

Zooming may be defined as changing a total span (e.g., a difference between an upper-axis limit and a lower-axis limit) of one or more axes in the visualization display 200. A single axis may be zoomed in or out by the user. A single graph (e.g., two perpendicular axes) may be zoomed in or out. However, the system may be configured to allow a user to zoom in and/or out on multiple axes and/or graphs simultaneously. For example, zooming in on the longitude-time graph 204 may adjust not only the first time axis 220 and first longitude axis 224, but it may adjust the second time axis 244 as well.

Zooming and/or panning in one axis or one graph may affect which points are displayed in other graphs within the visualization display 200. For example, in an adjustment of the lower-time limit 304 or the upper-time limit 308, the system may be configured to update the longitude-latitude graph 212 to display pixels corresponding only to longitude-latitude points corresponding to a set of identifiers having a time identifier between the lower-time limit 304 and the upper-time limit 308.

Panning and/or zooming may be done within a graph or along an axis. For example, in response to a user input to pan or zoom along a length of first time axis 220, the system may be configured to simultaneously modify one or more of the lower-time limit 304 and/or the upper-time limit 308. In response to a user input to pan or zoom along a length of second time axis 244, the system may be configured to simultaneously modify one or more of the lower-time limit 504 and/or the upper-time limit 508. Additionally or alternatively, in response to a user input to pan or zoom along a length of the first longitude axis 224, the system may be configured to simultaneously modify one or more of the lower-longitude limit 312 and/or the upper-longitude limit 316. In response to a user input to pan or zoom along a length of the second longitude axis 236, the system may be configured to simultaneously modify one or more of the lower-longitude limit 412 and/or the upper-longitude limit 416. Additionally or alternatively, in response to a user input to pan or zoom along a length of the latitude axis 232, the system may be configured to simultaneously modify one or more of the upper-latitude limit 404 and/or the lower-latitude limit 408. In response to a user input to pan or zoom along a length of the scalar axis 248, the system may be configured to simultaneously modify one or more of the lower-scalar limit 512 and the upper-scalar limit 516.

Further, in response to a user input to adjust the lower-longitude limit 312 or the upper-longitude limit 316, the system may update the scalar-time graph 208 to display pixels corresponding only to scalar-time points corresponding to a set of identifiers having a longitude identifier between the lower-longitude limit 312 limit and the upper-longitude limit 316. Similarly, in response to a user input to adjust the upper-latitude limit 404 or the lower-latitude limit 408, the system may update one or more of the longitude-time graph 204 and/or the scalar-time graph 208 to display pixels corresponding only to respective longitude-time points and/or scalar-time points corresponding to a set of identifiers having a latitude identifier between the lower-longitude limit 312 and the upper-longitude limit 316.

Moreover, in response to a user input to adjust the lower-scalar limit 512 or the upper-scalar limit 516, the system may update one or more of the longitude-time graph 204 and the longitude-latitude graph 212 graph to display pixels corresponding only to respective longitude-time points and/or longitude-latitude points corresponding to a set of identifiers having a scalar identifier between the lower-scalar limit 512 limit and the upper-scalar limit 516.

As noted above, the system may be configured to store dozens of petabytes of data. This can provide a variety of challenges. One of which is how the data are displayed in a way that is helpful to a human user. Accordingly, in certain embodiments, the visualization display 200 may be configured to divide a graph (e.g., the longitude-time graph 204) into a plurality of pixels. Each pixel may represent a corresponding bin of data. Each bin can be configured to store historical and/or contemporary data as well as metadata.

In some cases, a single pixel may correspond to a bin containing dozens, hundreds, or even thousands of data sets corresponding to orbital objects. To aid a user in digesting such a large amount of data, the visualization display 200 may be configured to display an indication of the amount of data (e.g., the number of objects, the number of sets of object identifiers) stored therein. For example, a user may use the point marker 256 to identify a pixel. The system can be configured to display a number of object identifiers (e.g., a number of unique object identifiers) between one and a total number of object identifiers associated with the bin associated with the identified pixel. An object identifier can be any type of identifier of an orbital object. The object identifier may comprise one or more letters, numbers, symbols, or any combination of these.

In some designs, the system is configured to receive a selection from a user of a target object identifier. For example, the system may sequentially cycle (e.g., automatically, manually) through a display of each object identifier associated with the identified pixel (e.g., every second, every two seconds, in response to a user input, etc.). As a different example, the system may be configured to display a list of object identifiers from which a user may select the target object identifier. The system may be configured only to display unique object identifiers since many object identifiers in a single bin may be identical. In some embodiments, the system may not display one or more of the metadata stamps (e.g., the tracking line longitude stamp 290, the horizontal tracking line 260, the object identifier stamp 282, the scalar stamp 274, etc.) until an object identifier has been selected. In certain embodiments, the system displays metadata stamps for each unique object identifier present in the bin. The visualization display 200 may implement a color scale or gray scale to provide information about the number of unique orbital object identifiers in a bin. For example, bins with more unique orbital object identifiers may correspond to lighter pixels while bins with fewer unique orbital object identifiers may be darker. Bins with no orbital object identifiers may be black. This situation may arise, for example, when viewing a small portion (e.g., zoomed in) of the data in a graph.

The system can be configured to identify one or more values (e.g., by various metadata time stamps described herein) associated with a default data set. The point marker 256 is an example of an interface element that can identify values in the default data set. The default data set may be determined based on one or more default rules. The default rule(s) may be based on a storage time (e.g., most recently stored), a view time (e.g., most recently viewed), a numerical value (e.g., smallest latitude), an object identifier (e.g., earliest object identifier by alphabetical order), or any other default measure.

As a user moves the point marker 256, the system may automatically (e.g., in real-time) update the identified values (e.g., metadata time stamps) associated with the updated pixel corresponding to an updated data set. The updated data set may be determined using the same or different rules described above. The user may move the point marker 256 over an updated pixel in a variety of ways, such as by mousing over the pixel using an input device (e.g., mouse), tapping on the pixel (e.g., using a touchscreen), typing in information associated with the updated pixel, or in any other way to identify a pixel.

It may be advantageous to allow a user to save one or more settings associated with the visualization display 200. For example, a user may wish to return at a later time to a point or set of points displayed by the visualization display 200. This may be accomplished in a number of ways. For example, a user may be configured to bookmark one or more values associated with the target point (e.g., an object identifier, a longitude value, a time value, etc.). The system may store a list of the user's bookmarks to allow for easy access at a future time. The system may be configured to store a set of points based, for example, on the points having a common object identifier. For example, multiple points may correspond to the same object as it orbits the planet. Thus, multiple points in time and space may reference the same object. The user may be able to retrieve the set of points by inputting the object identifier (e.g., selecting it from a list, typing it in).

Additionally or alternatively, the system may be able to allow a user to save a view of one or more graphs. For example, a user may be able to bookmark a particular view within the longitude-time graph 204. Accordingly, the system may associate with the bookmark stored values for a bookmark-min longitude value (e.g., the lower-longitude limit 312), a bookmark-max longitude value (e.g., the upper-longitude limit 316), a bookmark-min time value (e.g., the lower-time limit 304), and/or a bookmark-max time value (e.g., the upper-time limit 308). Similar usage may be made for other values (e.g., a scalar value, an object identifier, a latitude). Points that satisfy these bookmark-min and/or bookmark-max values could be displayed by the system in response to a user selection of the associated bookmark.

### Display Synchronization

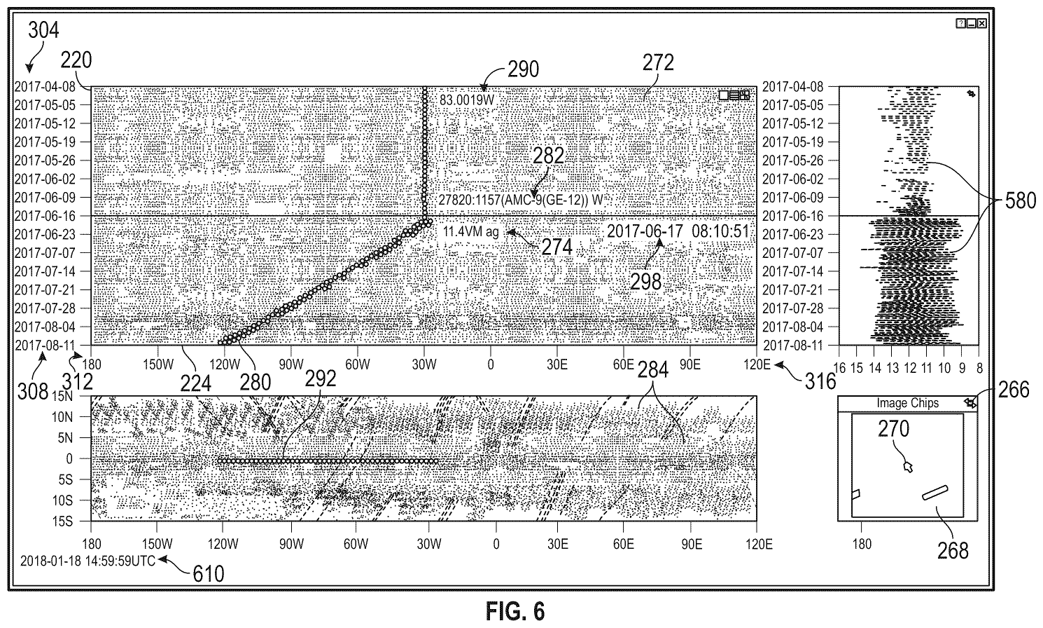

One of the benefits of various embodiments described herein is the ability of a user to quickly and easily view and digest an immense amount of data containing variables in three, four, or more dimensions. To help a user visualize data containing higher-dimension values, various graphs of the visualization display 200 may be synchronized to each other. FIGS. 6-9 illustrate various functionality associated therewith.

FIG. 6 shows a zoomed-in and panned view of visualization display 200 of FIG. 2. As shown, the first time axis 220 spans from and updated lower-time limit 304 to an updated upper-time limit 308. The first time axis 220 spans about fifteen weeks. Similarly, the first longitude axis 224 has been updated to show a span of about 37 degrees between the lower-longitude limit 312 and the upper-longitude limit 316. The object identifier stamp 282 indicates the same object identifier shown in FIG. 2. This indicates that the point marker 256 identifies a pixel associated with the same object as is identified in FIG. 2. The tracking line longitude stamp 290 indicates a longitude of about 83.0019 W and the tracking line time stamp 298 indicates a time of 2017 Jun. 17 08:10:51. As shown, the selected collection 280 of longitude-time points is associated with the pixel identified by the point marker 256. Other unhighlighted collections 272 of longitude-time points are also shown, which are associated with the unhighlighted collections 284 of longitude-latitude points.

The selected collection 280 of longitude-time points is similarly associated with the selected collection 292 of longitude-latitude points displayed in the longitude-latitude graph 212 as well as the selected collection 580 of scalar-time points displayed in the scalar-time graph 208.

The visualization display 200 may further include a current time stamp 610. The current time stamp 610 may indicate a current universal time, such as one tracking the coordinated universal time (UTC).

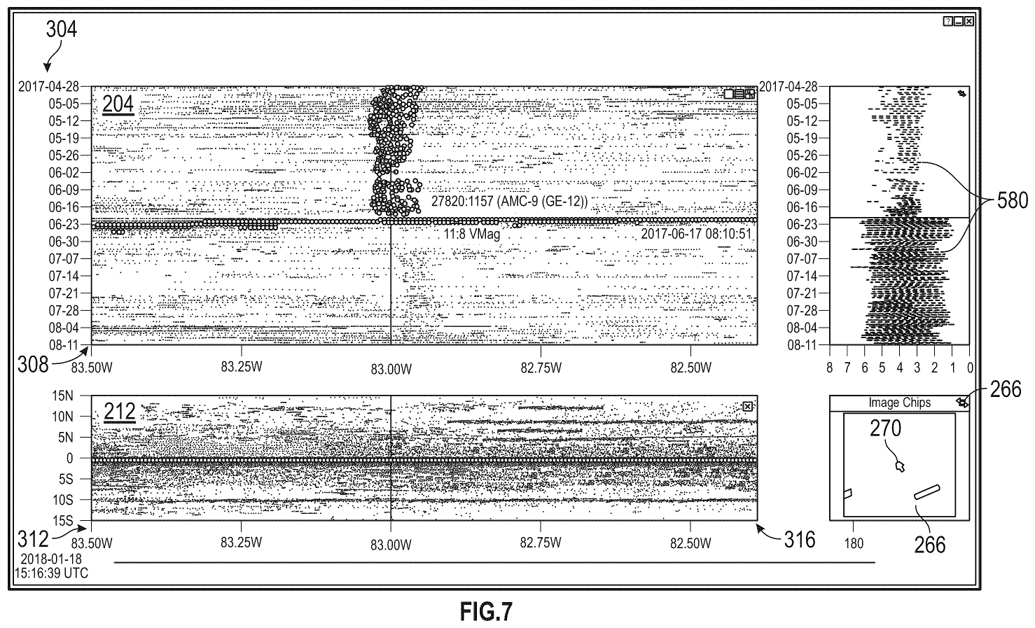

FIG. 7 shows the same view as FIG. 6 after the first longitude axis 224 and the synchronized second longitude axis 236 have been zoomed in. Note that the first longitude axis 224 and the second longitude axis 236 (as well as the first time axis 220 and the second time axis 244) are synchronized in this case, allowing for a seamless viewing experience when viewing each of the graphs. Because the first longitude axis 224 and the second longitude axis 236 are synchronized to each other, the scalar-time graph 208 has also been updated. The point marker 256 identifies a slightly different pixel as compared to FIG. 6. As shown, both longitude axes 224, 236 span a little over a single degree. Moreover, as shown, the axis labels (and/or the associated hash marks) on the first longitude axis 224 have become omitted since the two longitude axes 224, 236 are synchronized. Similarly, the two time axes 220, 244 can be synchronized, in which case the axis labels (and/or the associated hash marks) of the second time axis 244 may be omitted.

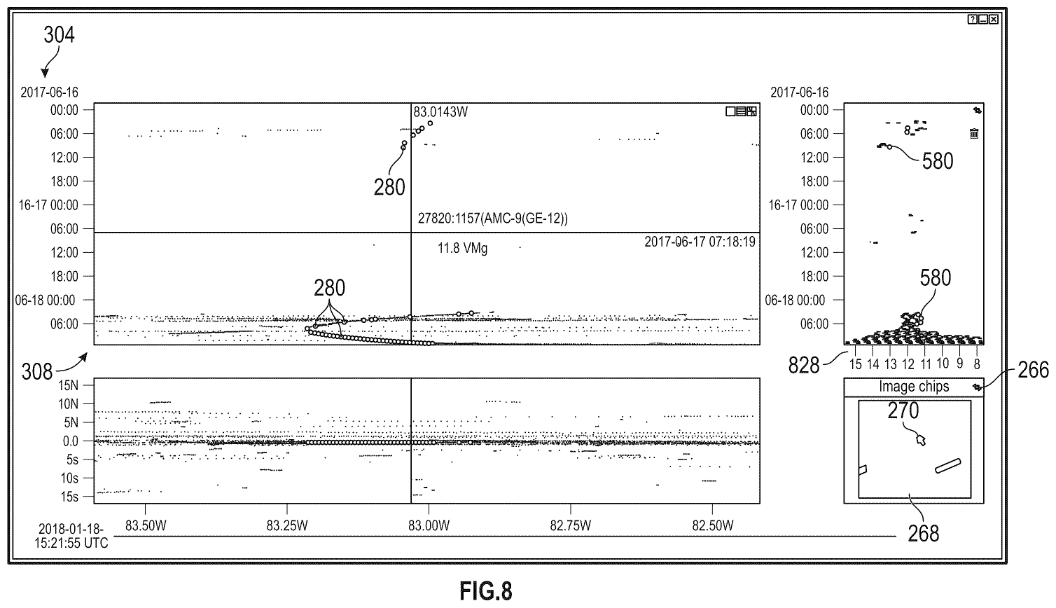

FIG. 8 shows the same view as FIG. 7 after the first time axis 220 and the synchronized second time axis 244 have been zoomed in. Because the first time axis 220 and second time axis 244 are synchronized to each other, the scalar-time graph 208 has also been updated. The point marker 256 identifies a slightly different pixel as compared to either FIG. 6 or FIG. 7.

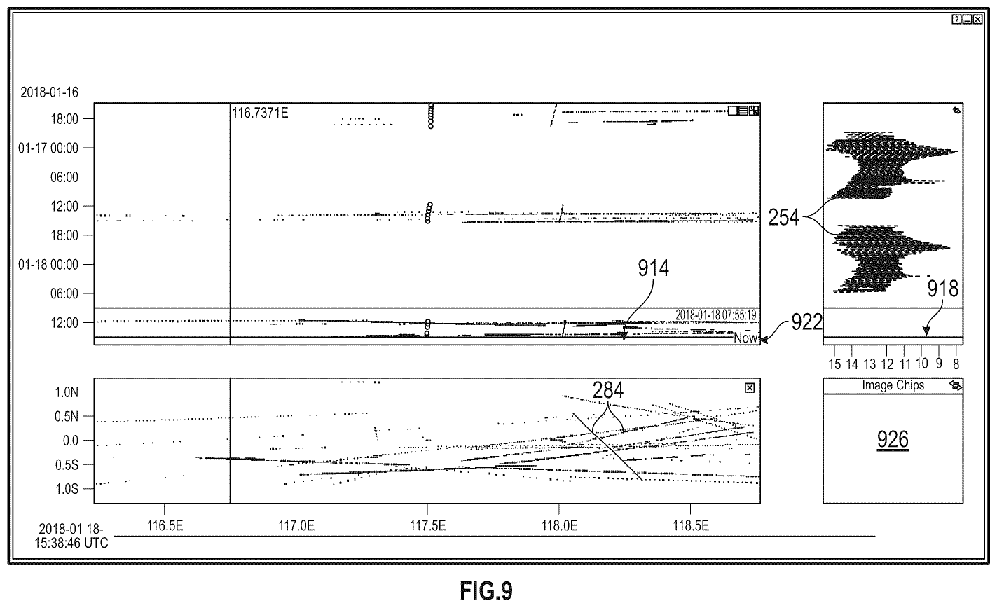

FIG. 9 shows a zoomed-in and panned view of a longitude-time graph 204 at a current time horizon. The current time horizon may be identified by a current time marker 922. The current time marker 922 may include a line and/or a descriptor, such as a “now” descriptor, as shown. The future longitude-time area 914 and the future scalar-time area 918 do not include any display points corresponding to object data since those times are later than the current time as indicated by the current time stamp 610. Data that has been received later than a threshold time from the current time may not be displayed yet. This delay may be due to latency in the network (e.g., the network 144) or for some other reason that delays the system from receiving the data.

The image chip 268 in FIGS. 6-8 identifies an object image 270 while the image chip 268 in FIG. 9 does not. The image chip 268 corresponds to a photograph from which object data has been obtained associated with a pixel identified by the point marker 256. The photographs shown in FIG. 6-8 may identify the object image 270 received from actual telescopic images. As noted, an image chip 268 may include a plurality of object images 270. In some embodiments, the image chip 268 identifies which of the plurality of object images 270 corresponds to the data associated with the pixel identified (e.g., by the point marker 256). For example, a marker may be displayed indicating a location of the object within the at least one photograph. The marker may comprise a circle, a box, crosshairs, a coloring, a flicker, or any other indication of an object within a photograph. The user may identify the pixel associated with the object image 270 in other ways described above.

Image chip 268 data may be received from one or more databases. For example, the system may receive the image chip 268 data from a database remote from the system. Additionally or alternatively, the data may be received from a database local to the system. The image chip 268 data may be received via one or more pointers (e.g., hyperlinks) that point to corresponding databases. For example, various image chip 268 data may be stored on databases associated with the imager (e.g., telescope) from which the data was first obtained.

The user may select one or more objects from an image chip 268 and a corresponding point or plurality of points may be indicated (e.g., highlighted, supplied with a marker) on one or more of the graphs in the visualization display 200. Additionally or alternatively, the user may be able to select a point or plurality of points on one or more of the graphs in the visualization display 200 and have one or more images (e.g., photo, video) displayed by the image chip 268 with associated marker. In some designs, the image chip 268 is configured to show a video corresponding to multiple points within a graph in the visualization display 200. The multiple points may comprise a common object identifier. In FIG. 9, because an identified pixel does not correspond to image data for a photograph, the blank image chip 926 does not display any photograph.

### Tagging Interface

It may be useful to update data corresponding to the object data in the historical and/or contemporary databases. For example, it may be helpful to add or remove an object identifier (e.g., object name) to one or more points. To this end, a tagging interface can be implemented in various embodiments. FIGS. 10A-10D illustrate various aspects of embodiments of the system that include a tagging interface.

FIG. 10A shows a tagging interface comprising a stitching tool interface 804 and an analysis plot interface 808. The tagging interface is shown along with a longitude-time graph 204 and a longitude-latitude graph 212. As shown, the stitching tool interface 804 may include a source track region designator 818 with corresponding source track region 820 and/or an destination track region designator 826 with corresponding destination track region 824. In some embodiments, the source track region designator 818 and/or destination track region designator 826 are not included. The destination track region 824 may include one or more of a stitch selector 828, a splice selector 832, an orbit selector 836, and/or a download selector 840. In response to the orbit selector 836, the system may be configured to calculate and/or display an aspect of an orbit of a selected object or plurality of objects. The stitching tool interface 804 may further include an undo selector 834. The undo selector 834 may be represented by words “undo” and/or by a symbol (e.g., an arrow symbol). In response to a selection of the undo selector 834, the system may undo a most recent user selection. In response to a sequence of selections, the system may be configured to revert back a sequence of actions in response to a sequence of previous user selections.

The analysis plot interface 808 may include one or more analysis plot input selectors 848 and/or an interface toggle 266. The interface toggle 266 may be selected by a user to toggle between a tagging interface and the scalar-time graph 208 and/or display area 216. The analysis plot interface 808 may include an analysis plot. The analysis plot may display one or analysis points within a plot area. The analysis plot may include a time axis and/or a scalar axis. The time axis may span a particular number of days (e.g., five days, seven, days, ten days, etc.). The scalar axis may be determined based on a number of selected points, such as a collection 816 of longitude-time destination points.

As shown in FIG. 10A, the collection 816 of longitude-time destination points may be selected by a user. For example, the user may highlight one or more of the collection 816 of longitude-time destination points. As used herein, highlighting may include altering one or more of a color, shading, intensity, and/or background. This may be achieved, for example, by right-clicking on a mouse one of the points in the longitude-time graph 204 and/or the longitude-latitude graph 212. The right-click (or other user input) can cause the point marker 256 to identify a pixel associated with object data. As shown in FIG. 10A, the user has identified the collection 816 of longitude-time destination points. The identified collection 816 of longitude-time destination points may be highlighted (e.g., colored). The collection 816 of longitude-time destination points corresponds to a collection 844 of longitude-latitude destination points. The destination track identifier 852 in the stitching tool interface 804 identifies the collection 816 of longitude-time destination points as a destination track. The selected points may correspond to the destination track analysis points 856 displayed within the analysis plot interface 808.

FIG. 10B shows a selection by a user of a collection 868 of first longitude-time source points. The collection 868 of first longitude-time source points may consist of a single point. As shown, the collection 868 of first longitude-time source points is different from the collection 816 of longitude-time destination points. The collection 868 of first longitude-time source points may be highlighted (e.g., differently from the highlighting of the collection 816 of longitude-time destination points). The source track region 820 now shows a first source track identifier 864 that has been selected. A corresponding collection 872 of first longitude-latitude source points and/or a corresponding collection 860 of first source analysis points may be plotted in their respective graph/plot.

FIG. 10C shows a selection by a user of a collection 880 of second longitude-time source points. The collection 880 of second longitude-time source points may consist of a single point. As shown, the collection 880 of second longitude-time source points is different from either the collection 816 of longitude-time destination points or the collection 868 of first longitude-time source points. Similarly, as shown, the highlighting of the collection 880 of second longitude-time source points may be different from either the collection 816 of longitude-time destination points or the collection 868 of first longitude-time source points. The second source track identifier 876 indicates the additional selection of the collection 880 of second longitude-time source points. A corresponding collection 884 of second longitude-latitude source points and/or a corresponding collection 888 of second source analysis points may be plotted in their respective graph/plot. A highlighted stitch selector 829 may indicate that the selected collections 868, 880 are ready to be stitched. It will be noted that a single source track (as opposed to the two source tracks in the displayed example) may provide the highlighted stitch selector 829 as well.

FIG. 10D shows the visualization display 200 of FIG. 10C after a user has selected the stitch selector 828. Once the stitch selector 828 has been selected by the user, the resulting new collection 892 of longitude-time destination points comprise the original destination and source track(s). A corresponding new collection 896 of longitude-latitude destination points and/or a new collection 898 of destination analysis points may also be displayed. Accordingly, it may be that no source tracks are indicated in the source track region 820. The destination track region 824 may continue to display an object identifier associated with the resulting destination track.

In this way, the tagging interface may allow a user to select a destination element comprising a first name identifier and a source element comprising at least one of the plurality of pixels corresponding to longitude-time points comprising a second name identifier. After selecting the stitch selector, the display can be configured to indicate that the source element comprises the first name identifier. In some designs, each of the destination element and source element consists of one or more points displayed by the system during the user selection of the stitch selector. In response to the user selection, the computer readable storage may be configured to associate a first data file comprising the first name identifier with a second data file comprising the second name identifier.

A reverse process may be used to splice a collection of points into separate sets of points. For example, a user may be able to select a collection of source points as well as one or more splice points from among the source points. After selecting the splice selector 832, the system may be configured to remove and/or alter an object identifier associated with the splice points relative to the source points.

For example, the system can be configured such that a user may be able to select at least one pixel corresponding to at least one longitude-time point comprising a first object identifier. The system may be configured to highlight a series of longitude-latitude points comprising an object identifier identical to the first object identifier. In response to a user selection of the splice selector, the system can be configured to distinguish a first set of one or more longitude-time points from a second set of one or more longitude-time points on the visualization display 200.

The system can be configured to highlight one or more pixels corresponding to a set of longitude-time points, for example, in response to a user input. The user input may comprise a selection of the one or more longitude-time points (e.g., via a selection of one or more pixels). The user input may include a mouse click, a double tap, a pinch motion, a two-finger tap, a grouping (e.g., circling) motion, or some other input signifying a selection of points. In some embodiments, the system may highlight a series of points based on a user selection of a first pixel. The system may be configured to highlight a series of pixels comprising the first pixel. Each of the pixels in the series can correspond to longitude-time points comprising a common object identifier. Moreover, while longitude-time points have been used as an example in FIGS. 10A-10D, other points (e.g., longitude-latitude points, analysis plot points) may be used for selecting and/or tagging (e.g., stitching, splicing).

### Autoselector

One of the many advantages of the systems described herein includes the ability to track and/or predict space objects. The trajectory of a space object can be extremely challenging to calculate and predict. Each prediction may include a set of measurements, which can be variable in their accuracy, precision, and/or dependability. For example, determining a position of the object in flight may require many images of the object using many optical sensors, such as a network of telescopes. Piecing the data from these images and arriving at an accurate and reliable position can be extremely difficult.

Despite the many challenges of capturing and allowing meaningful user interactions with space objects, embodiments disclosed herein can allow a user and the system to work synergistically to help identify areas where certain data can be improved, modified, and/or removed if necessary. Such an interface combines access to an enormous dataset, direction to more interesting features and aspects of that dataset that a human user can understand, and often a user experience that allows for real-time interaction with those features and aspects that is intuitive and manageable. In certain embodiments, a user can work with the machine to identify, manipulate, and sort (e.g., combine) data about various space objects.

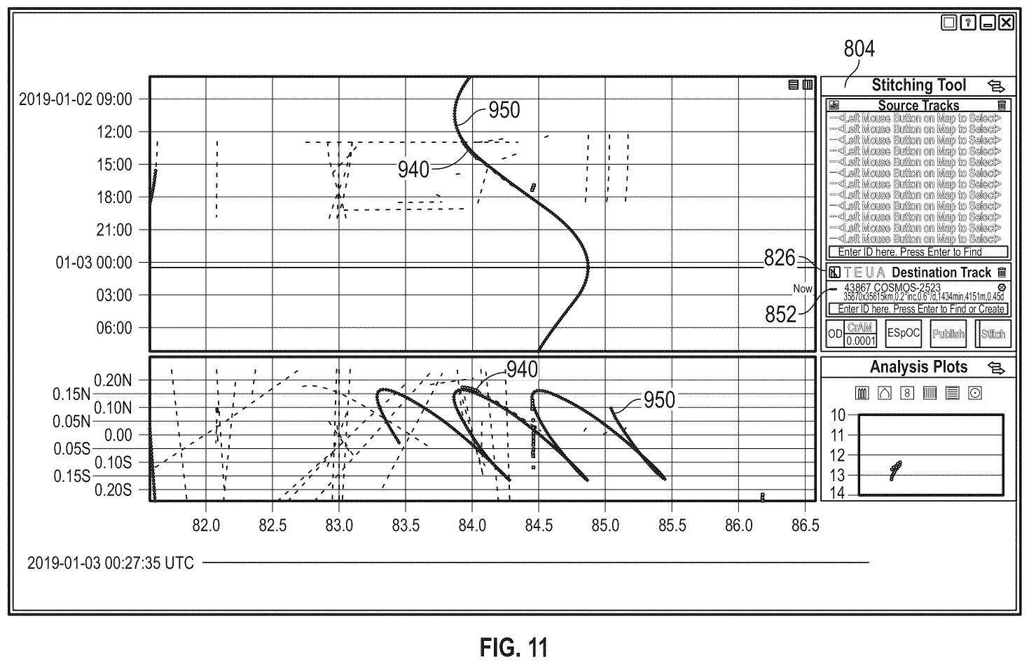

FIG. 11 shows an example user-selected first track (e.g., via a track identifier or track representation) and a system-predicted second track (e.g., via a system-predicted track identifier or track representation). A tagging interface is shown. One or more track representations (e.g., lines) may represent a corresponding number of tracks. A track may represent a path that an orbital object takes in space. One or more points or pixels may be used to indicate data points (e.g., timepoints) associated with an object's trajectory, position, time, etc. As shown, the first and second tracks may be displayed one on or more graphs. For example, a longitude-time graph may be shown together with a longitude-time graph (e.g., as described elsewhere herein). Additionally or alternatively, one or more scalar-time plots may be included. Other graphs/plots may be used, such as those described elsewhere herein.

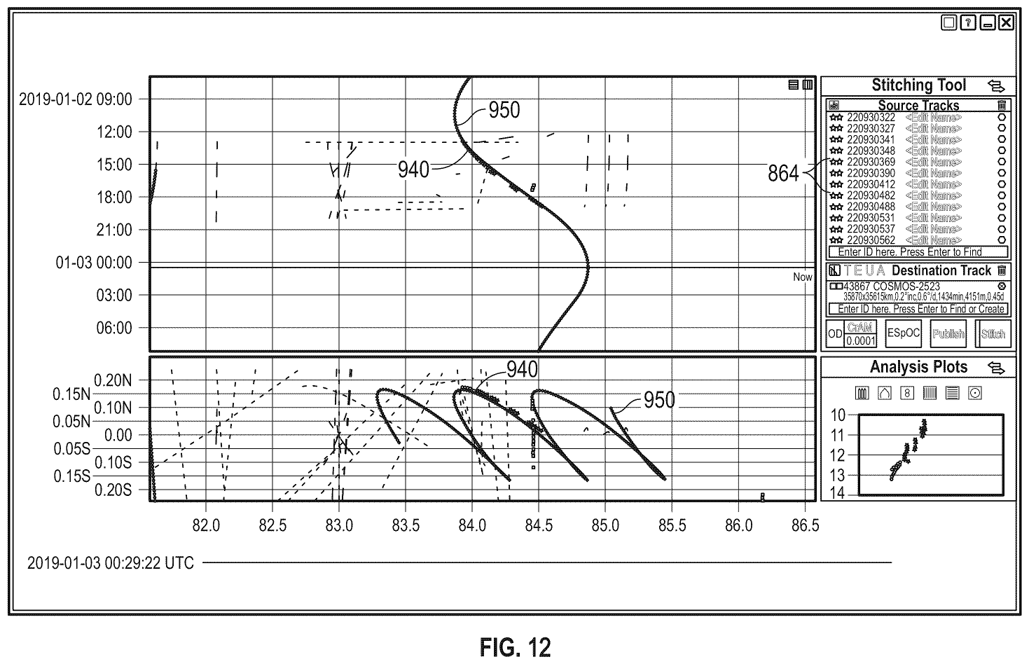

FIG. 12 shows where second track is updated (e.g., to include additional tracks). As shown in the photographs of FIGS. 11-12, for example, the first and/or the second tracks can include an indication of the “future” (e.g., below a “current time” line). A first track representation may include points (e.g., longitude-time points) within a corresponding graph (e.g., longitude-time graph). Each of the plurality of longitude-time points can correspond to a set of identifiers having a time identifier between the lower-time limit and the upper-time limit and having a longitude identifier between the lower-longitude limit and the upper-longitude limit. The first track representation can provide a view of at least a portion of the first track. Additional tracks may be represented with corresponding track representations.

The display system may include a tagging interface that includes a stitch selector (e.g., “Stitching Tool” in FIGS. 11-12). The stitch selector may include certain functionality (e.g., buttons, interface design, etc.) of that described in relation to FIGS. 10A-10D, for example. In response to a user selection of a track representation, the display can indicate a selection (e.g., automatic, user-identified) of a different track representation corresponding to a second track. The system may automatically determine that the second track representation based on a determination that the second track is associated with the same orbital object as the first track.

The second track representation may be displayed on one or more graphs described herein. The system can highlight one or more of the first and/or second track representations (e.g., based on a user selection of the corresponding track representation).

In certain embodiments, the system can update the display to progressively highlight one or more additional track representations (e.g., after highlighting the first and/or second track representations). The system may update the display to automatically and/or progressively highlight each of the additional track representations. The delay may be between about 0.01 s to about 10 s between each of the highlights. The delay may depend on the density of tracks and/or the number of tracks in the viewable display. In response to a user's suspend input, the system may suspend and/or stop progressive highlighting of each of the additional track representations. A length of the delay between each of the highlights may depend on at least one of a density and/or a number of tracks displayed. The display may be configured to progressively highlight the additional track representations based at least on a time identifier associated with the additional track representations. The display may progressively highlight the additional track representations (e.g., within the longitude-time graph) by receiving a user designation. The designation may include one or more of a scroll indicator, a button, a wheel, a switch, or any combination thereof. Additionally or alternatively, the display may deselect highlighting by receiving the user designation.

As described in more detail herein, the system may be configured to determine an orbital path of the orbital object. The orbital path may be determined over an orbital time period that includes a first time period that (i) overlaps the time period, (ii) precedes the time period, (iii) succeeds the time period, or (iv) any combination thereof. As shown in FIGS. 11-12, the orbital path may be shown on one, two, or more graphs simultaneously. For example, the orbital path may be shown on the latitude-longitude graph and/or the longitude-time graphs. Other variations are possible.

### Image Stacking

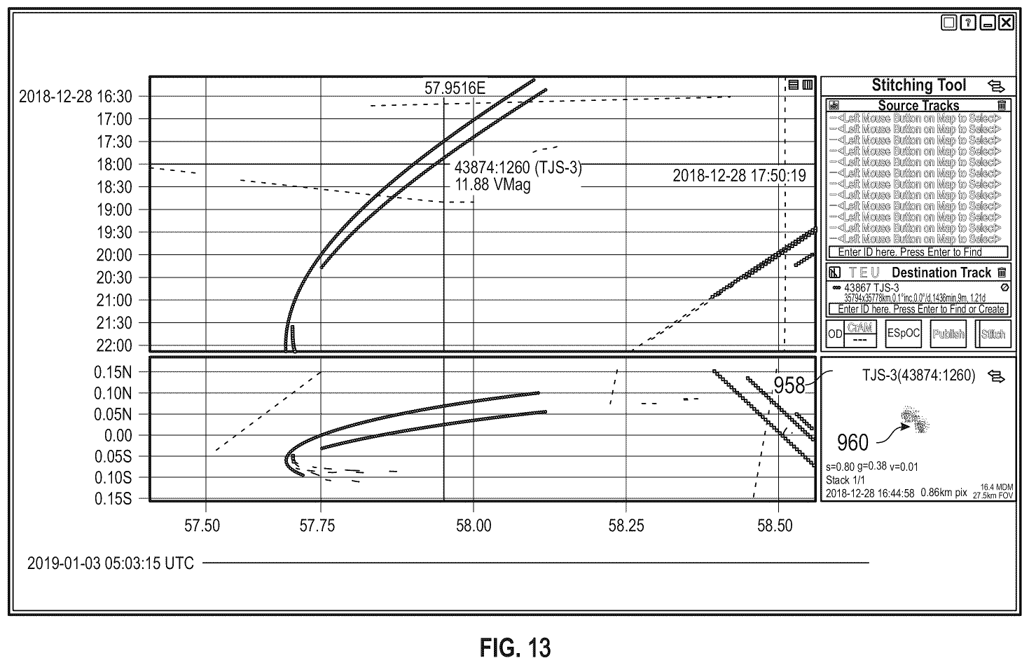

The system can receive a plurality of photographs of space objects within a time domain. Each of the plurality of photographs can correspond to a latitude domain, a longitude domain, and/or a timestamp within the time domain. Based on a selection (e.g., by a user), the system can receive image data derived from the plurality of photographs. In certain embodiments, the system may receive a user selection of a latitude range within the latitude domain, a longitude range within the longitude domain, and/or a time range within the time domain. FIG. 13 shows a photograph based on a user-selection of a latitude range, a longitude range, and a time range of set of photographs. Once selected, the display can show an object image 960 within the image chip 958.

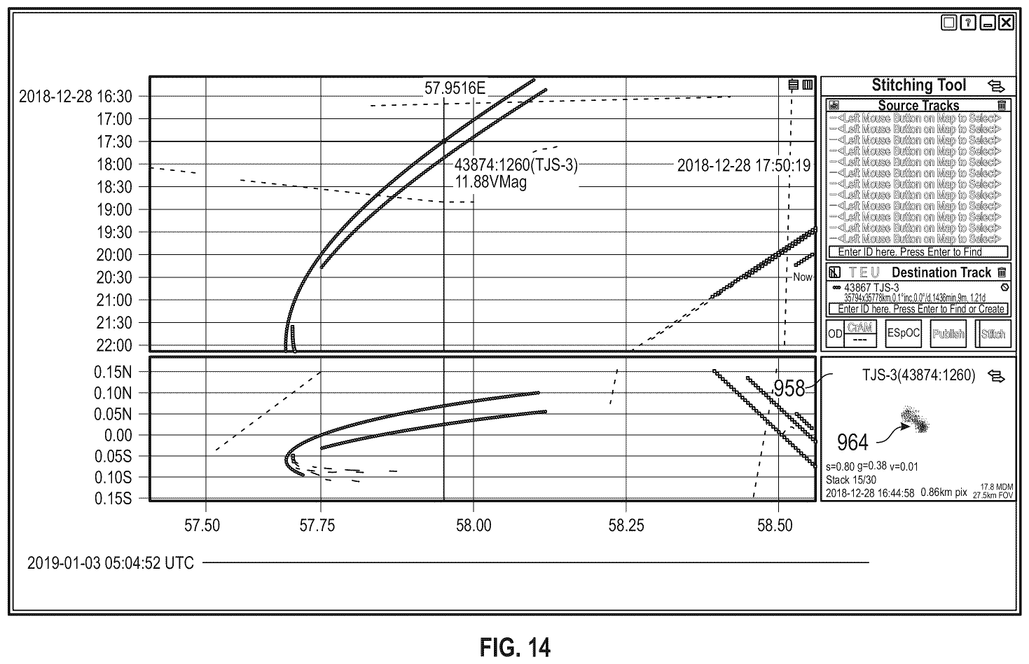

In response to the user selection, the system may modify the image shown in the image chip 958. FIG. 14 shows an example modified photograph (e.g., based on a set of photographs) relative to the photograph showed in FIG. 13. The modification may be based on at least one of the plurality of photographs received by the system. As shown in FIG. 14, the display interface can generate a display of the 958. As shown in the photographs of FIGS. 13-14, one or more of the space object's characteristics (e.g., location in photo, size, color, brightness, etc.) may be shown as being modified (e.g., the object may be removed from the photo).

The modified image may be a combination (e.g., a summation, overlay, etc.) of two or more images of the plurality of photographs within the selected latitude range, longitude range, and time range. For example, the system may integrate (e.g., summate values of) the image data derived from the plurality of photographs of space objects. For example, certain values (e.g., RGB values, color histogram values, image histogram values, brightness values, contrast values, contrast histogram values, etc.) may be added together and/or averaged across a plurality of photographs to determine a final (e.g., integrated) value. One of more of the photographs may show a plurality of space objects even though FIGS. 13-14 show only a single space object.

The system can receive a user selection of an object shown in a photograph and display a marker indicating a location of the object within the photograph. The marker may include any marker, such as a circle, a box, and/or crosshairs. In some embodiments, a user can select a time identifier and/or a name identifier associated with an object. Based on this selection, the system may display a marker indicating a location of the object within the photograph.

The system can be configured to automatically identify one or more objects within the modified image. Such modification may include increasing or decreasing a brightness, a contrast, or a gamma value of one or more photographs. Other changes may be made. For example, the system may reduce a characteristic of an object within at least one of the plurality of photographs. As another example, the system may remove an object within at least one of the plurality of photographs, as further discussed below.

When reducing a characteristic of an object, the system can reduce a brightest of the object within the photograph. Additionally or alternatively, a larger object (e.g., the largest object in the photograph) within the at least one of the plurality of photographs may be obscured or removed. In some embodiments, the system is configured to reduce a characteristic of an object based on a location of the object within the photograph. For example, a central object may be obscured or removed from the photograph. The user may select the object and/or the system may automatically detect the object. Additionally or alternatively, the system may reduce a characteristic of the selected object, such as a brightness. Other objects may be removed from the photograph or their visibility may be otherwise substantially reduced.

In some embodiments, the system develops each of image chips such that a space object is disposed at a predetermined location of each image chip of a plurality of image chips. For example, the space object may be disposed at or near a center of the image chip. This can allow a user more convenient and intuitive visual access to the space object within the chip. Additionally or alternatively, this arrangement can allow for fewer mistakes by the system in identifying the space object, such as when modifying one or more characteristics thereof, as disclosed herein.

It may be further advantageous to dispose the space object within the same predisposed location within the image chip within a particular range of latitudes, longitudes, times, etc. For example, the space object may be maintained at a center of each image chip even as corresponding latitude and longitudes ranges change for each image chip of the plurality of image chips as the space object moves through space. The system may use this information to predict a position of the space object position and/or an orbit of the space object orbit. The system may, based on the predicted space object's position and/or orbit, develop an image chip such that the predicted space object position and/or the space object orbit position (e.g., in an image chip where the expected position of the space object is located) is disposed at a center of the image chip. Other configurations are possible.

### Object Detection

It can be advantageous to be able to automatically and/or manually identify objects in the photographs or image chips. For example, the system may be configured to detect one or more objects (e.g., additional objects) that may not have been previously detected by the system or a user.

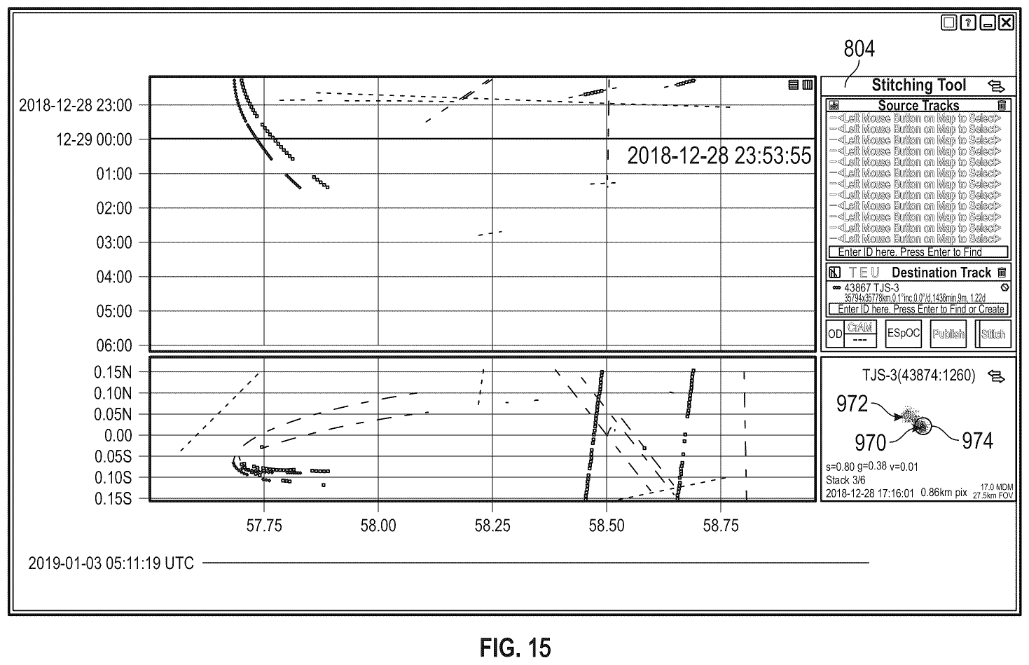

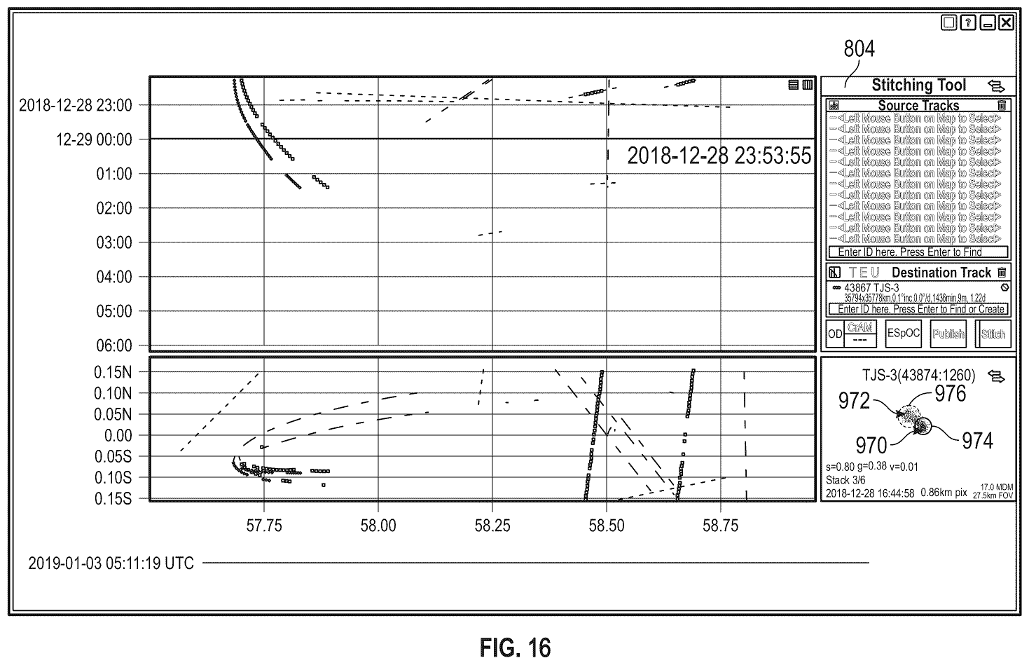

Reference will now be made to FIGS. 15-16. FIG. 15 shows an indication of a user-selected primary object 970 in a photograph and FIG. 16 shows an indication of a secondary object 972 detected by the system (e.g., based on the user selection of the first object, based on an automatic detection). As shown in the photographs of FIGS. 15-16, the primary and/or secondary objects may be selected using user-inputted time and/or name identifiers. The system can automatically identify the primary object 970 in the photograph. In some embodiments, the system may receive a user selection of the secondary object 972 object in the at least one of the plurality of photographs. The secondary object 972 may be more visible in part because of modifications to the photographs, as described herein. In response to the user selection of the secondary object 972 in the at least one of the plurality of photographs, derive a second set of identifiers corresponding to the second orbital object.

A display a marker can be displayed to indicate a location of the primary object 970 and/or the secondary object 972 (and/or other objects) within the photograph. The marker(s) 974, 976 can be one or more of a circle, a box, crosshairs, and/or some other visual or audible marker. For example, as shown in FIG. 16, the secondary object selection identifier 976 may be a dotted-lined circle. The primary object selection identifier 974 may be a different shape, size, color, etc. to distinguish it from the secondary object selection identifier 976. Various colors or highlights may additionally or alternatively be included to mark its location in the photograph.

In some embodiments, a user can select a time and/or name identifier to signal to the system a particular location or other characteristic of the secondary object 972. The system can receive the time and/or name identifier display a marker indicating a location of the secondary object 972 within the at least one photograph. The user can enter the secondary object's 972 via various input methods, such as a mouse, keyboard, eye gesture, hand gesture, and/or other indication.

In some embodiments, the system may be configured to derive a set of identifiers associated with the secondary object 972 to automatically identify the secondary object 972 in one or more photographs. For example, the system may determine a particular contrast between an object and a background. Additionally or alternatively, the system may determine that a primary object (e.g., the primary object 970) appears to have an unusual shape, which may be an indication of another object in the frame. Such a contrast may be more apparent, for example, if a user and/or the system automatically adjusts a parameter of the image, such as the image's brightness, contrast, gamma value, and/or other characteristic. As noted above, this modification may include modifying a characteristic of the primary object 970 of the at least one of the plurality of photographs.

The system may receive the user input via two or more interface devices. For example, a combination of a keyboard, mouse, controller, headset, touch-interface, and/or other interfaces may be used.

### Orbit Determination

As noted above, one of the many advantages of the systems described herein includes the ability to track and/or predict space objects. The trajectory of a space object can be extremely challenging to calculate and predict. Yet, if determining a space object's position is challenging, predicting the trajectory (e.g., orbit) of the object into the future and/or based on limited data can often be even more complicated. Yet, in spite of these challenges, embodiments disclosed herein can accurately determine such trajectories and/or present those determinations in a format that a user can readily understand and manipulate. Such an interface combines access to an enormous dataset, direction to more interesting features and aspects of that dataset that a human user can understand, and often a user experience that allows for real-time interaction with those features and aspects that is intuitive and manageable. Indications of, and data on, an object's trajectory can be indispensable to a user in certain circumstance. Such data may help identify future collisions, and having access to the data may help protect life and property.

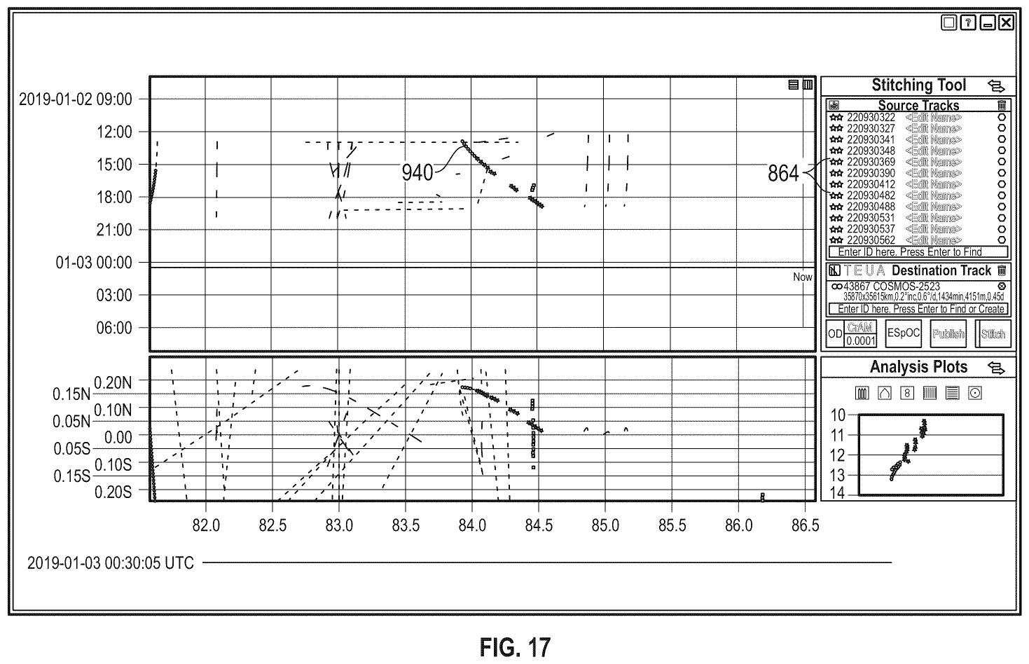

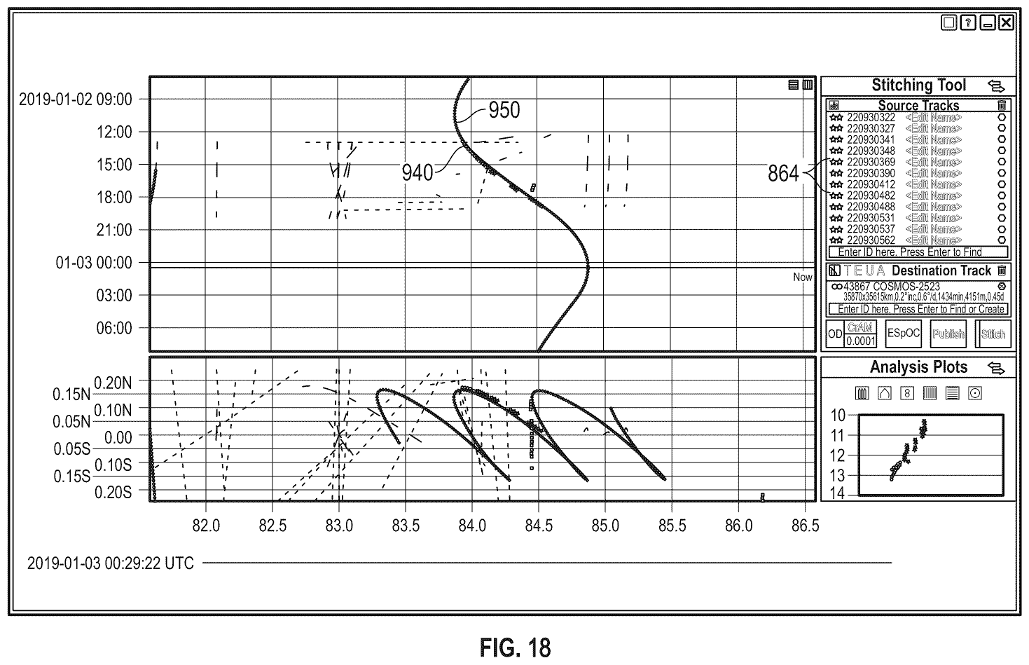

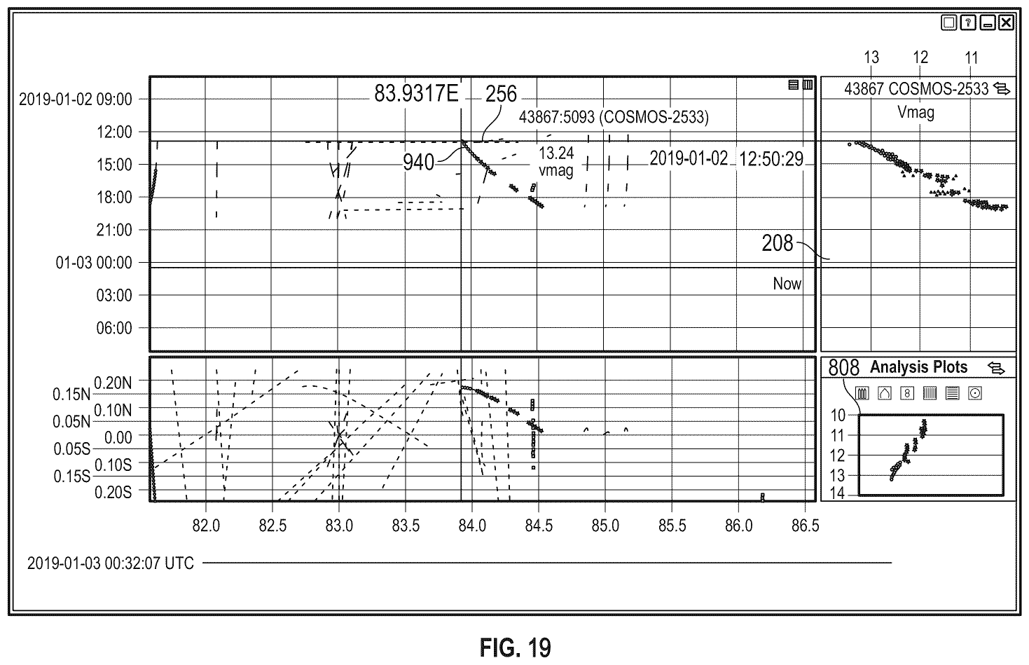

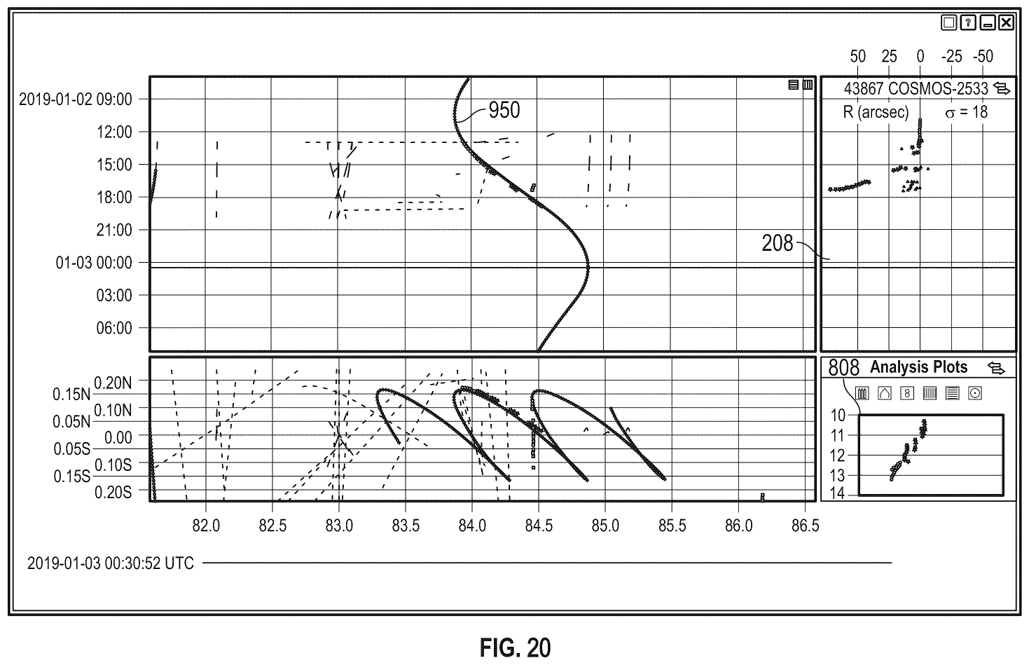

Reference will now be made to FIGS. 17-20. FIG. 17 shows a plurality of time points selected by user. FIG. 18 shows a track that extends both into the past and future. Tracks may include published orbit tracks and/or user-determined tracks. FIG. 19 shows an example of a longitude-time plot and a scalar-time plot showing same points. As shown, two or more plots may be used to show the same plurality of points and/or one or more of the same tracks. As shown in FIGS. 17-19, for example, a user may select timepoints by choosing a combination of time, name, longitude, and/or latitude identifiers. FIG. 20 shows a graph of residuals (either between published and user-selected or between published and system-determined). For example, as shown, the scalar-time graph 208 may indicate the residual between the system-determined timepoints and/or track and another (e.g., published) corresponding track. The scalar-time graph 208 shown indicates that a residual is near zero for some portions but deviates (e.g., to greater than 50) for other portions. Such a comparison can help the user and/or the system to calibrate the accuracy of the system's determinations. Additionally or alternatively, the user and/or system may be better able to determine the accuracy of the other corresponding track. As shown, the residual is represented as a sigma (“σ”) or other symbol. The residual may be shown as a difference, an average, a standard deviation, or other metric.

As shown, the system can receive a selection of a plurality of timepoints (e.g., from a remote or local database, as described herein) corresponding to one or more orbital objects. Each timepoint may include sets of identifiers within a selected time period. For example, as shown, the point marker 256 indicates that a user has selected the track representation 940. Based on these timepoints, the system can determine an orbital path of an orbital object associated with the selected plurality of timepoints, wherein the orbital path is determined over an orbital time period that includes a time period that (i) overlaps the selected time period, (ii) precedes the selected time period, (iii) succeeds the selected time period, or (iv) any combination thereof. The selected time period generally spans from a lower-time limit to an upper-time limit that may be selected by a user or in certain implementations by the system automatically. Based on the selection, the system can generate a display interface, such as the one shown in any of FIGS. 17-20. The selected time period can determine one or more axes of one of more graphs displayed, such as any of the graphs described herein. The display can show an indication of the orbital path of the object spanning the selected time period. This indication is represented as a predicted track representation 950 in FIGS. 18 and 20.

The selection of the timepoints may include a selection based one two or more identifiers of those timepoints. This selection may help the system identify a space object of interest. For example, the selection may be based on a selection of a time identifier and a name identifier, multiple time identifiers, multiple longitude identifiers, multiple latitude identifiers, a combination of these, or some other combination of identifiers.

A user may select an orbit determination selector to calculate an orbit associated with the one or more space objects. Once selected, the system can display an indication of the orbital path spanning a future-time period subsequent to the selected time period. Additionally or alternatively, the indication of the orbital path may span a prior-time period preceding the selected time period. As shown in FIG. 19, for example, an indication of the current time (e.g., the time the user is using the display) may be displayed. The current time may be shown as a line traversing at least part of a longitude-time graph and/or a scalar-time graph, for example, as shown in FIG. 19. Additionally or alternatively, a time of a selected timepoint may be displayed. Such times can orient a user around which part of the displayed orbital path covers a future time period. As shown, for example, in FIG. 20, the predicted track representation 950 may be displayed on a plurality of graphs simultaneously. Additionally or alternatively, the selected timepoints may be indicated on a plurality graphs.

Because the system in certain embodiments can predict the future position of the space object, the indicator of the current time may be displayed so as to indicate that the time period of the predicted track representation 950 spans a time later than the current time (e.g., the “future”).

It may be helpful for a user to compare a system-predicted path with a third-party published path (e.g., a path determined from a received path equation or other symbolic representation). The system may, through an orbital path data interface for example, receive orbital path data from one or more orbital path data sets (e.g., a third party data set, a previously predicted data set of the disclosed systems). Each of the received orbital paths may be associated with the same orbital object. The system can then display, based on the received orbital path data, an indication of a received orbital path (e.g., from the third party) spanning the selected time period. This orbital path may be in addition to or instead of the predicted track representation 950, for example.

In some embodiments, the system can determine the received orbital path based on a comparison of corresponding name identifiers associated with the received orbital path and the orbital path determined by the system. Because the orbital path data among the various predicted data may be slightly different, a comparison of the data may be helpful. Accordingly, the system may be able to compare the selected orbital path with the received orbital path and, based on the comparison, indicate a result of the comparison. For example, the system may determine and display a residual characteristic of the selected orbital path by determining a difference between a timepoint associated with the selected orbital path and a corresponding timepoint associated with the received orbital path.

Comparing the selected orbital path with the received orbital path may include determining a difference between at least one identifier (e.g., a time identifier, a latitude identifier, etc.) associated with the selected orbital path and a corresponding identifier of the received orbital path. The system may determine, for example, a residual characteristic (e.g., a level of accuracy or reliability) by calculating an ascension and/or a declination based on the data. Other configurations are possible.

### Maneuver and Transfer Determination

Once an orbit has been determined, it can be useful to determine how that orbit relates to another space object, such as an orbit of the other space object. Space objects may from time to time change their expected trajectory. For example, an altitude, longitude, latitude, and/or velocity may be altered. This alteration may occur through short accelerations (e.g., burns) and/or sustained (e.g., continuous) accelerations. In some instances, it may be desirable to adopt the orbit of a target space object or simply some other orbit. Adopting a new orbit, such as the orbit of a target space object, is called an orbit transfer. It may additionally or alternatively be desirable to not only adopt another orbit but to do so at the same or similar position of a target object (e.g., substantially along the same path as the other space object). Joining another object in such a way is called a rendezvous transfer. An orbit transfer or a rendezvous transfer may include a Lambert transfer, which is an expenditure of a minimum or substantially minimum change in velocity (or energy) of the object to complete the transfer. The change in velocity can be denoted as a “delta V.” In each of the orbit and rendezvous transfers, the object completes at least two separate maneuvers—an initial maneuver and a final maneuver.

A third type of transfer may involve a single maneuver. This type of transfer can be used to alter an orbit of an object to contact or impact another space object (e.g., substantially transverse to the path of the other space object). Such a maneuver may be used to perturb the path or orbit of the target object. This third type of transfer is called an intercept transfer. Each of these transfers, along with other details, is described in more detail below.

A user interface can be helpful in visualizing, identifying, and/or manipulating a path (e.g., orbit) of a space object. The user interface can include a display interface such as is disclosed herein (e.g., visualization display 100, 200). For example, the interface can include a longitude-time graph (e.g., having longitude and/or time axes). The interface can include a zoom control interface (e.g., a time axis zoom control interface, a longitude axis zoom control interface, etc.) and/or a pan control interface (e.g., a time axis pan control interface, a longitude axis pan control interface, etc.). The zoom control interface can allow a user to select a scale factor for one or more axes of a graph (e.g., a longitude-time graph, a longitude-latitude graph, a magnitude-time graph, etc.). Additionally or alternatively, the pan control interface can allow a user to move a lower and/or upper limit of a graph in the same direction.

The user interface can include one or more indications of orbital paths that have been stored, received, and/or determined by the system. The interface can allow a user to select an initial orbit of an orbital object and a target orbit. One or both of the initial and target orbits may be selected from stored, received, and/or determined orbits. The system may allow a user to quickly and easily toggle between which selected object corresponds to the initial orbit and which one corresponds to the target orbit, where applicable.

Using the interface, a user can select an orbit transfer window (e.g., an orbit transfer time window, an orbit transfer longitude window, etc.). The orbit transfer window can set boundary conditions for when and/or where an orbit transfer is to be initiated, at least partially take place, and/or be completed by a space object. The “now” line on the user interface may serve as a minimum boundary condition on time. The transfer window can identify how long an object has to complete a transfer, when the transfer can begin, and/or when it can end. Based on the transfer window, the system can automatically determine a transfer duration, a transfer start position, a transfer end position, and/or a total transfer distance. Automatically may mean occurring without further input from a user (e.g., execution instruction, selection, etc.). The system may allow a user to set a maximum computation time that determines how long the system can strive to best approximate the calculated value(s) within the set time. For example, a user may set a maximum computation time of about 0.01 s, 0.1 s, 0.5 s, 1 s, 2 s, 5 s, 10 s, 25 s, 30 s, 45 s, 60 s, or any value therein or a range of values having any endpoints therein. The transfer window can determine in part an efficiency of an energy expenditure by the selected object. For example, a larger time window may improve an efficiency of an energy expenditure of a selected object. A user can select a transfer action for the orbital object (e.g., an orbit transfer, a rendezvous transfer, an intercept transfer, etc.). As disclosed herein, the transfer action may include one, two, or more individual maneuvers. In some designs, details of each maneuver may be selected by the user. For example, one or more of the following parameters (e.g., maximum, minimum, target, etc.) of the space object may be selectable by a user: an energy change, a velocity change, a path angle change, an altitude change, a latitude and/or longitude change, a threshold distance from another object (e.g., another space object), a closing velocity, a solar phase angle (e.g., an angle between the vector toward the sun and the line of sight from one target to the other), etc. Other details of the space object may, if known, be identified by the user (e.g., mass of the object, name of the object, relationship of object to other space objects, etc.), such as those described herein.

The system can calculate or otherwise determine one or more details of an orbital object and/or of an orbit of the orbital object, such as is described above. Some details may apply to a change in a path of the orbital object, such as a transfer action. Many of these details include, for example, one or more of the following: a trajectory of the transfer path, a duration of one or more maneuvers, a total duration of a transfer action, a curvature of a path during one or more maneuvers and/or transfer actions, a velocity (e.g., speed and/or direction) of the object during one or more maneuvers and/or transfer action, a time of initiating and/or concluding one or more maneuvers and/or transfer actions, a contact time when an object encounters another object, a location of said encounter, an altitude during one or more maneuvers and/or transfer actions, a mass of the object, another scalar value (e.g., brightness, diameter, etc.) of the object, a closing velocity, a solar phase angle (e.g., an angle between the vector toward the sun and the line of sight from one target to the other), and/or any other detail of a space object.

For example, the system can determine a velocity change of the orbital object capable of causing the orbital object to move from the initial orbit to the target orbit within the transfer window (e.g., starting and/or ending the transfer within the transfer window). The system may additionally or alternatively calculate a transfer path of the orbital object corresponding to a path between the initial orbit and the target orbit. The path may begin and/or end within the transfer window, which may include a transfer time window. The system can modify the longitude-time graph to include an indication of the calculated transfer path.

In some designs, the system determines the initial orbit of the orbital object by using observations of the orbital object collected over a time period having an endpoint no later than a first maneuver timepoint (e.g., when the first maneuver is to begin). The calculated velocity change may be a minimum velocity change (e.g., in a Lambert transfer) needed to perform the maneuver and/or the full transfer action.

For certain transfer actions (e.g., the orbit transfer), the system may be configured to calculate, based on the orbit transfer window, a velocity change associated with a maneuver of the transfer action. The orbit transfer window can include a completion timepoint by which the orbit transfer is to be completed. The calculated second velocity change may be capable of causing the orbital object to move (e.g., after a first maneuver) into the target orbit within the orbit transfer time (e.g., based on the orbit transfer time window). The system can display an indication of the target orbit relative to the transfer path, such as described below. The indication of the calculated transfer path can include indications of timepoints corresponding to respective initiations of one or more maneuvers of the transfer action.

In some implementations, the system can determine a total velocity change. The total velocity change can include a summation of one or more velocity changes associated, for example, with corresponding one or more maneuvers of a transfer action.

As noted above, the transfer action can be an orbit transfer for adopting a target orbit. The transfer action can be a rendezvous transfer for joining a position and adopting an orbital path of a target orbital object.

The transfer action can additionally or alternatively include an intercept transfer for causing the orbital object to contact a target orbital object. The user may be allowed to select a minimum intercept velocity or other parameter (e.g., minimum energy, maximum intercept velocity, target path direction, etc.) associated with the orbital object as it contacts the target orbital object. As noted, a user can identify and/or select an orbit transfer window (e.g., time window) and/or one or more targetable objects from a subset of one or more potential objects (e.g., within a graph of the user interface).

The system can determine whether the transfer action (e.g., intercept transfer) is possible within the orbit transfer window. In some cases, for example, a particular transfer action may not be possible within a certain time frame. In some implementations, a maximum velocity change may be set by the system. For example, a maximum velocity change may be about 10 m/s, about 12 m/s, about 15 m/s, about 20 m/s about 25 m/s, or fall within any range having endpoints therein or having a value therein. In some implementations, the maximum velocity change is about 15 m/s. The system may be able to calculate a time and/or may display a timepoint corresponding to that time when the orbital object is to contact the target orbital object and/or adopt its orbit and/or position. The user interface can display this timepoint within the orbit transfer window if applicable.

The system can allow a user to update the orbit transfer window. In some designs, the system may automatically update calculated output (e.g., transfer path, contact time, contact location, maneuver time, etc.) in real-time based on a change in the orbit transfer window (e.g., by panning, by zooming, by direct input via an input interface, etc.). For example, the system may be configured to automatically calculate an updated transfer path of the orbital object in response to a user-updated orbit transfer time window. The system may allow a user to lock the display so that panning and/or zooming is temporarily disabled to allow, for example, for more precise window determination and more accurate calculations. Additionally or alternatively, the lock function may allow a user to pan and/or zoom without causing the system to automatically recalculate one or more details related to a transfer.

As noted above, some of the data may be obtained from a real-time telescope data connection interface configured to receive image data from historical and contemporary data sets. These data sets can be generated by a network of telescopes photographing the orbital object. From such photographs, one or more sets of identifiers can be identified about the space object.

A network of telescopes can have various specifications. The specifications may be referred to as “array specifications” or similar. The array specifications can describe one or more of the sensors in the network. The specifications may include a largest distance between any two of the array of co-located telescopes. The specifications may include what kinds of data the telescopes are equipped to capture, such as an available set of spectral ranges. Additionally or alternatively, the specifications can include a number of available pixels associated with one or more individual (e.g., single) telescopes of the array of co-located telescopes. The specifications can include a total number of available pixels associated with the array of co-located telescopes. The total number of available pixels may constitute a total effective sensor size. Additionally or alternatively, the array specifications can include an effective aperture size of the array of co-located telescopes and/or an aperture size of one or more of the telescopes of the array of co-located telescopes.

The system can display an indication of the current time (e.g., by a line and/or timestamp). The system may display the indication of the transfer path of the orbital object in relation to the indicator of the current time so as to indicate that at least part of the transfer action (e.g., an initiation and/or completion of the transfer action) occurs and/or spans a time later than the current time. Additionally or alternatively, the system may display the indication of the transfer path in relation to the indicator of the current time so as to indicate that at least part of the transfer action occurs and/or spans a time prior to the current time.

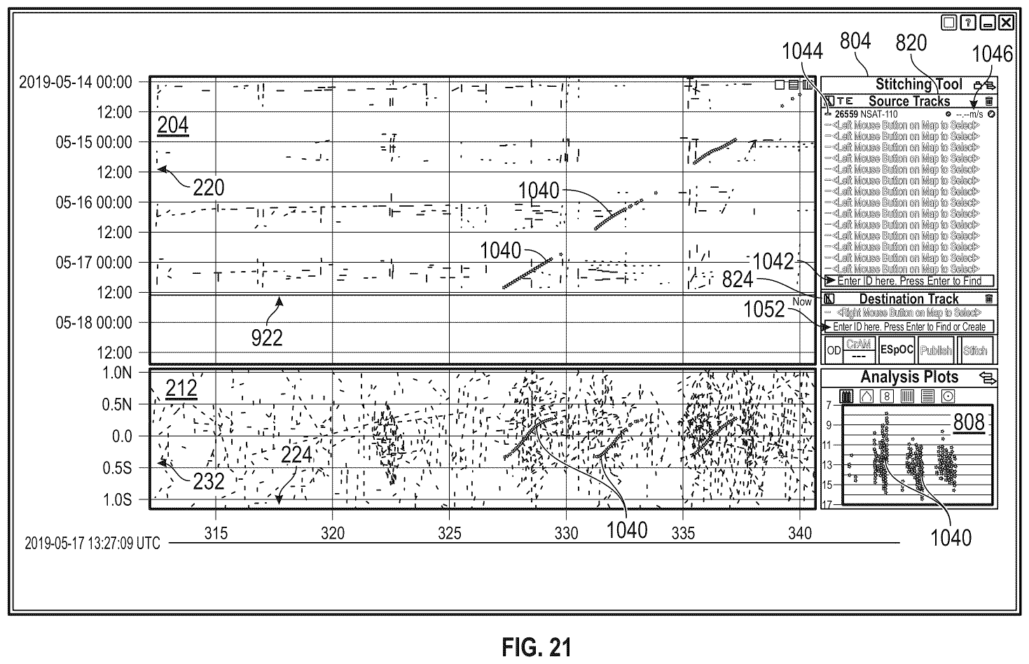

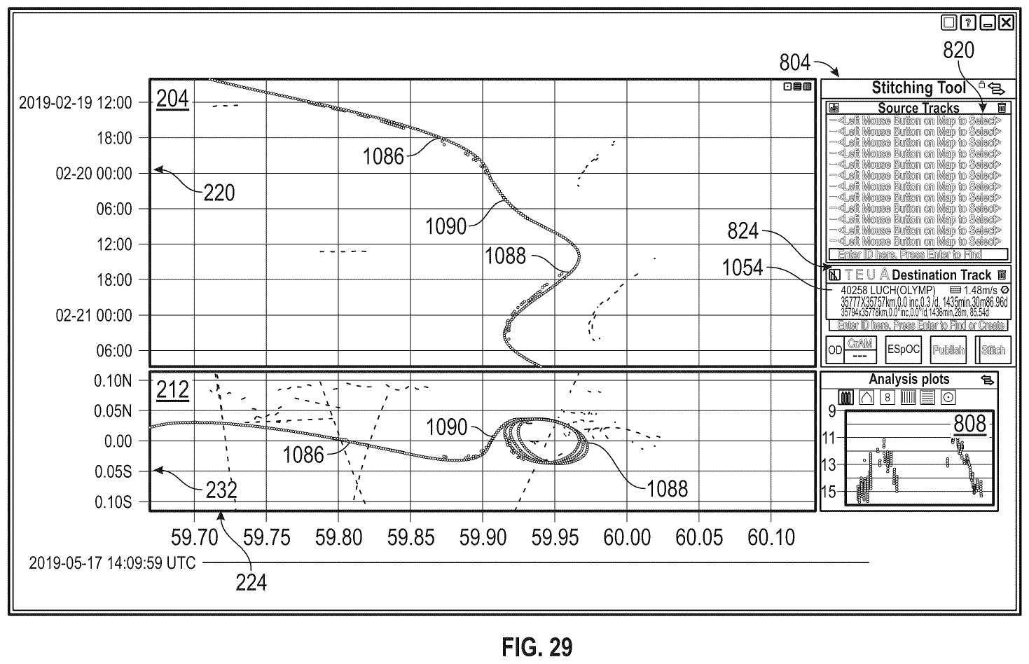

Turning now to the figures, the details above will be explained in greater detail and/or additional features will be described. FIGS. 21-23 show initial orbit selection, target orbit selection, and transfer action selection. FIG. 21 shows an interface having a longitude-time graph 204, a longitude-latitude graph 212, a stitching tool interface 804, and an analysis plot interface 808. It should be noted that many of the features described with reference to FIGS. 21-29 include one or more features of FIGS. 1-20. Where common numbers are used, similar or common functionality may be included.

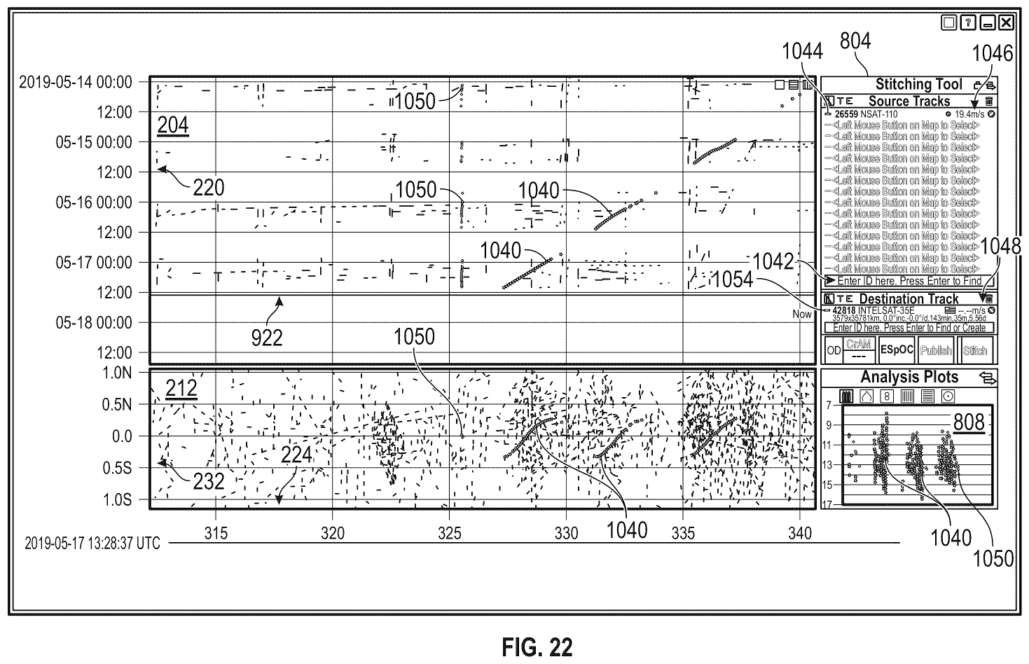

For example, FIG. 21 and FIG. 22 show a time axis 220, a latitude axis 232, and a longitude axis 224. A first plurality of elements may form an initial track 1040 and a second plurality of elements may form a target track 1050. One or both may be additionally or alternatively represented in the longitude-latitude graph 212 and/or the analysis plot interface 808. The analysis plot interface 808 may show a magnitude value of the tracks, as described in more detail above. One or both of these can be identified, for example, in the stitching tool interface 804. For example, the initial track identifier 1044 can indicate what track the initial track 1040 is (e.g., based on a color coordination, a shape coordination, etc.). Additional information may be provided about the initial track 1040 as shown, such as an identification number, a name, an associated country (e.g., origin, owner, etc.), and/or a velocity. Other details described herein may be included additionally or alternatively. Similar information may be presented for the target track 1050 via the target track identifier 1054. The “now” or “current time” line is indicated by the current time marker 922. FIG. 13 also includes an alert selector 1042 configured to allow a user to select a target one or more alerts from the source track region 820.

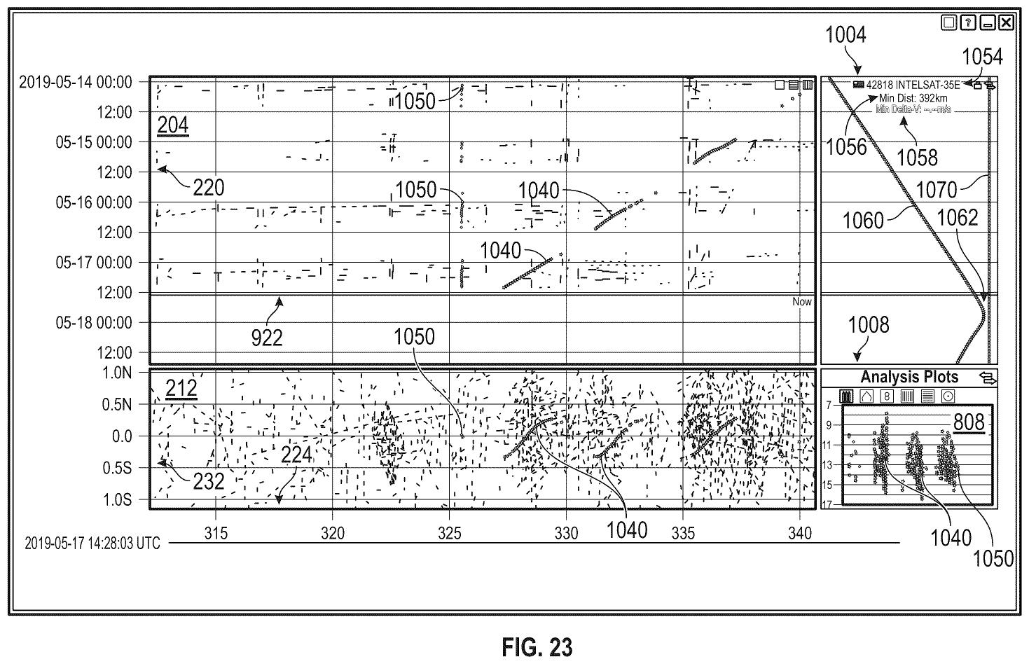

FIG. 23 shows an initial orbit 1060 and target orbit 1070 corresponding to the initial track 1040 and the target track 1050, respectively. The initial orbit 1060 and the target orbit 1070 may be shown within a transfer selection interface 1004, as shown. The transfer selection interface 1004 may be included additionally with, alternatively to, or part of the stitching tool interface 804. The transfer selection interface 1004 can include a transfer relationship axis 1008. The transfer relationship axis 1008 has units associated with distance in kilometers, though other units of distance (e.g., m, miles, etc.) may also be used. The vertical axis may correspond to the time axis 220. Additionally or alternatively, a separate axis (e.g., longitude, latitude, altitude, etc.) may be used. The transfer selection interface 1004 can include details about one or more orbital objects. As shown, details of the object associated with the target orbit 1070 are indicated, such as the target track identifier 1054, the distance differential indicator 1056, and the velocity differential indicator 1058. If a user selects a different target object, target track 1050, and/or target orbit 1070, different information may be indicated.

The transfer selection interface 1004 can allow a user to select a target type of transfer action. For example, a user may select a space object (e.g., by selecting a track, by selecting an orbit, by selecting a photograph, etc.) as well as a target space object and/or orbit (e.g., by selecting a track, by selecting an orbit, by selecting a photograph, etc.). The user may select the type of transfer (e.g., orbit transfer, rendezvous transfer, intercept transfer). The user may additionally or alternatively select various parameters, such as a transfer window, as described herein. Other details may be selected by the user, such as maximum values for a velocity, energy, etc., as described herein in more detail. A target final velocity may be selected. In some embodiments, the target velocity may be 0.1 km/s, 0.5 km/s, 1 km/s, 2 km/s, 5 km/s, or any value therein or fall within any range with endpoints therein.

In some designs, the system may automatically suggest a target space object/orbit. The system may also automatically update the interface to indicate one or more details associated with the combination of the target object/orbit with the selected transfer type (e.g., a calculated velocity change, a calculated time of completion, a calculated duration of transfer, etc.). The system may take into account other factors, such as a direction and/or energy of sunlight on one or more of the initial and/or target object.

As shown the initial orbit 1060 approaches the target orbit 1070. The system indicates that an expected closest approach 1062 is to occur sometime in the future. This is because the closest approach 1062 occurs below the current time marker 922. However, the closest approach 1062 could occur in the past in a different circumstance.

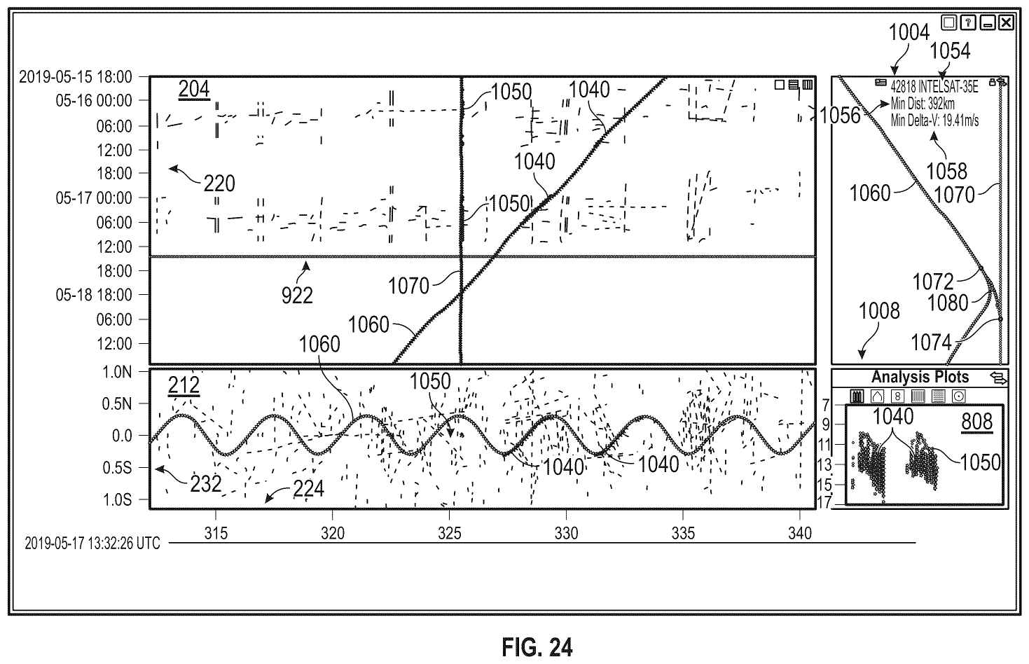

FIG. 24 shows an example intercept transfer via the user interface. As shown, the initial orbit 1060 and/or the target orbit 1070 may be indicated on one or more of the longitude-time graph 204, the longitude-latitude graph 212, and/or the analysis plot interface 808. In the transfer selection interface 1004, a transfer path 1080 is provided. The transfer path 1080 informs a user of a calculated path that a selected space object could take to complete the intercept transfer. Since the intercept transfer only requires a single maneuver, the intercept transfer has an initial maneuver point indicated by the transfer initiation indicator 1072 and an ending maneuver point indicated by the transfer completion indicator 1074. In this case, the transfer completion indicator 1074 indicates a time where the orbital object is expected to contact the target object. As shown, each of the transfer initiation indicator 1072, the transfer path 1080, and the transfer completion indicator 1074 occur below the current time marker 922, which indicates that the beginning and ending of the transfer action would occur in the future. Additionally or alternatively, the system may be able to identify such transfer actions in the past.

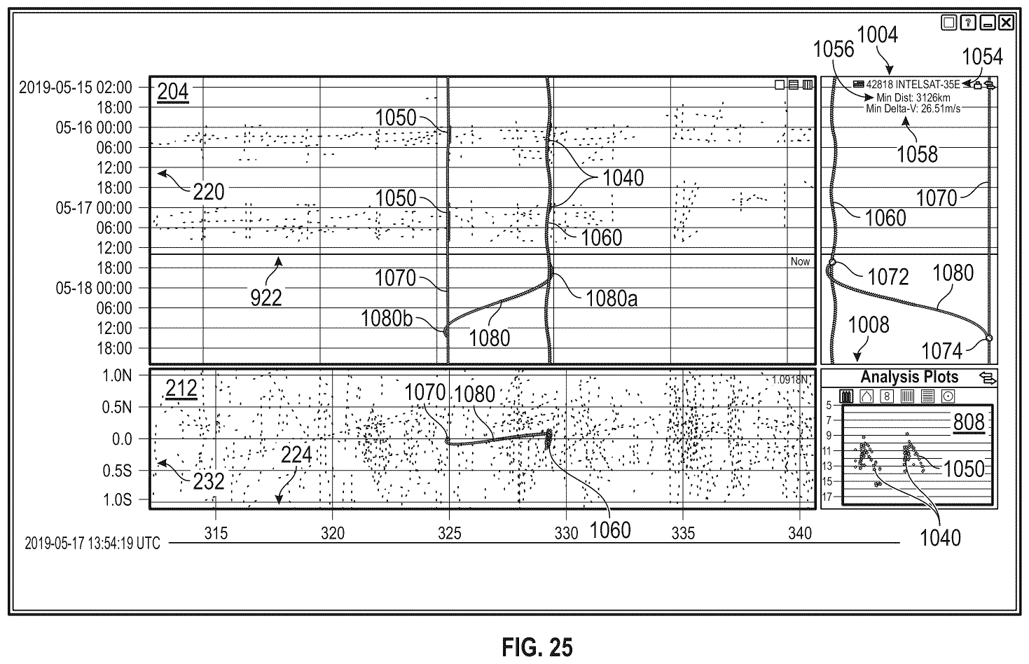

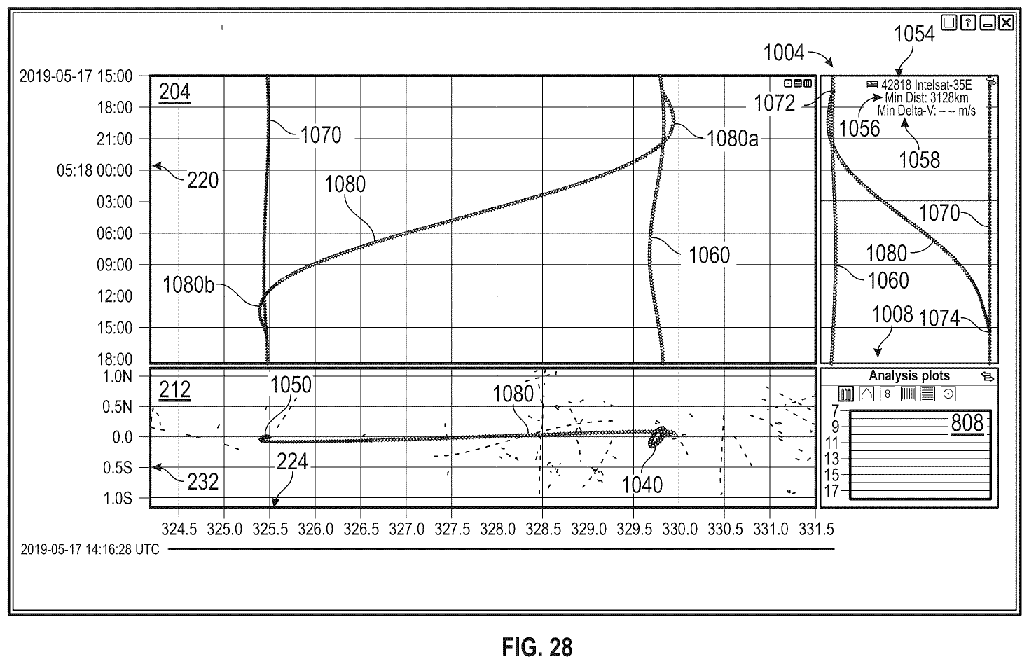

FIG. 25 shows an example rendezvous transfer via the user interface. As shown, the initial orbit 1060, the target orbit 1070, and/or the transfer path 1080 may be provided in one or more of the longitude-time graph 204, the longitude-latitude graph 212, and/or the transfer selection interface 1004. As shown, the initial orbit 1060 and the target orbit 1070 appear to be at a substantially constant longitude. Here, as indicated in the longitude-latitude graph 212, the initial orbit 1060 may also be a nearly substantially constant latitude. However, as shown below in FIG. 28, this appearance may be largely due to the zoom factor of the longitude-latitude graph 212. As shown in FIG. 25 (e.g., in the longitude-time graph 204), the rendezvous requires at least two maneuvers, each indicated by corresponding curves 1080a, 1080b of the “S-shape” transfer path 1080. The transfer path 1080 may indicate a visual transition between the initial track 1040 and the target track 1050. For example, a beginning of the transfer path 1080 (e.g., the first maneuver 1080a) may share the same or similar color as the initial orbit 1060 and/or an end of the transfer path 1080 (e.g., the second maneuver 1080b) may share the same or similar color as the target orbit 1070. Continuing the example, the color along the transfer path 1080 may indicate a smooth transition to suggest that the orbital object is transitioning from the initial orbit 1060 to the target orbit 1070. Additionally or alternatively, other visual indicators may be used, such as dot shapes, shadings, line dashings, number of lines, line style, highlighting, background color, and/or other indicator. Similar indicators may apply to the transfer initiation indicator 1072 and the transfer completion indicator 1074, respectively.

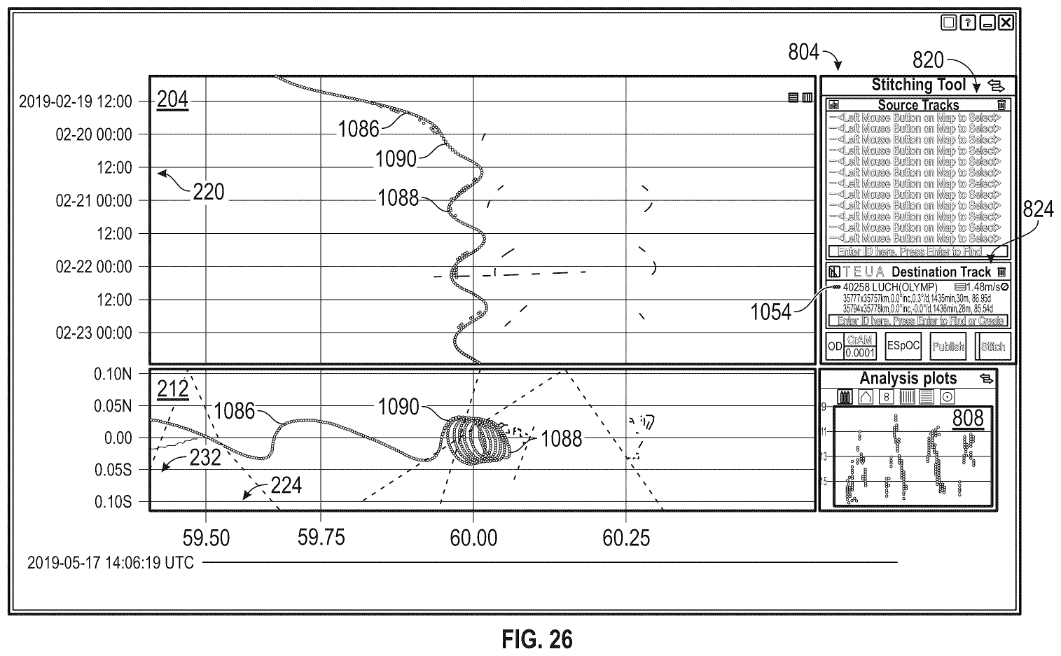

FIG. 26 shows a characterization of a maneuver that has moved an object from a first path to a second path. Sometimes an object has already changed its trajectory but what transfer has taken place may not yet be known. The system can allow a user to quickly and/or automatically determine and characterize the transfer that has taken place. The target track identifier 1054 shows details related to the object. As shown, an initial orbit 1086 of a space object is displayed in the longitude-time graph 204 and the longitude-latitude graph 212. A corresponding final orbit 1088 is also shown. When transferring between the initial orbit 1086 and the final orbit 1088, the object underwent at least one maneuver 1090. The maneuver 1090 can be identified by the system automatically and/or by the user. The maneuver 1090 may generally be difficult to detect by a human for a number of reasons. For example, photographic and/or other tracking data may not be available for a corresponding space object during the maneuver 1090. Additionally or alternatively, details of the space object may be incomplete during the maneuver 1090. The system may automatically identify the two orbits 1086, 1088 or receive a user selection of the two orbits 1086, 1088 and thus identify the intervening maneuver 1090. In this way, the system can automatically direct a user to find the maneuver 1090 within the user interface. The system may indicate or highlight the maneuver 1090 by, for example, displaying it using a different aspect (e.g., color, dot shape, shading, line dashing, etc.) from one or more of the initial orbit 1086 and/or the final orbit 1088.

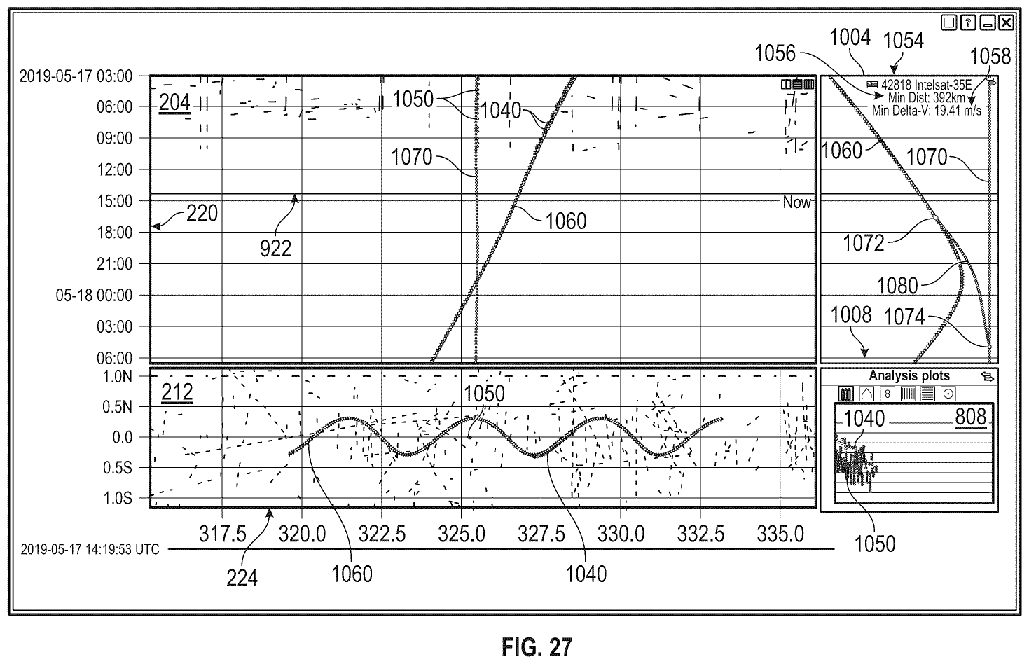

FIGS. 27-29 show panned and zoomed displays of corresponding FIGS. 24-26. Accordingly, the time axis 220, the longitude axis 224, the latitude axis 232, the analysis plot interface 808, and/or the transfer relationship axis 1008 have been zoomed and/or panned. As noted above, the system can let a user quickly and easily pan and/or zoom one or more of these axes of one or more of the graphs. This can help allow a user to focus in on particular details that may be of interest. Additionally or alternatively, the user can zoom out to obtain a more high-level perspective of one or more of the objects' movements. The system is tailored for either close-up or zoomed-out inspection of space objects and their movements and/or objects.

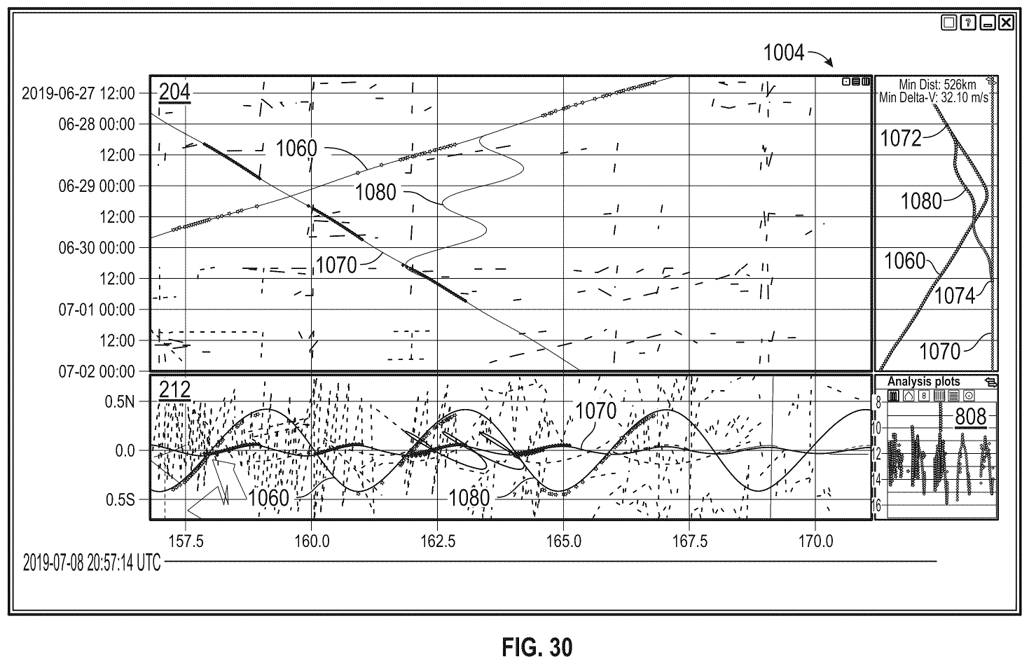

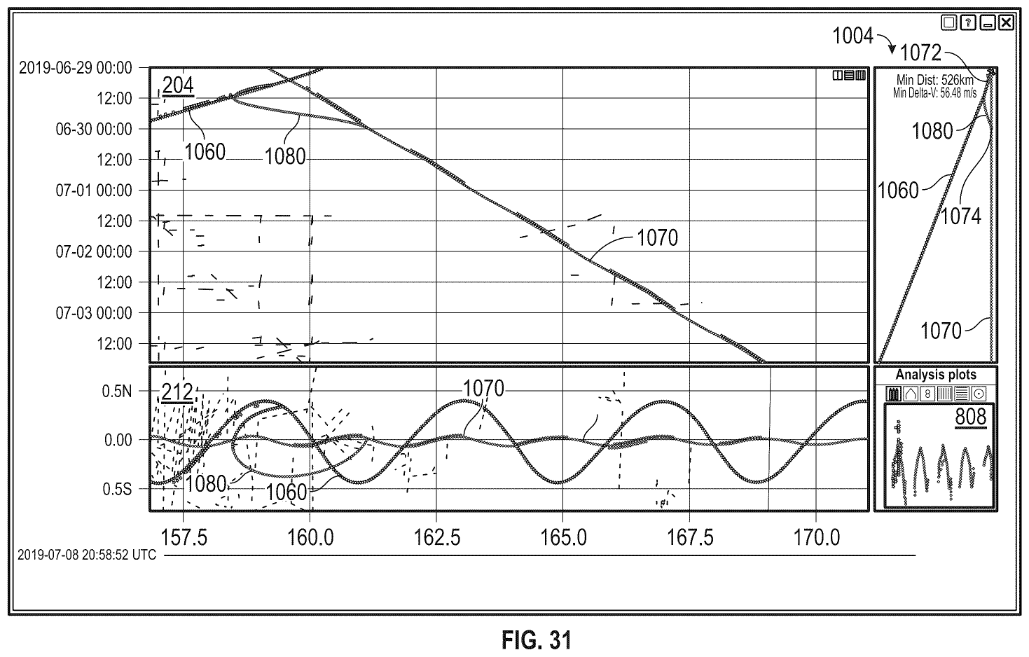

FIGS. 30-31 show an example of additional panned and zoomed displays where the system determines a different transfer based on the corresponding boundary conditions set by the display in the respective figure. As noted above, a user may select a viewing screen to be able to determine the boundary conditions (e.g., time range, latitude range, longitude range) of a desired transfer. For example, a user may be able to determine a time range in which the transfer must begin, in which the transfer must end, or both. In some configurations, the user may select whether the ending, the beginning, or both are required to be performed within the selected boundary conditions.

FIG. 30 shows an example determination of a boundary condition for which the completion of both the beginning and ending of the transfer path 1080 are required. As shown in the longitude-time graph 204 and in the transfer selection interface 1004, the transfer is to begin or has begun (as indicated, for example, by the transfer initiation indicator 1072) at around Jun. 28, 2019 at midnight. Further, as shown the transfer is to be completed or has completed just after noon on Jun. 30, 2019.

FIG. 31 shows the same initial orbit 1060 and target orbit 1070 as in FIG. 30 but with different boundary conditions (e.g., via a panning and zooming of the longitude-time graph 204). As shown, the transfer is to begin around 6 a.m. on Jun. 29, 2019 and is to end around midnight of Jun. 30, 2019. The boundary conditions of the selected time interval of the longitude-time graph 204 and/or the transfer selection interface 1004 in FIG. 31 do not include the calculated time for the beginning of the transfer in FIG. 30 (midnight of Jun. 28, 2019). Thus, according to the boundary conditions set by the user shown in FIG. 31 (and, in this case, the requirements that both the beginning and ending of the transfer occur within those boundary conditions), the same transfer as calculated for FIG. 30 is not calculated and/or shown. Accordingly, a user can quickly and intuitively identify a desired boundary condition in which to begin and/or end a transfer by panning and/or zooming on one of the graphs in the visualization display 200. As the user pans and/or zooms, the system can automatically and/or in real-time update one or more of the graphs to show the newly calculated transfer path 1080.

### Alert and Report Generator

The systems and methods described herein can be used to develop and display one or more reports configured to be read by a computer and/or human. The reports can be generated based on information collected as described above. The collected information can be analyzed, optionally with the supplementary input from a human user, to determine unique interactions between or among two or more space objects that have already occurred, that are occurring at a present time, that are expected to occur based on current trajectories, and/or that may occur based on contingent intermediate maneuvers of one or more space objects. The collected information can be analyzed to identify one or more maneuvers of a single space object. Thus, the systems and interactive graphical user interfaces described herein may be configured to generate a report on one, two, three, or more space objects and the path parameters associated therewith.

The systems described herein can determine whether a given space object is an active satellite under control of a launching or operating entity or an inactive object. This information may be obtained without having information provided about the true nature of the object. The nature of the object may be inferred through observations of its behaviors.

Behaviors of a single object can be divided into those that are observable via the astrometric characteristics of an object and those that are observable via its photometric characteristics. The photometric and astrometric characteristics of an object may not truly be independent. For example, the pose (orientation in 3-space) and motion of an object may affect the signature observed by a sensor. If this signature is faint, the ability of a sensor to localize the object may be degraded. In general, however, the astrometric and photometric behaviors may considered to be at least somewhat independently. One benefit of systems and methods described herein is to prevent unwanted interactions between space objects (e.g., unsafe close approaches, collisions, radio frequency interference, etc.) that may be prevented.

A report can be generated in response to a user selection. Additionally or alternatively, a report can be generated in response to an identification (e.g., manual, automatic) of one or more events that have occurred, are occurring at a current time, or that may occur under certain circumstances. Such events can trigger an alert or some other indication of the event. The alert can include a communication or indication on the graphical user interface and/or may be configured to be understandable by a human user or observer.

A first type of alert that may be triggered is a maneuver alert. Space objects, including orbital objects, may perform maneuvers from time to time. A maneuver can include a single maneuver or a plurality of maneuvers. Maneuvers that require two or more maneuvers may be referred to as “transfers.” Examples of such maneuvers include those discussed above, such as an orbit transfer, a rendezvous transfer, and an intercept transfer. Orbit transfers, for example, can include a shift to anther orbit. As an example, an orbital object may transfer to and/or from the graveyard orbit. Such maneuvers can include an increase or decrease in a delta V (e.g., instantaneous change in velocity) of the object.

An alert may be triggered when two or more space objects come into or are predicted to come into proximity with each other. The trigger may occur when a distance between two objects is measured or predicted to be below a threshold (e.g., minimum threshold). When closer than the threshold, the two objects may be referred to as being in conjunction with one another at a particular time or within a particular time window. Such an alert may be referred to as a “proximity alert” or a “conjunction alert.” Rendezvous and proximity operations (RPO) described herein (e.g., where a space object makes an intentional controlled approach to another space object) may reflect one or more orbit regimes, such as satellite servicing, inspection, and/or active debris removal.

Another maneuver includes station keeping, which involves a subtle movement by the space object to retain its current target orbital path. Often a space object (e.g., one orbiting at Geosynchronous Equatorial Orbit (GEO)) may be a government- or commercially-owned communications or weather satellite. When stationed in its assigned orbital location, the behavior of such an object may often be routine, with station-keeping maneuvers usually occurring on a predictable schedule. Sometimes persistent and precise observations may detect these relatively small maneuvers, and patterns can often be teased out of the observation data. As orbital objects revolve around a planet, the orbital object's orbit may deteriorate over time. Thus, a station keeping maneuver may be used to maintain the orbit and prevent and/or repair deterioration in the orbit. For example, a station keeping maneuver can prevent a loss of altitude, circularization, and/or other imperfection in the orbit. Circularization refers to the lack of eccentricity in an orbit.

While a station keeping maneuver can trigger an alert, a failure of an object to maintain a stable orbit can also trigger an alert. Such drifting can indicate that an object is no longer capable of maintaining a stable orbit and/or that control of the object has diminished or ceased. The system may be able to identify if an object is failing to maintain the stable orbit by identifying an expected value, such as a position, degree of circularization (e.g., angle of curvature), velocity, and/or acceleration, and comparing the expected value with a corresponding measured or observed value. Additionally or alternatively, the system may identify an alert when a drift rate has been increased, decreased, and/or changes directions.

Specific details (e.g., path parameters) of a space object's trajectory may trigger an alert. For example, a particular apparent destination or source orbit may trigger an alert. The system may, for example, identify an alert when a space object enters/exits a graveyard orbit, a geosynchronous orbit, a geostationary orbit, a semi-geosynchronous orbit, and/or other type of orbit.

In generating alerts, the system may identify a threshold (e.g., maximum threshold) that needs to be exceeded before an alert is triggered. For example, the system may generate an alert if a threshold difference between the expected value and the measured value is exceeded. The threshold can include a difference between an expected trajectory and a measured trajectory. For example, the threshold can refer, for example, to an angular threshold and may be about 0.05 degrees, about 0.1 degrees, about 0.2 degrees, about 0.3 degrees, about 0.5 degrees, about 0.8 degrees, about 1 degree, about 1.5 degrees, about 2 degrees, about 2.5 degrees, about 3 degrees, about 4 degrees, about 5 degrees, any value therein, or fall within any range having endpoints therein. The threshold may refer to a distance threshold and may be about 1 meter, about 5 meters, about 10 meters, about 20 meters, about 30 meters, about 40 meters, about 50 meters, about 60 meters, about 75 meters, about 100 meters, about 150 meters, about 200 meters, about 250 meters, any value therein, or fall within any range having endpoints therein. The threshold can refer to a velocity threshold and may be about 0.5 m/s, about 1 m/s, about 1.5 m/s, about 2 m/s, about 2.5 m/s, about 3 m/s, about 4 m/s, about 5 m/s, about 7 m/s, about 10 m/s, about 12 m/s, about 15 m/s, about 20 m/s, about 30 m/s, about 40 m/s, about 50 m/s, about 100 m/s, any value therein, or fall within any range having endpoints therein. In some embodiments, the threshold may be an isolated value (e.g., not a difference between two values). For example, an alert may be generated if a Delta-V value exceeds a threshold value.

Another event that may trigger an alert is the identification (e.g., appearance) of a new object. The system may be regularly (e.g., continuously) reviewing images of space to identify new objects. Additionally or alternatively, as described herein, a human user may aid the system in identifying new objects. A new object may be identified from a launch, a deployment, a third-party listing that draws attention to the object, and/or from a new visibility (e.g., manually and/or automatically). The identification of new objects may trigger an alert that can cause the system to generate a report. Additionally or alternatively, a lost space object may trigger an alert. An object may be lost when a space object does not appear at or near an expected location. The expected location may be an area or volume of space. The boundaries of the area or volume may be based on a threshold distance, area, or volume from or around a target point. Examples of such threshold distances are described herein. Threshold areas or volumes may be a 2D or 3D extension of such threshold distances.

Yet another example of a possible alert that may be triggered is when the system determines that a magnitude (e.g., intensity of light, light pattern) of a space object differs from an expected magnitude value. For example, one alert is triggered when an intensity of light differs from an expected intensity of light. Additionally or alternatively, the alert may be triggered if the shape or pattern of the light emitted and/or reflected from the space object is sufficiently different (e.g., greater than a threshold value) from an expected shape or pattern. Such an alert may be referred to as a “photometric anomaly alert” (PAA).

As described in more detail above, the system can receive a plurality of images of one or more space objects. Based on these images, the system can identify an intensity of light projected from the space objects at different times and positions. Using these images, the system can determine a model of a photometric pattern projected from the objects and, based on the model, determine an expected photometric pattern and/or intensity of light at a given future time.

Using the model (e.g., expected photometric pattern, intensity of light), the system can determine an attitude state, such as a relative attitude state, of the space object. Examples of such attitude states include a spin stable state, an attitude control state, an uncontrolled spin state (e.g., anomalous slewing), a directed orientation (e.g., dynamic slewing), and a tumble state (e.g., a low-aspect-ratio tumble). Dynamic slewing includes directing the objects orientation in a controlled way, such as apparently directing an attitude toward another object. An alert may be generated if a particular attitude state changes, such as a beginning, ending, or acceleration of an attitude state.

In some embodiments, the system identifies certain attitude states as non-alerts. For example, certain embodiments may use attitude states to identify alerts of objects that appear to be “dead” (e.g., apparently not controlled). However, in certain implementations, “live” objects may trigger alerts as described herein, such as the proximity and orbit transfer alerts.

One of the many advantages of the systems described herein includes the ability to identify and signal anomalous or otherwise interesting information to a human user and/or the computer system. Each alert can be based on tracking path parameters of a space object. The path parameters can include a position, a displacement, a speed, a velocity, an acceleration, a curvature of orbit (e.g., circularization), and/or any other detail of the object's orbit or other trajectory. Path parameters can additionally or alternatively include a relationship with one or more space objects (e.g., a distance from, a relative velocity/speed, a relative lighting advantage, etc.) such as described herein. A path parameter can include a detail of a departure or change in object trajectory (e.g., a maneuver, a transfer, etc.).

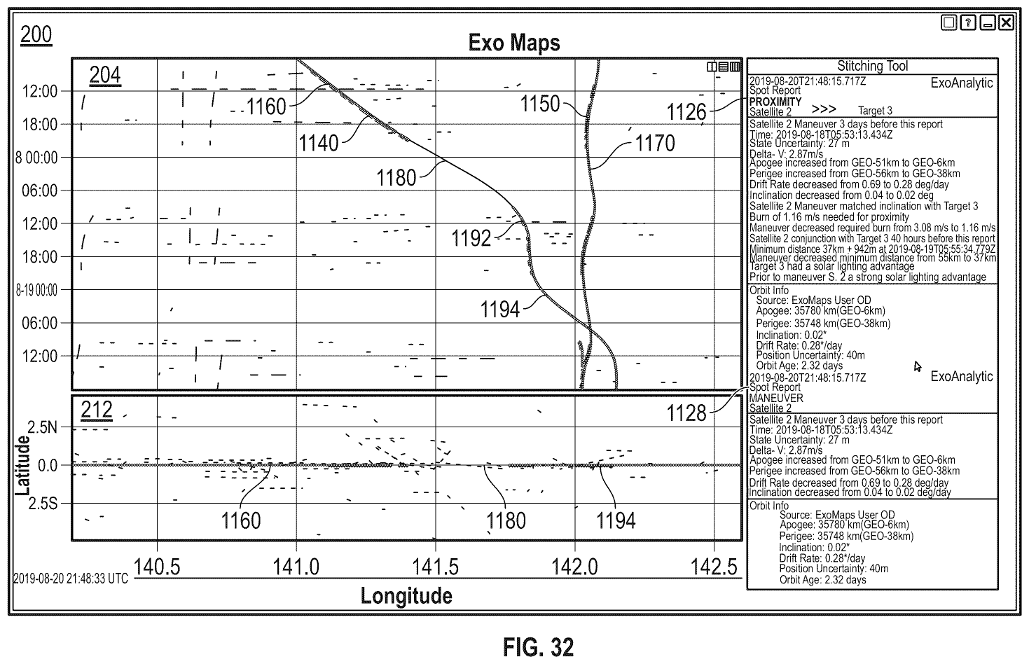

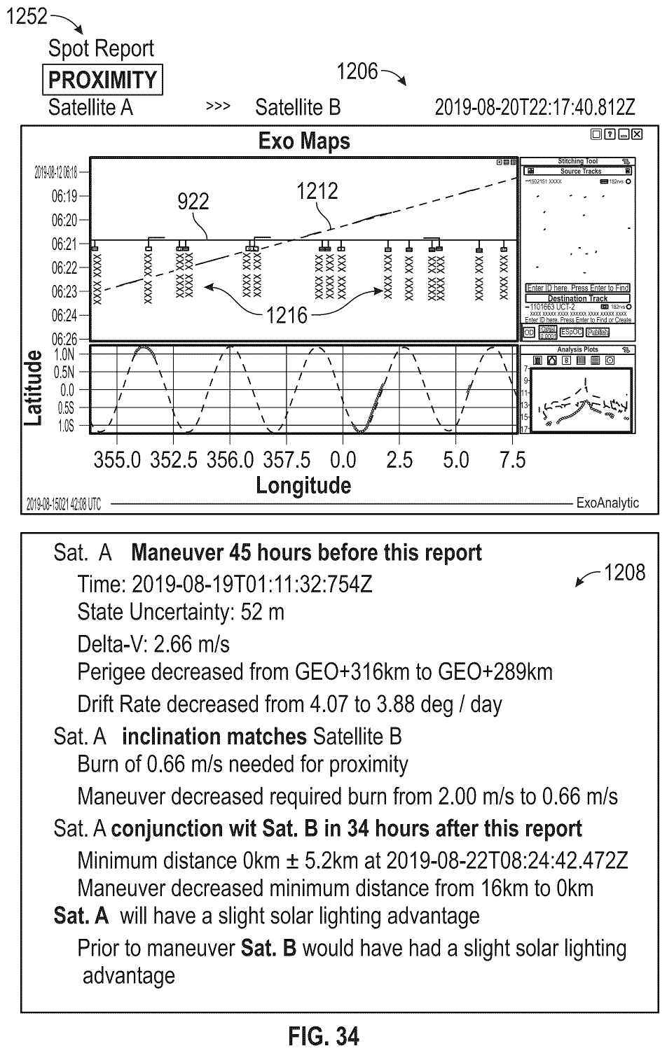

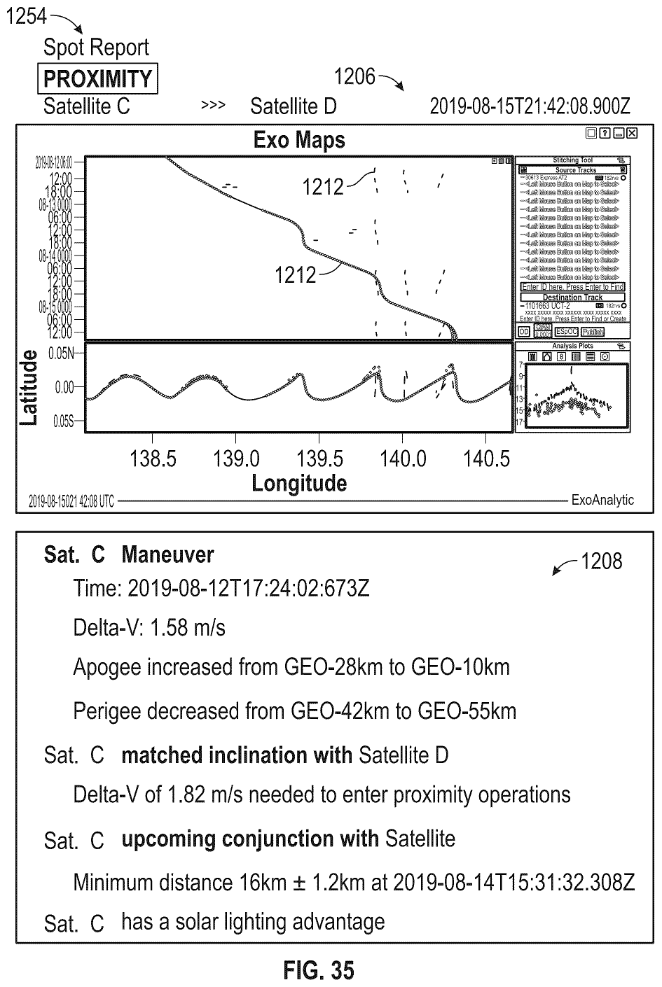

Various features of certain embodiments will now be described with reference to the figures. FIG. 32 shows an example visualization display 200 (e.g., interactive graphical user interface) with a proximity spot report and a maneuver spot report. The proximity spot report and the maneuver spot report may be indicated by the proximity spot report indicator 1126 and the maneuver spot report indicator 1128, respectively. The spot reports 1126, 1128 represent pop-up reports that can be shown directly in the visualization display 200, as shown. However, other types of displays and formats are possible, such as those described below with FIGS. 34-35. The longitude-time graph 204 and longitude-latitude graph 212 show two orbital paths of separate objects-Satellite 2 and Target 3. The initial orbit 1160 of Satellite 2 is shown, which is based at least in part on a corresponding initial track 1140 of Satellite 2. Following the initial orbit 1160, the visualization display 200 shows that Satellite 2 undertook one or more maneuvers to initiate a transfer path 1180 (e.g., a intercept transfer). Following the transfer path 1180, a final orbit 1194 of the Satellite 2 is displayed. The final orbit 1194 may be calculated in part based on a corresponding final track 1192 of Satellite 2. The initial track 1140 and final track 1192 each represent one or more data points (e.g., timepoints) associated with corresponding one or more images of the Satellite 2.

The Target 3 has an orbit represented on the visualization display 200 by the target orbit 1170, which is determined at least in part by its associated target track 1150. As shown in the longitude-time graph 204, the final orbit 1194 of Satellite 2 and the target orbit 1170 of Target 3 appear to reach their point of closest approach around 06:00 of Aug. 18, 2019.

In response to a user selection, a spot report may be generated. Such a report may be based on an alert identified by the system and/or may be based on a user search. For example, a user may select (e.g., click on) a particular alert, which may result in the automatic generation of the spot report. Additionally or alternatively, a user may search for one or more source objects (e.g., Satellite 2), one or more target objects (e.g., Target 2), a time or time window, a latitude or latitude range, a longitude or longitude range, and/or other search parameter.

As shown in FIG. 32, for example, a user has selected one or both of Satellite 2 and Target 3. In response, the proximity spot report indicator 1126 can include details such as when the maneuver occurred (e.g., 3 days before the generation of the report), at what time the maneuver occurred (e.g., at 5:53:13 on Aug. 18, 2019), a degree of uncertainty (e.g., positional uncertainty of about 27 m), a near-instantaneous change in velocity (e.g., Delta-V) of the source object Satellite 2 (e.g., 2.87 m/s), a change in apogee (e.g., increase from GEO−51 km to GEO−6 km), a change in perigee (e.g., increase from GEO−56 km to GEO-38 km), a drift rate change (e.g., decrease from 0.69 deg/day to 0.28 deg/day), and/or change in inclination (e.g., decrease from 0.04 deg to 0.02 deg).

The report may additionally or alternatively include a status of any matches of the above factors to a target object (e.g., Target 2) and/or related information. For example, the system may identify that the maneuver of Satellite 2 caused it to have a matched inclination with Target 2, which required a burn of 1.16 m/s to achieve proximity. A change in burn economics (e.g., a decrease or increase) based on the maneuver can be shown (e.g., decrease from 2.08 m/s to 1.16 m/s). The report can include a time of when the conjunction occurred (e.g., 10 hours before the generation of the report). A minimum distance (e.g., 37 km+/−942 m) of the conjunction and/or the time of the conjunction (e.g., 5:55:34 on Aug. 19, 2019) can be displayed. An effect on the minimum distance and/or on the time of conjunction (e.g., maneuver decreased minimum distance from 55 km to 37 km) can be displayed.

It may be advantageous to know whether one or more objects had a solar lighting advantage. For example, an object may be equipped with image sensors to obtain details about another object, such as when the conjunction occurs. The proximity spot report 1126 can additionally or alternatively include an indication of which object had a solar lighting advantage during the conjunction (e.g., Target 3 had a solar lighting advantage) and/or whether the maneuver changed the nature of the solar lighting advantage (e.g., Satellite 2 had a strong solar lighting advantage prior to the maneuver).

Other path parameters of the source object (e.g., Satellite 2) and/or target object (e.g., Target 3) can be calculated and displayed. For example, the details of the orbit of Satellite 2 are shown in FIG. 32—Source: ExoMaps User OD; Apogee: 35780 km (GEO−6 km); Perigee: 35748 km (GEO−38 km); Inclination: 0.02 degrees; Drift Rate: 0.28 degrees/day; Position Uncertainty: 40 m; Orbit Age: 2.32 days.

As shown, the system also generated a maneuver spot report 1128. A system may generate one or more spot reports. The maneuver spot report 1128 indicates path parameters associated with the path of the source object (e.g., Satellite 2). Here, because the proximity report already included details of the maneuver (e.g., time of maneuver, effect, etc., as discussed above), those details are not listed again here.

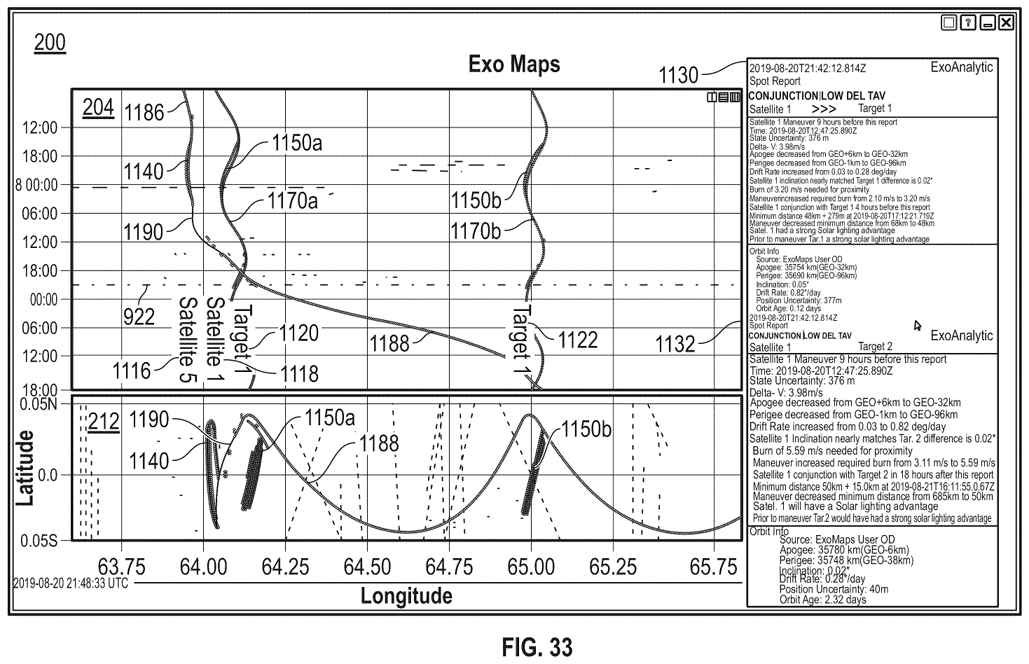

FIG. 33 shows two example conjunction spot reports 1130, 1132. The first conjunction spot report 1130 describes details associated with a conjunction between a source object Satellite 1 and a first target object Target 1. The second conjunction spot report 1132 shows details related to a conjunction between the Satellite 1 and a second target object Target 2.

The longitude-time graph 204 and longitude-latitude graph 212 visually show details of the paths of the Satellite 1, Target 1, and Target 2. The visualization display 200 shows an initial orbit 1186, maneuver path 1190, and a final orbit 1088. The initial orbit 1186 is calculated in part based on the initial track 1140. The visualization display 200 shows the first target orbit 1170a (e.g., based at least in part on the first target track 1150a) and the second target orbit 1170b (e.g., based in least in part on the second target track 1150b). One or more of the elements described above may be displayed by the longitude-time graph 204, the longitude-latitude graph 212, another graph described herein (e.g., the magnitude-time graph), and/or any combination thereof.

The longitude-time graph 204 shows a current time marker 922. The final orbit 1088, first target orbit 1170a, and the second target orbit 1170b each span before and after a current time, as indicated by their display below and above, respectively, the current time marker 922. In some embodiments, as a user zooms into the longitude-time graph 204 and/or the longitude-latitude graph 212 to a certain threshold of detail, one or more object indicators may be shown. The visualization display 200 shows a Satellite 5 indicator 1116, a Satellite 1 indicator 1118, a Target 1 indicator 1120, and/or a Target 2 indicator 1122. These object indicators may indicate where a corresponding orbit would intersect the current time marker 922 in the absence of any intervening maneuvers. In some embodiments, the location of the object indicators may based on a relative location of the paths of the respective object orbital paths. Note that no tracks (e.g., initial track 1140, first target track 1150a, second target track 1150b) are indicated below the current time marker 922 since no future images of objects would yet be available for analysis.

As shown, the first conjunction spot report 1130 includes details related to a maneuver of Satellite 1 that already caused a conjunction (e.g., historical conjunction) with Target 1. As shown, the maneuver occurred 9 hours before the generation of the report. The maneuver occurred at 12:47:25 on Aug. 20, 2019 with a degree of positional uncertainty of 376 m and a Delta-V of the Satellite 1 of 3.98 m/s. The first conjunction spot report 1130 shows a decrease in apogee from GEO+6 km to GEO−32 km and a decrease in perigee from GEO−1 km to GEO−96 km and a drift rate increase from 0.03 deg/day to 0.82 deg/day.

The first conjunction spot report 1130 indicates that Satellite 1 and Target 1 had a matched inclination with a difference of 0.02 degrees, which required a burn of 3.20 m/s to achieve proximity. The required burn increased from 2.10 m/s to 3.20 m/s. The conjunction occurred 4 hours before the generation of the report. A minimum distance of 48 km+/−279 m of the conjunction occurred at 17:12:21 on Aug. 20, 2019. The maneuver decreased a minimum distance from 68 km to 48 km. The first conjunction spot report 1130 indicates that Satellite 1 had a solar lighting advantage during the conjunction but that prior to the maneuver, Target 1 had a strong solar lighting advantage.

Other path parameters of Satellite 1 are shown in FIG. 33—Source: ExoMaps User OD; Apogee: 35754 km (GEO−32 km); Perigee: 35690 km (GEO−96 km); Inclination: 0.05 degrees; Drift Rate: 0.82 degrees/day; Position Uncertainty: 377 m; Orbit Age: 0.12 days.

FIG. 33 also shows an example second conjunction spot report 1132 that shows an expected conjunction (e.g., future conjunction) between Satellite 1 and Target 2. As shown, the maneuver shares the same characteristics of the maneuver described by the first conjunction spot report 1130, so those details will not be repeated. The second conjunction spot report 1132 indicates that Satellite 1 and Target 2 had a matched inclination with a difference of 0.02 degrees, which required a burn of 5.59 m/s to achieve proximity. The required burn increased from 3.11 m/s to 5.59 m/s. The conjunction is not expected to occur until 18 hours after the generation of the report. A minimum distance of 50 km+/−15.0 km of the conjunction occurred at 16:11:55 on Aug. 21, 2019. The maneuver decreased a minimum distance from 685 km to 50 km. The second conjunction spot report 1132 indicates that Satellite 1 will have a solar lighting advantage during the conjunction but that prior to the maneuver, Target 2 would have had a strong solar lighting advantage but for the maneuver by Satellite 1. Other path parameters of Satellite 1 are shown in FIG. 33, but as above, these details repeat the orbit information shown by the first conjunction spot report 1130 and are not repeated here.

FIGS. 34-35 show two example proximity spot reports 1252, 1254, respectively. The proximity spot reports 1252, 1254 show reports that can be presented to a human user in an easily digestible format. The proximity spot reports 1252, 1254 do not require access to the visualization display 200 described above but can be prepared (e.g., printed) and presented to a human user after analysis by the computer system and/or one or more human users has been conducted.

FIG. 34 shows an example first proximity spot report 1252 showing a conjunction between Satellite A and Satellite B. The first proximity spot report 1252 includes a display interface detail 1206 and a spot report detail 1208. The display interface detail 1206 shows an object orbit 1212 (e.g., of the Satellite A and/or of the Satellite B), a current time marker 922, and a plurality of object indicators 1216. The object indicators 1116 can include identifiers such as country flags, position indicators (e.g., lines, arrows), activity details (e.g., blinking, highlighting, font adjustments) based on current or otherwise relevant object behavior (e.g., a satellite may blink or be highlighted based on a recently obtained alert related thereto). Other details, such as those described above, are shown but are not discussed here in detail. For example, details of the source and/or target objects can be shown in with the stitching tool interface (e.g., stitching tool interface 804 of FIG. 22) and/or the analysis plot interface (e.g., analysis plot interface 808 of FIG. 22).

The spot report detail 1208 shows that Satellite A maneuvered at 01:11:32 on Aug. 19, 2019, which was 45 hours before the generation of the first proximity spot report 1252. The state uncertainty is 52 m with a Delta-V of 2.66 m/s. The perigee decreased from GEO+316 km to GEO+289 km with a decrease in drift rate from 4.07 degrees/day to 3.88 degrees/day. Satellite A is expected to match the inclination of Satellite B, and 0.66 m/s of burn is required for proximity. The maneuver decreased a required burn rate from 2.00 m/s to 0.66 m/s. The first proximity spot report 1252 indicates that the conjunction is expected to occur 34 hours after this report with a minimum distance of 0 km+/−5.2 km at 08:24:42 on Aug. 22, 2019. The maneuver decreased the minimum distance from 16 km to 0 km and will give Satellite A a solar lighting advantage, even though prior to the maneuver, Satellite B would have had a slight solar lighting advantage.

FIG. 35 shows a second proximity spot report 1254 in response to a maneuver performed by Satellite C. The second proximity spot report 1254 includes a display interface detail 1206 and a spot report detail 1208. The display interface detail 1206 includes a plurality of object orbits 1212, including the orbits of Satellites C and D.

The spot report detail 1208 shows that Satellite C maneuvered at 17:24:02 on Aug. 12, 2019, with a Delta-V of 1.58 m/s. The apogee increased from GEO−28 km to GEO−10 km and the perigee decreased from GEO−42 km to GEO−55 km. Satellite C matched the inclination of Satellite D, and a Delta-V of 1.82 m/s is required to enter proximity operations. The second proximity spot report 1254 indicates that the conjunction is expected to occur with a minimum distance of 16 km+/−1.2 km at 15:31:32 on Aug. 14, 2019. The maneuver will give Satellite C a solar lighting advantage.

### Alert and Other Data Management

The systems can display and manage alerts (e.g., description, report, update, etc.). Certain alerts may be automatically generated while others may be generated as a result of user interaction with a user interface. In some embodiments, the user interfaces may display to a user one or more alerts. The user may be able to select an alert and view the alert or metadata associated with the alert, update the alert, remove the alert, transmit the alert to another computer, and/or take another action related to the alert. The alert may notify a user of unique interactions between or among two or more space objects that have already occurred, that are occurring at a present time, that are expected to occur based on current trajectories, and/or that may occur based on contingent intermediate maneuvers of one or more space objects. Accordingly, the alerts may include a report and/or other alert data related to one, two, or more space objects and/or path parameters associated therewith.

As discussed above, there are many kinds of alerts that can be identified and/or generated by the systems described herein. For example, an alert can be related to a maneuver, a proximity of two space objects, a station keeping of a space object, a failure to station keep by a space object, failure to maintain a stable orbit, an apparent destination or source orbit of a space object (e.g., to/from a graveyard orbit, etc.), a drift rate of a space object, an appearance of a new object, a disappearance of a known object, a change in a magnitude (e.g., radiometric measurement) associated with one or more space objects, and/or other conditions or scenarios described herein may result in generation of an alert.

In some embodiments the system may be able to predict what a user determines to be an alert. For example, the system may use a trained machine learning model to develop predictions for what a user may identify as important alerts and/or what a user identifies as a dismissible alert. The methods and systems for using deep learning techniques to arrive at what is an important or dismissible alert, alone or in combination with other data (e.g., user input). Deep learning techniques in the form of one or more algorithms can be used to analyze the alerts. An algorithm can obtain results of user responses to alerts as input data and output a prediction of a user outcome of an alert. The algorithm may utilize a neural network, such as a convolutional neural network (CNN), or some other machine learning model. In some embodiments, the algorithm includes a particle filter that is configured to probabilistically assign a condition that most likely matches or fits with characteristics associated with each dismissed and/or maintained. This probabilistic assignment may be based on hundreds, thousands, or even millions of relevant alerts as prior information.

The system can receive alert input, pass the alert input through a machine learning model, such as, for example, a convolutional neural network (CNN), and receive an alert status output. The machine learning model can receive the alert input and pass it to one or more model layers. The model layers can include a plurality of convolutional layers that “convolve” with a multiplication or other dot product. Additional convolutions may be included, such as pooling layers, fully connected layers, and normalization layers. One or more of these layers may be “hidden” layers because their alert inputs and alert status outputs are masked by an activation function and a final convolution.

Pooling layers may reduce the dimensions of the data by combining the alert status outputs of neuron clusters at one layer into a single neuron in the next layer. Pooling may be a form of non-linear downsampling. Pooling may compute a max or an average. Thus, pooling may provide a first approximation of a desired feature, such as a degree of damage to a hair follicle or other sample. For example, max pooling may use the maximum value from each of a cluster of neurons at a prior layer. By contrast, average pooling may use an average value from one or more clusters of neurons at the prior layer, as represented schematically in FIG. 2. Maximum and average pooling are only examples, as other pooling types may be used. In some examples, the pooling layers transmit pooled data to fully connected layers. Fully connected layers can connect every neuron in one layer to every neuron in another layer. Thus, fully connected layers may operate like a multi-layer perceptron neural network (MLP). A resulting flattened matrix can pass through a fully connected layer to classify alert input.

At one or more convolutions, the algorithm can use a sliding dot product and/or a cross-correlation. Indices of a matrix at one or more convolutions or model layers can be affected by weights in determining a specific index point. For example, each neuron in a neural network can compute an alert status output value by applying a particular function to the alert input values coming from the receptive field in the previous layer. A vector of weights and/or a bias can determine a function that is applied to the alert input values. Thus, as the machine learning model proceeds through the model layers, iterative adjustments to these biases and weights results in a defined alert status output, such as a likelihood of a user dismissal of the alert, or the like.

### Software-Defined Telescopes

Sensors that sense and track space objects are large, bulky, expensive, and otherwise prohibitive for many of the tasks described herein. For example, the sensors can remain non-operational for extended periods of time due to a variety of factors (weather, maintenance, natural disasters, attack, etc.). Accordingly, a need exists for improved sensors that solve one or more of these problems. Described herein are sensors that can obtain imagery of space objects. In some embodiments, the term “imagery” refers to image data obtained from an image sensor, such as a telescope. Additionally or alternatively, “imagery” may refer to the displayed image data. The sensors may be image sensors and may include one or more telescopes, such as a network or array of telescopes. A “network” of telescopes may be generally synonymous with “array” of telescopes. In some embodiments, an array of telescopes may refer to a linear subset of a network of telescopes. The sensors can compose a Highly-mobile Autonomous Rapidly Relocatable Integrated Electro-optical Resources (HARRIER) system. HARRIER track near-geosynchronous orbits (GEO) and other resident space objects (RSOs) using an electro-optical sensor and/or assembly of sensors with utility matching optical sensors from the Space Surveillance Network (SSN). As used herein, RSO may be used somewhat interchangeably with “space object”, although a space object may also include other space objects, such as stars, planets, galaxies, or other space objects that are not in orbit around a planet (e.g., Earth). An RSO generally refers to satellites, particles, or other objects that may be in an orbit around the Earth and/or are at an altitude that may be near such an orbit. The telescopes may be configured to obtain and image space objects using noncoherent light. This ability can provide an advantage over other systems that may rely on coherent light to image space objects.

The sensors and/or sensor networks described herein may be ground-based electro-optic sensors for space situational awareness (SSA) and/or may achieve similar performance to SSN optical sensors. Systems described herein may include an algorithm that can combine images from several sensors (e.g., telescopes) to achieve the same performance of a single sensor with a larger aperture. For example, the photon collecting area of eight 14″ telescopes is equivalent to a single 1 m telescope and may be able to identify a minimum detectable target (MDT) with a visual magnitude (Vmag) of approximately 20-21. Visual magnitude is a measure of source intensity in astronomical images. It can be calculated using a specific optical band-pass filter ahead of or in front of the sensor.

Additionally or alternatively, the system may include a user interface (UI) that can allow a user to easily task and/or receive real-time images and detection data (e.g., Right Ascension (RA), Declination (Dec), Vmag) at a desktop workstation or elsewhere.

State of the art technologies generally achieve sub-optimal search and track performance of RSO using SSN optical assets. For example, reliance on sidereal rate tracking for search mode, inefficient image processing, and/or sub-optimal thresholding for dim object detection can result in poorer performance in certain cases. The systems and methods described herein improve the state of the art. For example, some embodiments can improve GEO search and track using fixed staring mode on small ground-based telescopes for search. Additionally or alternatively, some embodiments leverage highly efficient data processing described herein. As a result, certain systems and methods described herein can achieve state of the art performance or better using 14″ telescopes for one or more of the following measures of performance (MOPs): (1) MDT, (2) metric accuracy, (3) photometric accuracy, (4) number of observations per night, and/or (5) number of tracks per night.

The embodiments described herein may be able to register frames accurately to allow a stack of frames to be collected from different telescopes sufficiently well to increase the Signal-to-Noise Ratio (SNR) of detected objects close to the theoretical maximum, which is given by the formula

$$SNR = {SNR}_{0} \sqrt{{N}_{s} {N}_{f}} \qquad ( 1 )$$

The MDT gained in terms of Vmag is then given by

$$MDT = {MDT}_{0} + 2.5 {log}_{10} \sqrt{{N}_{s} {N}_{f}} \qquad ( 2 )$$

where Ns is the number of telescopes and Nf is the number of frames per telescope so that NₛN_{f} is the total number of frames stacked. For example, an increase of 2 Vmag may be achieved by stacking 60 frames each from two identical telescopes, and an increase of 3 Vmag may be achieved by stacking 352 frames from a single telescope. The systems and methods described herein may be able to achieve an SNR and MDT gain of at least about

$$SNR = 0.82 \cdot {SNR}_{0} \sqrt{{N}_{s} {N}_{f}} \qquad ( 3 )$$

$$and$$

$$MDT = {MDT}_{0} - 0.1 + 2.5 {log}_{10} \sqrt{{N}_{s} {N}_{f}} \qquad ( 4 )$$

The systems described herein may be able to achieve astrometric accuracy of less than 0.25 arcseconds and a MDT of at least 18 panchromatic Vmag.

The system may reduce raw images from a camera, remove a sky background, estimate noise levels, and/or calculate boresight and orientation of the image. Additionally or alternatively, the system may estimate RA, Dec, and/or Vmag of one or more objects present in the image, and/or report one or more of these (e.g., to the user). The system may translate tasking based on these calculations into command messages for telescopes and/or cameras.

The system may collect a statistically significant number of photons compared to what is needed to overcome background noise. This is a measure of SNR. To increase the photon count, it can be helpful to use larger apertures. Additionally or alternatively, the system may use stacked focal planes. For example, if the only noise source is shot noise due to the background, and the pixel's Instantaneous Field of View (IFOV) and Point Spread Functions (PSF) are comparable, then a scaling of the SNR may be proportional to the scope(s) effective aperture area times the square-root to the integration time. In this case, stacking focal planes can be equivalent to larger apertures scopes. In some bases, larger apertures attain a diffraction-limited PSF and thus have a smaller blur. Additionally or alternatively, there may be additional noise sources such as thermal noise and readout noise which can cause frame stacking to be less effective. However, when done properly, stacking frames can be used to increase SNR.

Frame stacking from a single sensor may be used to increase the SNR of a single image by summing frames at the pixel level. This may involve removing any star streaks. However, stacking frames can result in a reduction in the collections operation tempo by a factor of N, where N is the number of frames summed and VN is the SNR increase under optimal conditions.

The system may include two or more co-located sensors that can each collect 60 or more frames while staring at the same section of the sky. In some embodiments, the sensors may be considered “co-located” if the sensors are close enough to one another to achieve a particular minimum pixel size given a particular desired field of view. The combined frames (e.g., 120 frames, 180 frames, etc.) can be stacked. A portion of the frames may constitute a subset of the telescopic imagery. Multiple subsets of the telescopic imagery can be obtained where only one or more subsets are used to stack or summate the image data. A subset can include a portion or a complete amount of something. This can result in an SNR improvement of about 8.98, or 0.82√NₛN_{f} where Ns is the number of the scopes and Nf is 60 frames. Using a single sensor, this SNR increase would have required stacking at least 8.982 (or 81) frames and thus requiring a longer dwell time.

The data set used for image analysis can include 71 images in a plurality of sequential series of images of one RSO and surrounding stars. All images to be stacked may be binned in a matrix (e.g., 2x2, 3x3, etc.) for presenting a composite image.

The magnitude and intensity levels of stars may be identified as well. The magnitude of the RSO can be estimated based at least in part on the magnitude of stars or other space objects. Tracking stars may also be helpful in tracking atmospheric conditions because the images of stars may brighten and dim with changing conditions. The stars may serve as orientation or calibration points. The stars may be ultimately subtracted from the images to provide enhanced SNR.

Each pixel in an image file of the system memory can include an intensity parameter. The value of intensity of a given pixel can be a number between, for example, 0 and 65535. This may be stored in the image file as an integer or a real number. The intensity is related to the number of photons striking the pixel's active region during the time that the shutter is open, the quantum efficiency of electron production, and/or noise from various sources.

In some embodiments, a user can select imaging criteria to generate enhanced telescopic imagery. Imaging criteria may include a selection of a signal sensitivity, which may be a target signal sensitivity. The signal sensitivity can refer to a level of signal, relative to a random background noise of the imagery. The signal sensitivity can include a signal to noise ratio (SNR). A selected SNR can correspond to a minimum SNR, which may determine which images are acceptable and which are not. For example, images having an SNR above the minimum SNR may be retained and/or used for summating, as described herein. Additionally or alternatively, the minimum SNR can indicate which images are to be modified as described herein.

The imaging criteria may include a number of spectral bands. Spectral bands can refer to one or more ranges of electromagnetic (EM) waves. The spectral bands may be selected within an optical spectral range. The optical spectral range can refer to a range of EM waves that exhibit optical properties, such as interference, diffraction, and/or polarization. Generally optical waves include infrared light, visible light, and ultraviolet light. The optical spectral range can include wavelengths from between about 2 mm and about 200 nm. A user may select a number of spectral bands within the optical spectral range above some minimum number of spectral bands. The minimum number of spectral bands may be selected by the user. The minimum number of spectral bands may be 1, 2, or more.

A spectral range can be associated with the spectral bands. The spectral range may be a broad, continuous range of EM waves that encompasses all of the spectral bands. For example, a spectral range may include the visible light range, the infrared light range (or a portion thereof, such as the near-infrared light range), and/or the ultraviolet light range.

A user may select a location (e.g., geographic location) of the plurality of co-located telescopes. For example, a user may select a state, a city, a city region, a coordinate location (e.g., a nearest coordinate location), a latitude-longitude range, and/or some other selection of a location. Additionally or alternatively, the user may select an identifier of one or more networks (e.g., arrays) of co-located telescopes. The identifier may include a network name, an owner name, and/or some other identifier. The co-located telescopes can generate an improved “effective aperture size” compared to any of the individual constituent telescopes. An effective aperture size can refer to a size of a mathematically equivalent aperture of a single sensor.

In some embodiments, a user may select a data cadence to be a target data cadence. A data cadence may refer to a number of frames per minute, such as a target number of frames per minute or a minimum number of frames per minute. The minimum number of frames per minute may represent a threshold such that a telescope or network of telescopes that do not capture frames at or above the minimum number of frames per minute are not selected. Additionally or alternatively, imagery that is not captured at or above the minimum number of frames per minute may be discarded or otherwise not used in generating enhanced telescopic imagery. For example, a user may choose a target data cadence, which may limit which telescopes and/or telescope networks may be used.

A user may select an image data integration time as a target image data integration time, such as a minimum data integration time. The image data integration time may refer to a time the sensor (e.g., telescope) takes to capture the image. The image data integration time may be about 10 ms, about 50 ms, about 50 ms, about 100 ms, about 500 ms, about 1 s, about 2 s, about 5 s, about 10 s, any value therein, or fall within a range having endpoints as any value therein. The selected or target image data integration time may specify which telescopes and/or telescope networks may be used, corresponding for example to only those telescopes and/or telescope networks that integrate the imagery. The selected image data integration time may be a minimum image data integration time or a maximum image data integration time. In some embodiments, the selected image data integration time may be a range of acceptable image data integration times. A selected minimum image data integration time may cause a telescope network (e.g., a selected telescope network) to spend at least the selected integration time to integrate the image data. A selected maximum image data integration time may cause a telescope network to spend no more than the selected integration time in integrating the image data. Additionally or alternatively the selected minimum or maximum image integration time may restrict which telescopes and/or telescopes may be used in capturing and/or generating image data.

In some embodiments, a user may select an image data download time. The image data download time may correspond to how rapidly the image data can be transmitted to a remote computing device. A remote computing device can be a computing device that is not connected to an internal intranet network. Additionally or alternatively, a remote computing device can be a computing device that is beyond a threshold distance (e.g., about 100 m, about 500 m, etc.) from the telescopes or telescope network. In some embodiments, the image data download time may correspond to how rapidly the image data can be transmitted from an image sensor (e.g., a camera) to a hard drive associated with the image sensor. A user may select a minimum and/or maximum image data download time. A selected minimum image data download time may cause a telescope network (e.g., a selected telescope network) to spend at least the selected download time in downloading the image data. A selected maximum image data download time may cause a telescope network to spend no more than the selected download time in downloading the image data. Additionally or alternatively the selected minimum or maximum image download time may restrict which telescopes and/or telescopes may be used in capturing and/or generating image data.

In some embodiments, a user can select a number of space objects to be tracked as a target number of space objects. Additionally or alternatively a user may select how many telescopes of a telescope network are to be dedicated to tracking each of one or more space objects.

In some embodiments, a user can select a spatial resolution as a target spatial resolution. Spatial resolution can refer to an ability of the sensor (e.g., telescope) to distinguish between two measurements, such as two nearby space objects. Spatial resolution may be selected in terms of pixels, pixel density, distance, or some other unit value. A user may select a minimum spatial resolution as a target minimum spatial resolution. The minimum spatial resolution may refer to minimum value for acceptable imagery. A user may select a minimum and/or maximum spatial resolution. A selected minimum spatial resolution may cause a telescope network (e.g., a selected telescope network) to use only telescopes or a subset of telescopes within a plurality of co-located telescopes in generating the image data. A selected maximum spatial resolution may cause a telescope network to use only telescopes that generate imagery having a spatial resolution no more than the maximum spatial resolution. Additionally or alternatively the selected minimum or maximum image spatial resolution may restrict which imagery may be used in generating enhanced imagery data. In some embodiments, a user may be able to select a magnification level of the telescopes. The magnification level may refer to a field of view of the telescope or telescopes relative to a possible field of view.

The detection of RSOs may include a threshold confidence level relating to a low False Alarm (FA) rate. A reasonable and consistent FA rate can be defined and kept constant when comparing analysis to avoid incorrect conclusions. Additionally or alternatively, an SNR threshold can be set based upon a desired statistical FA rate. Assuming a detection algorithm's SNR output over all pixels processed contains only noise and has a SNR distribution that is a Gaussian of one sigma with zero mean, then the “ideal” relationship between the algorithm's SNR and FA rate can be defined as

$$FA rate = \frac{1}{2} ( 1 - erf ( \frac{SNR}{\sqrt{2}} ) ) \qquad ( 6 )$$

For example, for an SNR of 5 and 6, the FA rate results are roughly {3 E−7, 1 E−9} or {1 in 3.5 million, 1 in 1000 million}. If the FA rates using a given threshold do not work out to the desired FA rate, then the SNR can be scaled so that the FA rate works according to the formula. In some embodiments, the SNR threshold may be 5 or 6 because there are many pixels. A 1000×1000 focal plane has 1 million pixels. With an SNR threshold of 6, this corresponds to 1 false alarm every 1000 focal planes. Similarly, an SNR threshold of 5 has a FA rate every 3.5 focal planes. Other SNR thresholds can be set. A user may set the SNR threshold, such as via an interactive graphical user interface.

A signal can be obtained from noise using a matched filter centered on the brightest point in the vicinity of where the target was supposed to be located. The matched filter can be created using a Gaussian blur of a set number of pixels and/or portion of pixels (e.g., 1.2 pixels). This threshold may be set for each sensor.

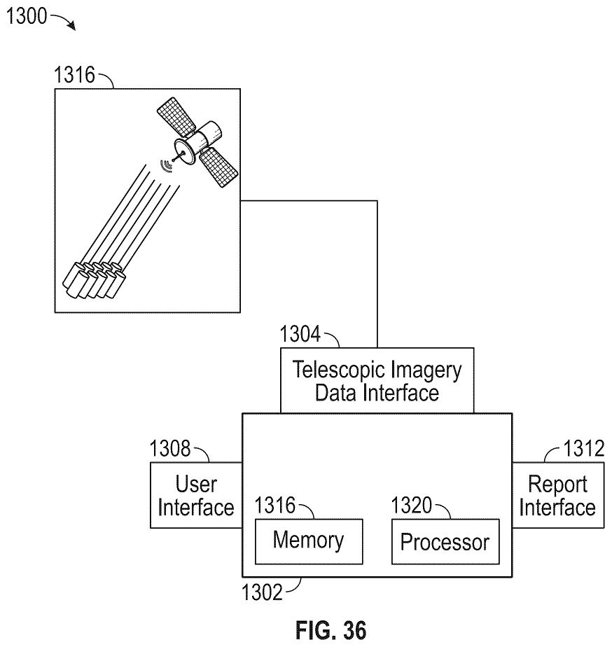

Turning now to the figures, FIG. 36 shows an example telescopic imagery system 1300. The telescopic imagery system 1300 may include one or more features and/or perform one or more of the functions described herein. The telescopic imagery system 1300 can include an image enhancement system 1302, a telescopic imagery data interface 1304, a user interface 1308, a report interface 1312, and/or a co-located telescope network 1316. In some embodiments, the co-located telescope network 1316 is connected to, but not included in, the telescopic imagery system 1300. The image enhancement system 1302 can include a memory 1306 and/or a processor 1310. The image enhancement system 1302 can generate enhanced telescopic imagery, which may include increasing the SNR of the imagery, increasing the spatial resolution of the imagery, and/or some other modification to the imagery as described herein.

The user interface 1308 may include one or more features of the visualization display 200 or other interface described herein. The memory 1306 and/or processor 1310 may include features described of a corresponding memory and/or processor above. The memory 1306 can include a trained machine learning model stored thereon. The trained machine learning model may be in operative communication with other elements of the system via one or more data connections. Although the trained machine learning model may be separate (e.g., remote) from the telescopic imagery system 1300, in some embodiments the trained machine learning model is included in the telescopic imagery system 1300 (e.g., as shown in FIG. 36).

Images of the space objects may be captured as described above. After capture, these images may be processed using the trained machine learning model. This process may be done automatically in response to receiving the images received by the telescopic imagery system 1300.

The trained model may receive an input (e.g., image of a space object), pass the input through the trained machine learning model, for example, a convolutional neural network (CNN), and receive an output. The input may include one or more images or other tensor, such as those received from the telescopes. The trained machine learning model receives the input and passes it to one or more model layers. In some examples, the one or more model layers may include hidden layers and a plurality of convolutional layers that “convolve” with a multiplication or other dot product. Additional convolutions may be included, such as pooling layers, fully connected layers, and normalization layers. One or more of these layers may be “hidden” layers because their inputs and outputs are masked by an activation function and a final convolution.

Pooling layers may reduce the dimensions of the data by combining the outputs of neuron clusters at one layer into a single neuron in the next layer. Pooling may be a form of non-linear down sampling. Pooling may compute a max or an average. Thus, pooling may provide a first approximation of a desired feature, such as an alert status or maneuver. For example, max pooling may use the maximum value from each of a cluster of neurons at a prior layer. By contrast, average pooling may use an average value from one or more clusters of neurons at the prior layer. It may be noted that maximum and average pooling are only examples, as other pooling types may be used. In some examples, the pooling layers transmit pooled data to fully connected layers.

Fully connected layers may connect every neuron in one layer to every neuron in another layer. Thus, fully connected layers may operate like a multi-layer perceptron neural network (MLP). A resulting flattened matrix may pass through a fully connected layer to classify the input.

At one or more convolutions, the system may calculate a sliding dot product and/or a cross-correlation. Indices of a matrix at one or more convolutions or model layers may be affected by weights in determining a specific index point. For example, each neuron in a neural network may compute an output value by applying a particular function to the input values coming from the receptive field in the previous layer. A vector of weights and/or a bias may determine a function that is applied to the input values. Thus, as the trained machine learning model proceeds through the model layers, iterative adjustments to these biases and weights results in a defined output, such as a location, orientation, or the like.

The telescopic imagery data interface 1304 can be configured to intake the imagery data (e.g., satellite imagery data, telescope imagery data) obtained from the co-located telescope network 1316. The telescopic imagery data interface 1304 can include an application programming interface (API) that can communicate with one or more computer systems to transmit the obtained imagery data and/or receive the data from the telescopic imagery data interface 1304. The telescopic imagery data interface 1304 can include one or more features of the real-time orbital object data interface 172 or other data connection interface described herein. The telescopic imagery data interface 1304 may include a space object data interface and/or another data interface (e.g., the real-time orbital object data interface 172).

The report interface 1312 may be configured to transmit a report or other data calculated or otherwise obtained by the image enhancement system 1302 to one or more other computing systems, such as a remote computing system. The report interface 1312 may be configured to transmit the data wirelessly or via a wired system.

The user interface 1308 may include an interactive graphical user interface, such as one described herein. For example, user interface 1308 may include one or more features of the visualization display 200, and/or sub-interfaces (e.g., the stitching tool interface 804, the analysis plot interface 808, etc.) within the visualization display 200, described above.

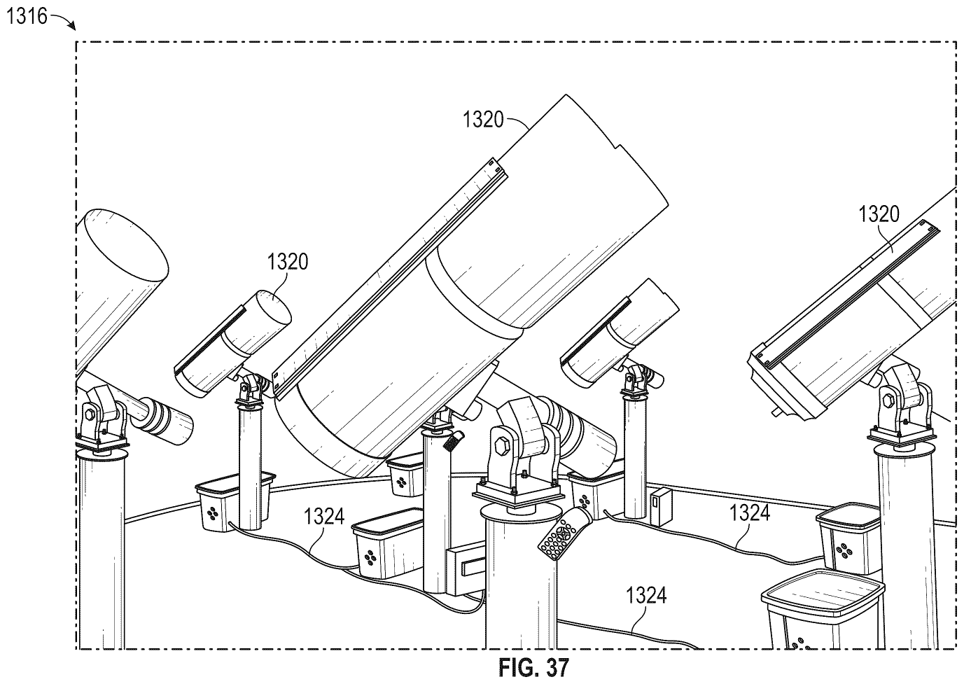

FIG. 37 shows an example co-located telescope network 1316 that includes a plurality of sensors 1320. The sensors 1320 can include telescopes that view visible light. Additionally or alternatively, the sensors 1320 may include infrared sensors, x-ray sensors, ultraviolet sensors, and/or sensors of other signals coming from space. The sensors 1320 may be networked together via one or more communication links 1324. These communication links 1324 may network each of the sensor 1320 to one or more neighboring sensors 1320 and/or to each of the sensors 1320 in the co-located telescope network 1316. The co-located telescope network 1316 may be remote from the image enhancement system 1302. For example, as shown the co-located telescope network 1316 is located in the United States. Other locations are possible. The sensors 1320 may be housed in an enclosed or semi-enclosed housing, such as a housing that includes walls but does not include overhead visual obstructions. This can lead to improved imagery.

Each of the sensors 1320 may be “co-located” (alternatively, “collocated”) with each other. Sensors may be “co-located” if each of the sensors is spaced from each other within a threshold distance from neighboring sensors. Additionally or alternatively, sensors may be co-located if the a center of the apertures of two of the farthest apart sensors is within a threshold distance. The threshold distance may depend on a distance an object is away from the co-located sensors (e.g., an altitude of the object). For example, an angle formed at a target space object by lines connecting the target object space object with the two farthest-apart sensors may be preferably no larger than an angle captured by a single pixel of a stacked image. In some embodiments, the angle captured by a single pixel may be about 0.2 arcseconds. Additionally or alternatively, the threshold distance may be based on a desired or target resolution of the co-located telescope network 1316. The threshold distance may be about 30 cm, about 50 cm, about 100 cm, about 150 cm, about 200 cm, about 300 cm, about 400 cm, about 500 cm, about 1000 cm, about 5000 cm, about 10000 cm, about 250 m, about 400 m, about 500 m, about 600 m, about 750 m, any value falling within those values, or fall within a range having any value therein as endpoints. In some embodiments, the threshold distance is about 400 m.

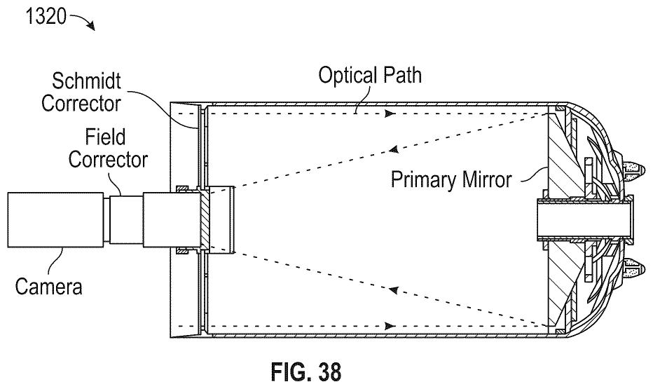

FIG. 38 schematically shows a cross section of an example sensor 1320, such as is shown in FIG. 37. The sensor 1320 can include a camera that receives focused light from a reflective or refractive optical element, such as the primary mirror located at a distal end of the sensor 1320. The optical path of the received light is shown. In some embodiments, the sensor 1320 includes a Schmidt corrector element, such as a Schmidt corrector plate. The Schmidt corrector element can include a lens (e.g., an aspheric lens) or other refractive optical element configured to correct spherical aberration introduced by the primary mirror. Additionally or alternatively, the sensor 1320 can include a field corrector. The field corrector may be configured to improve edge sharpness. For example, the field corrector can include a field flattener lens or other optical element configured to counteract field curvature. The field corrector can help reduce a field-angle dependence of sensor 1320.

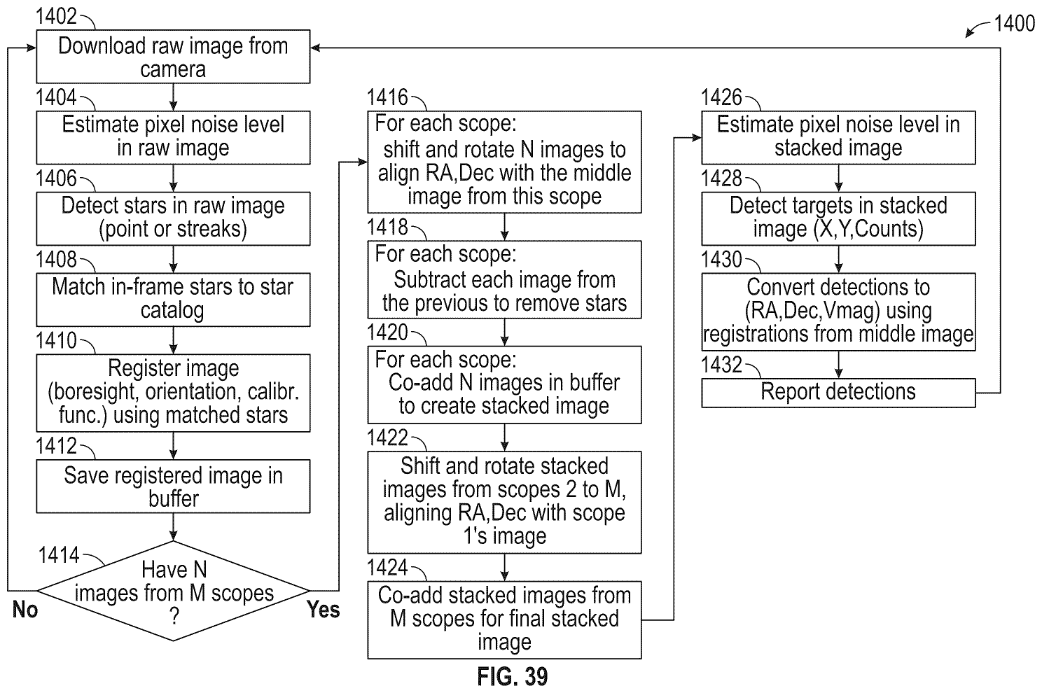

FIG. 39 shows an example method 1400 performed by one or more of the systems described herein. The system may include the visualization system 190, the telescopic imagery system 1300, or another system described herein. At block 1402, the system can download raw images, such as image data, from a camera, such as the camera of the sensor 1320. At block 1404, the system may estimate a pixel noise level in the raw images. At block 1406, the system may detect stars in the raw image. The stars may appear as points or streaks. At historical data server 140 the system can match in-frame stars to an exterior or interior catalog of stars. At block 1410, the system may register the images. Registering the images can include determining a boresight, identifying an orientation of the images, converting a sensor reading (e.g., pixel intensity) to an estimated light signal, and/or calibrating those images relative to known objects (e.g., the stars, other space objects). For example, the calibration may rely on the matched stars in some embodiments. In some embodiments, the calibration may refer to a calibration function that generates an object intensity based on a reading from a sensor array (e.g., camera). The calibration function may include an algorithmic function to convert received data into a measured intensity. In some embodiments, the telescope network may register the images before sending them to the system (e.g., the image enhancement system 1302).

At block 1412, the system may save the registered images in a temporary storage, such as a data buffer. The system may evaluate at decision block 1414 whether the system has obtained a sufficient number of images relative to a number of scopes. The number of images may depend on a selected target intensity, target resolution, target SNR, and/or based on another variable described herein. For example, in a perfect environment with perfect instruments, the intensity produced by stacking N images should exactly equal the average RSO intensity multiplied by N. The number N of images can be 2 images, 3 images, 4 images, 5 images, 10 images, 15 images, 20 images, 30 images, 50 images, 75 images, 100 images, any number of images therein, or fall within a range of images having any endpoints therein. The number of sensors (e.g., telescopes) may be 2, 3, 5, 7, 8, 10, 15, 20, 30, 50, 80, 100, any number of images therein, or fall within a range of images having any endpoints therein. If the evaluation is No, then the process can return to the block 1402. If the evaluation is a Yes, then the system at block 1416 can, for each sensor, shift a number of the images to align the right ascension (RA) and/or declination (Dec) with a middle image of the sensor. The middle image could be a middle image taken in time and/or taken from a middle (e.g., non-terminal) telescope.

At block 1418, the system can, for each sensor, subtract each image from a previous image to remove other objects (e.g., stars). Removal of, for example, stars, can remove corrupting objects, which may make the target objects more clearly visible and/or easier to automatically identify. In some embodiments, the system may correct bad or unreliable images. For example, the system may be able to identify a significant discrepancy in an image compared to other images and remove a portion of the image or the image completely based on the discrepancy. A discrepancy can include a “hot” pixel, cloud cover, airplane or other undesired object, weather pattern influencing an image, and/or any other unique aspect of an image that may make the image unhelpful or even corruptive for a stacked image. Such images can be discarded and/or significantly reduced in their effect in the stacked image (e.g., reduced weighted impact on the stack).

At block 1420, the system can, for each scope, add N images in the short-term memory (e.g., data buffer) to create a stacked image. Image stacking is also described above with reference to FIGS. 13-14. At block 1422, the system may shift and/or rotate the stacked images from other sensors. The shifting may involve aligning the RA and/or the Dec with the image from the instant sensor. Additionally or alternatively, the system can scale the images so that the images can properly be stacked. At block 1424 the system can add (e.g., co-add) stacked images from one or more of the other sensors to create a final stacked image. In some embodiments the system can allow a user to select which sensor(s) (e.g., by a sensor identifier) to use when stacking the images.

Rotation of images can cause discrepancy in pixels due a re-grid of the rotated image from a first sensor to match a second sensor. During re-gridding, a single pixel may overlap with up to six pixels in the re-gridded frame. For example, 4 or more pixels can contribute to a new pixel on the re-grid. In this case, the resulting noise on the pixel can be attenuated because it's adding fractions of pixel noise. In some embodiments, the system may allow a user to select how the re-gridded pixels should be counted, how their signal and/or noise should be calculated, etc.

The re-grid method may apply a uniform pixel intensity over the pixel area and sum up the counts falling onto the new grid area. As noted above, it is possible to have up to 6 different pixels contributing to a new pixel for certain phases and rotations. For no rotation and only phase differences, then there would be only be at most 4 pixels contributing.

At block 1426 the system can estimate a pixel noise level in the stacked image. Estimating pixel noise level can include determining a threshold SNR, such as a target SNR. Within the stacked image, the system can detect one or more targets at block 1428. The system may identify (e.g., detect) a total number of targets and/or a position (e.g., x-y coordinate) within the stacked image. In some embodiments, the user interface can allow a user to select (e.g., by clicking) a target object around which to stack a plurality of images.

In some embodiments, the stacking may be automatically reframed around a target object based on a determined orbit. For example, the system may be able to automatically update a frame of subsequent images based on an amount of expected movement of the target object based on a calculated orbit of the target image. Thus, if the time discrepancy of the subsequent images is known, as well as an orientation of the images (e.g., known from the location of the satellites), then the system may be able to extrapolate an expected location of the target object within the subsequent images. These subsequent images may be based on a positions of the target object that are in the future and/or in the past.

In some embodiments the system can stack the images using a target object as a reference point for the stacking. This may be advantageous, for example, when summating images (e.g., image data) taken at different times for a moving object. As the object moves, the center or frame of a subsequent image may be slightly moved. This can remove or reduce blurring of the image in response to the stacking. Additionally or alternatively, it may result in a higher SNR and/or resolution of the object in response to the stacking. This type of moving-object stacking can be possible due to the removal of other objects (e.g., stars, planets) from the frames before stacking.

At block 1430, the system can convert the image details from the detections to data (e.g., RA, Dec, VMag, etc.) based on a scaling of a reference image. The reference image may be the middle image described above. In some embodiments, the reference image can be a different image and/or a stack of images. For example, in some embodiments the reference image can include an image with the highest resolution. The detected objects and/or their respective details may be reported to one or more electronic systems (e.g., via the report interface 1312).

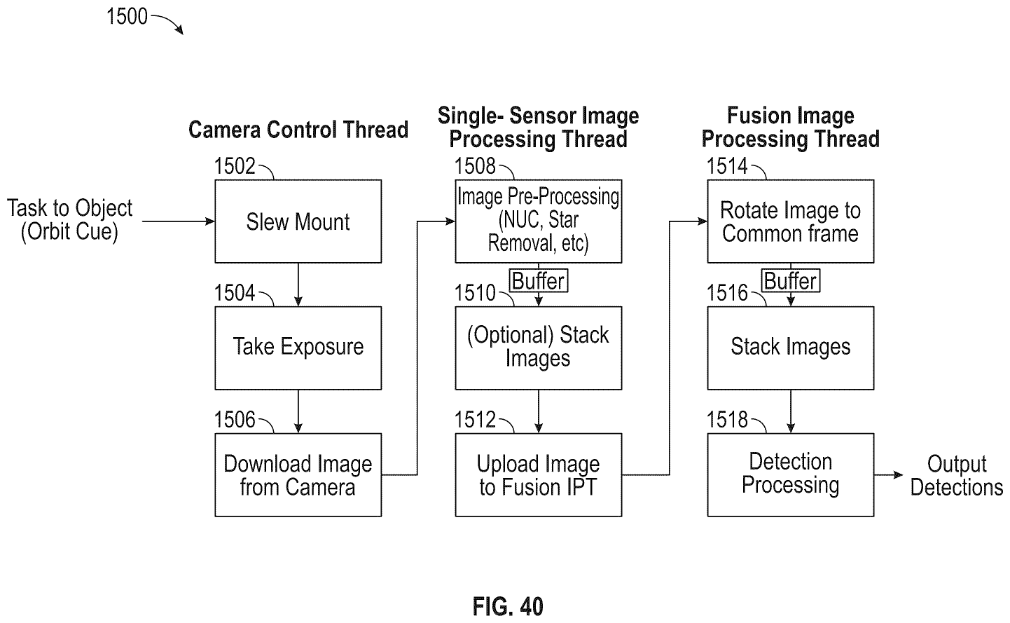

FIG. 40 shows an example method 1500 that may be performed by one or more of the systems described herein, according to some embodiments. The method 1500 may broadly include controlling the sensors, processing images from individual sensors, and/or fusing images from each sensor together. At block 1502, the system may orient (e.g., slew) a sensor toward a target imaging area. The target imaging area may include (or be expected to include) one or more target RSOs. The determination of the location of the target imaging area may be based on known initial conditions (e.g., x-y coordinate(s), corresponding times, velocity(ies), acceleration(s), etc.). Additionally or alternatively, the location of the target imaging area may be based on a calculated local or global trajectory (e.g., orbit) of the space object(s). Based on calculations of an expected later (e.g., future) location of a space object, the system may calculate a determined updated position and/or an updated velocity of the space object. Based on the updated position and/or velocity information, the system may be able to predict where the space object is expected to be at some later or earlier time. Such later or earlier times may be referred to as “expected locations”. The expected locations may be extrapolated by using a known position and a calculated trajectory of the space object. The calculated trajectory may be a calculated or determined orbit, as described above with regard to orbit determination. For example, a user may select an orbit determination selector. In response to the selection of the orbit determination selector, the system may calculate an orbit associated with the one or more space objects. If trajectories of each of a plurality of objects is calculated, then each space object may have respective expected locations. Counts detected in the block 1428 may be converted to a Vmag in the block 1430. Additionally or alternatively, the x-y coordinates can be converted to right ascension and/or declination.

At block 1504 the system can take the exposure of the RSO(s). At block 1504 the system can download the image(s) from the camera (e.g., the camera of the sensor 1320). Once the image(s) have been downloaded, the system at block 1508 can pre-process the image(s), such as by removing stars and/or unifying and/or calibrating the image(s). additionally or alternatively, the system may implement non-uniformity corrections (NUCs). Non-uniformity correction can include adjusting for minor detector drift that occurs as the scene and environment change. For example, the camera's own heat, the shape of the camera lens, and/or other optical non-uniformities may interfere with the readings from the sensor(s). NUC can include adjusting gain and offset for each pixel, producing a higher quality, more accurate image. NUC can include flat field correction (FFC) or even spherical field correction (to better approximate parabolic optical elements). NUC may occur using software algorithms and/or using optical corrective elements.

At block 1520 the system may stack a plurality of images together. At block 1512, the system can upload and/or transmit the stacked image (and/or the underlying images) to computing system (e.g., Fusion IPT) configured to perform the fusing (e.g., stacking) of all of the images.

At block 1514 the system can begin the fusion processing of the stacked images. The system can rotate each image to a common frame of reference. The frame of reference may be based on a location of other objects (e.g., stars), based on an orientation of a calculated trajectory (e.g., orbit) of the RSO(s), and/or some other metric. The system at block 1516 can stack the images. Stacking the images may include summating values of the images at corresponding points (e.g., pixels, regions). Image stacking is described in additional detail above with regard to FIGS. 15-16. The system at block 1518 may run algorithms to determine any space objects that may be in the resulting stacked image. The determination may be based on, for example, a threshold difference in value (e.g., intensity, color, etc.) between one pixel and a neighboring pixel and/or between a pixel and a nearby (but not neighboring) pixel. The detected space objects and/or corresponding location information may be saved and/or transmitted to another computing system.

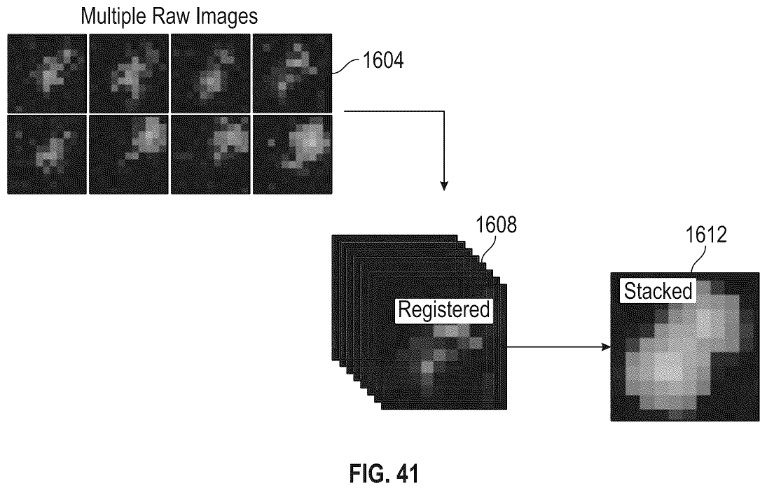

FIG. 41 shows an example of converting raw images into a stacked image. The raw images 1604 can be obtained by one or more sensors (e.g., the sensors 1320), such as telescopes. The raw images 1604 may come from a single telescope oriented at the same RSO over multiple frames. Additionally or alternatively, the raw images 1604 may include images of the same RSO(s) from a plurality of co-located sensors.

The registered images 1608 may correspond to the registered images 1608 after processing on each of the raw images 1604. For example, the registered images 1608 may be considered “registered” after one or more steps of processing on each individual raw image has been undertaken. The steps of processing are discussed herein and may include, for example, orienting the images (e.g., panning, rotating), centering the images, resizing the images (e.g., zoom in, zoom out), subtracting misleading or irrelevant data (e.g., stars, moon, other space objects), color modification, and/or other modifications to the images. In some embodiments the system can remove false positives, such as “hot” pixels. For example, the translation and/or rotation processes may shift the hot pixel location in the completed stack. Prior to all other image processing steps, hot pixels may be removed from each image by replacing the intensity value with a value obtained by calculating the mean background noise.

It may be helpful to reduce noise in a quick and efficient manner. In some embodiments, the system can encode image data in a compact way, known as run length encoding. For example, the system may establish a noise threshold. Pixels with values lower than the threshold may be categorized as noise. The threshold value can be calculated by analysis of a region of appropriate size. A mean value can be calculated, which may be used as a representative of the whole image. Localized pixel-based mean and/or standard deviation values for each spot and streak can be calculated. For example, the threshold may be about 3 standard deviations above the mean. The criterion for designating a region as data may be three (or more) consecutive pixels above background.

The run length encoding can compress pixels based on whether they are above or below the threshold. Consider three rows of 10 pixels as black (below threshold, denoted “B”) or white (above threshold, “W”):
BBBBWBBBBB
BBBWWWBBBB
BBBBWBBBBB
The system may compress these rows as:
B4W1B5
B3W3B4
B4W1B5

Using this to calculate centroids involves sweeping the image row by row and populating a cluster table, where each entry consists of a new “cluster” defined when a value is above the threshold (W). After the clusters are defined, the locations and size of clusters within the table can be compared, to define adjacent clusters (e.g., defined like above when two clusters are on adjacent rows, and the W counts bring them to within the same column range). Using this process, pixel intensities less than the threshold may be categorized as noise and ignored. This can make the process more efficient and/or accurate. Other filters, such as low-pass filters, may be applied to the data. The low-pass filters may be software-based (e.g., matrix) filters.

The registered images 1608 may be stacked to form the composite image 1612. The stacking may include summating intensity or other data from the registered images 1608. Additionally or alternatively, the composite image 1612 may include emphasizing distinctions between a foreground (e.g., the RSO) and a background. This may include increasing an intensity of identified object pixels without modifying the background pixels. Alternatively, the intensities could be modified for each of the pixels based on an intensity of the pixels. For example, the modification could include a linear or geometric increase of each pixel based on a stacked pixel intensity.

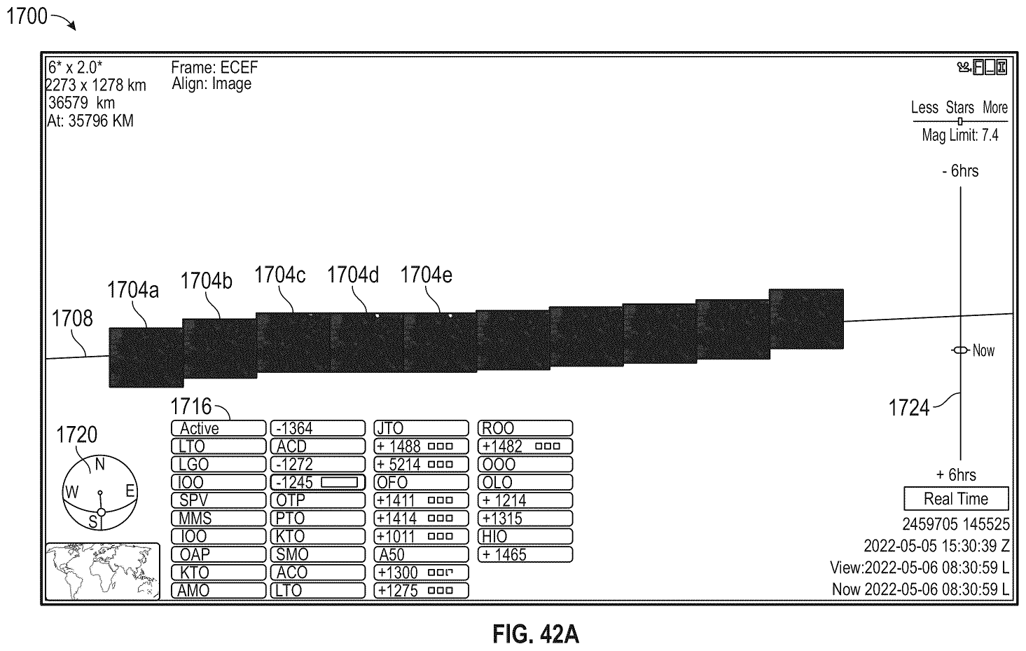

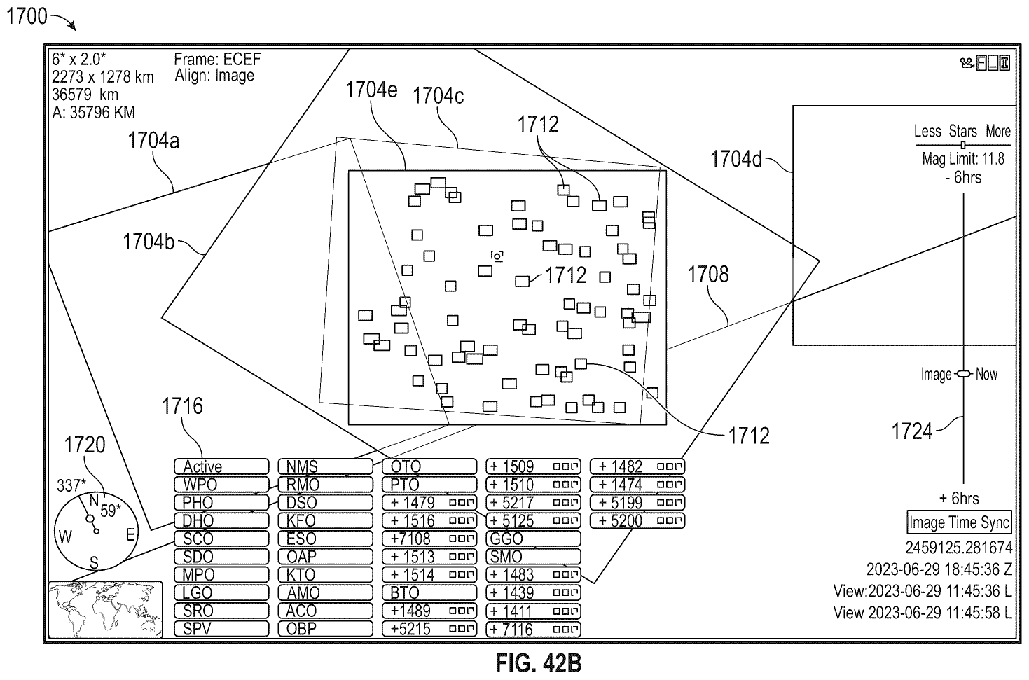

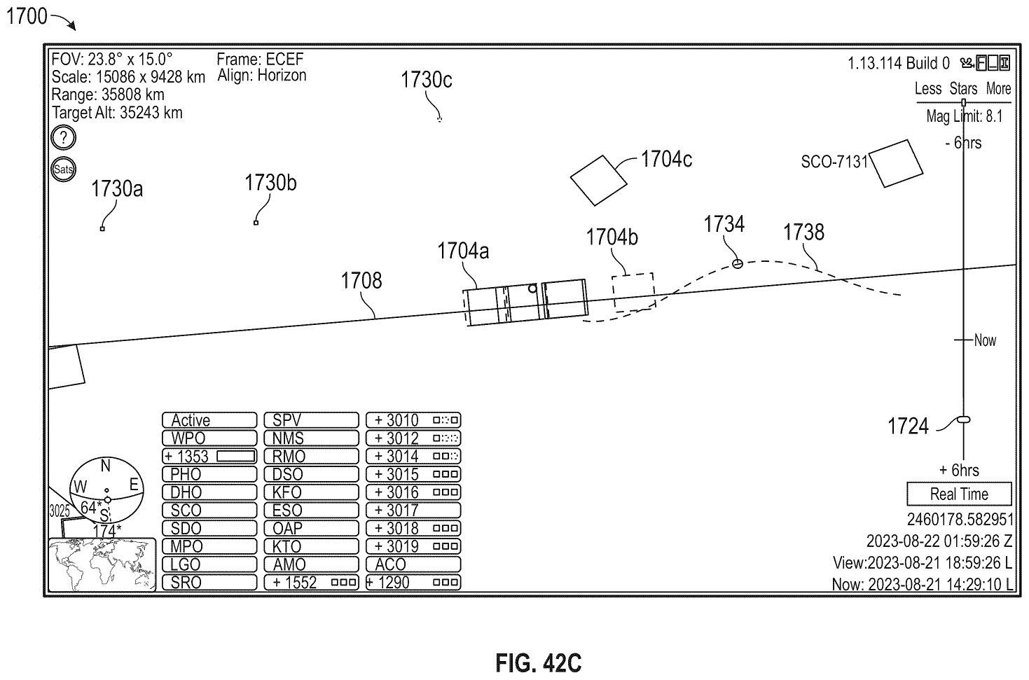

FIGS. 42A-42C show aspects of an example graphical user interface 1700. The graphical user interface 1700 could be the same as and/or include one or more features of the visualization display 100 or visualization display 200 described herein. FIG. 42A shows a plurality of images 1704a-e of one or more RSOs along an orbit of a region of space, as indicated by an orbit indicator 1708. The images 1704a-e may show one or more of the same RSOs along the orbit. The orbit may be calculated as described above. For example, the orbit may be based on a selection of time points in combination with an indication of a space object. Additionally or alternatively, the orbit may be calculated based on known initial conditions. The initial conditions can include a combination of a position in space at a known time and a velocity vector. The velocity vector can include a direction, and the velocity may indicate an initial speed of the space object.

Initial conditions, expected locations, calculated velocities, time data, and/or calculated positions may be referred to as “orbital data.” Time data may refer to times corresponding to when an object was in particular positions. Thus a space object may be in multiple positions at various respective times. The times can be referred to as time data, and respective times can be referred to as respective time data. Once such orbital data is calculated, the determined orbital data can be used to track a space object and/or track imagery of the space object. The tracking of imagery along an orbit may be referred to as a “GEO fence”. FIG. 42A shows an example system operating a GEO fence to provide persistent tracking and discovery (e.g., 18.5 VMag) for a 10-degree portion of the GEO belt.

The graphical user interface 1700 can allow a user to select one or more imaging criteria. The imaging criteria can be used to modify the imagery obtained from the telescopic imagery. The imaging criteria may be able to leverage the plurality of the sensors (e.g., the co-located telescope network 1316) to enhance the imagery in a way that will allow the RSOs to be identified, for relevant details to be sensed, and/or other benefits.

In some embodiments, certain imaging criteria may be in part dependent on other imaging criteria. For example, a user may select a first and a second imaging criteria (e.g., of three imaging criteria). Once the first and second imaging criteria are selected, a third imaging criteria may automatically be selected. For example, a minimum signal to noise ratio (SNR), a target data cadence, and a minimum spatial resolution may all be interdependent such that selection of any two of the three will automatically result in the third. These dependencies may be based on the array specifications associated with an array of co-located telescopes. The array of co-located telescopes may itself be a selectable imaging criteria (e.g., a fourth imaging criteria) that is further interdependent with the other three criteria. The system may be able to determine, based on the array specifications, the remaining imaging criteria of the three (or more) imaging criteria generate an indication of the remaining imaging criteria of the three imaging criteria. For example, the system may automatically select the remaining imaging criteria. The remaining imaging criteria may be a single criteria or may be a plurality of them. In some embodiments, the system may identify what a minimum or maximum value for each of the three imaging criteria may be, based on the array specifications. The array specifications can include one or more of a largest distance between any two of the array of co-located telescopes, an available set of spectral ranges, a number of available pixels associated with a single telescope of the array of co-located telescopes, a total number of available pixels associated with the array of co-located telescopes, an effective aperture size of the array of co-located telescopes, and/or an aperture size of the single telescope of the array of co-located telescopes.

The imaging criteria can be selected by a user. In some embodiments, the imaging criteria can be received from a remote computing device. In some embodiments, the imaging criteria are determined by a machine model described herein. The imaging criteria may be determined based on a goal of the enhancement. Additionally or alternatively, the imaging criteria may be based on what the images show. For example, if the background and foreground are not easily distinguishable, the imaging criteria selected may be a target signal to noise ratio (SNR) (e.g., an improved SNR). The target SNR may include a minimum SNR. The plurality of sensors may be uniquely able to provide the improved SNR. In some embodiments, the system may transmit the imaging criteria to the co-located sensor network to update the images that are obtained. For example, the sensors may increase an exposure time for an image based on an increased SNR. Additionally or alternatively, the system may simply select images from the network of sensors that have a sensitivity having at least the target SNR.

Other imaging criteria can be selected for image enhancement. Such imaging criteria can include a target number of spectral bands comprising a minimum number of spectral bands, one or more spectral ranges associated with one or more of the spectral bands, a location of the plurality of co-located telescopes, a target data cadence comprising a minimum number of frames per minute, a target number of space objects to be tracked, or a target minimum spatial resolution. Other imaging criteria are possible, such as those described herein.

In some embodiments, different of the sensors are configured to image the RSOs using different wavelengths. Thus, a user may be able to select the spectral bands, a number of spectral bands, a priority of the spectral bands (e.g., when stacking image data), and/or other criteria. Priority of the spectral bands can include a percentage of influence that spectral band has when stacking the images. It may be advantageous to use a selected spectral band to image and/or identify one or more stars or other space objects that emit/reflect light in that spectral band. The selected spectral band may correspond to a spectral band in which the sensor is most or highly sensitive.

The location of the co-located sensors may be selected in some embodiments. The system may be in communication with a plurality of co-located sensor networks in some embodiments. Each network may have corresponding attributes that may be desirable in some circumstances over others. The system may allow a user to select a subset of the networks in communication with the system.

The system may allow a user to select a target data cadence. The data cadence can include a number of frames per minute or other metric for how often the sensor network and/or individual sensors of the sensor network capture the sensing information. For example, the data cadence may correspond to a time needed to integrate and/or a time need to download the image data. The integration and/or download time of the data cadence may be about 0.1 s, about 0.5 s, about 1 s, about 2 s, about 3 s, about 4 s, about 5 s, about 6 s, about 7 s, about 8 s, about 10 s, about 15 s, about 20 s, about 30 s, about 45 s, about 60 s, about 80 s, about 90 s, about 100 s, about 105 s, about 120 s, be any value therebetween, or fall within a range of values having endpoints therein. The frames/minute of the data cadence may be about 0.1 frames/min, about 0.5 frames/min, about 1 frame/min, about 2 frames/min, about 5 frames/min, about 8 frames/min, about 10 frames/min, about 12 frames/min, about 15 frames/min, about 20 frames/min, about 25 frames/min, about 30 frames/min, about 40 frames/min, about 45 frames/min, about 60 frames/min, about 80 frames/min, about 90 frames/min, any value therein, or fall within any range having endpoints therein.

The system may allow a user to specify a number of space objects to be tracked. One of the many advantages of certain embodiments described herein is that a user can track a plurality of objects using the network of co-located telescopes simultaneously. For example, a user may select which telescope and/or a number of telescopes that are to track a first space object and/or how many and/or which will track a second space object. This process may be used for as many objects as there are available sensors. The number of sensors trained on each object may be different depending on the needs of each sensing job.

The system may allow a user to specify a target or minimum spatial resolution. For example, a user may specify a minimum distance (e.g., pixel distance) between two nearby objects. Additionally or alternatively, the spatial resolution may correspond to a level of detail in the resulting images. The spatial resolution may impact a number of and/or a greatest separation between telescopes from which imaging data can be taken in order to satisfy the target spatial resolution. For example, the minimum spatial resolution can determine a largest separation parameter corresponding to a subset of the plurality of co-located telescopes having no distance between any two of the subset of the co-located telescopes greater than the largest separation parameter. The largest separation parameter may equal the largest distance between any two telescopes of the co-located telescopes. A separation parameter may include a maximum distance between any two telescopes, a maximum distance between the centers of apertures of any two telescopes, a maximum angular separation between any two telescopes, etc.

One or more of the other imaging criteria may influence the other imaging criteria. For example, modified images may correspond to a lower SNR as a result of a selected lowered minimum spatial resolution. Additionally or alternatively, the target minimum spatial resolution may impact (e.g., reduce) the data cadence, such as the frequency of the image generation. Image generation may refer to the sensing of the signals by the image sensor, the integration of said sensing, the storing of said signals, and/or the generation of imagery for display.

With continued reference to FIG. 42A, the graphical user interface 1700 can include a timing selector 1724 that allows a user to select a delay from when the images were received. The network of sensors may be able to capture images of objects continuously. Accordingly, a selected time frame may be helpful in analyzing target images, orbit determination, etc. in some embodiments, the timing selector 1724 can allow a user to select a future time and allow the system to display a predicted location and/or image of the space objects. The predicted location may include an error level associated with the prediction. The error level may be based on how far into the future the prediction is made, an error level associated with the space object. In some embodiments, the error level is received by the system from another computing system and/or from a user.

The graphical user interface 1700 can additionally or alternatively include an orientation indicator 1720 that allows a user to quickly and easily identify an orientation of the displayed region of space relative to the Earth. The orientation indicator 1720 may include an indication of the location of the network of co-located sensors (e.g., within a map). An “indicator” may include an indication of an object. In some embodiments, the orientation indicator 1720 may allow a user to select a desire one or more networks of co-located sensors. The orientation indicator 1720 can and/or show a field of view (e.g., a zoom level) associated with the graphical user interface 1700. Other image parameters or arrangements are possible. An arrangement can include the orientation and/or the field of view of one or more of the telescopes (e.g., the network of telescopes). The graphical user interface 1700 can include one or more space object indicators 1716. The space object indicators 1716 may correspond to objects already identified within the images 1704a-e. The space object indicators 1716 can be indications within corresponding images 1704a-e in some embodiments. In some embodiments, the space object indicators 1716 may be color coded or otherwise visually identifiable based on a certain characteristic. For example, the space objects may be visually identifiable within the space object indicators 1716 based on an orbital path (e.g., GEO, other orbital path), an object type, an object velocity, an owner or associated entity of the space object, a size, and/or any other distinguishing factor described herein.

In some embodiments, the indicators 1716 may reference available telescope networks. In some embodiments, certain indicators 1716 may include one or more boxes or other indicators that indicate a level of operability and/or reliability of the telescope network. For example, a first box may indicate that the network is online. A second box may indicate that the telescope network is collecting images. A third box may indicate that the telescope network is generating registered and/or stacked images to the system.

FIG. 42B shows another aspect of the graphical user interface 1700 shown in FIG. 42A. As shown, the images 1704a-e can include a plurality of image chips 1712. The image chips 1712 are described above and may include identified space objects therein. The image chips 1712 may be determined based on previously identified space objects and centered around them, as described above (e.g., FIGS. 39-40). The image chips 1712 may be the raw images, registered images, and/or a stack of registered images. Each of the images 1704a-e may be obtained from separate sensors and/or from one or more sensors at different times. The images 1704a-e may each include some of the same space objects as the others and/or unique space objects.

The system may be able to identify one or more (e.g., all) of the image chips 1712 in response to selection of the corresponding image of the images 1704a-e. In some embodiments, the graphical user interface 1700 can allow a user to select one or more of the image chips 1712 and/or the images 1704a-e via selection of a corresponding space object indicator 1716. As shown the images 1704a-e are generally along or near the orbit indicator 1708, but other display orientations are possible.

FIG. 42C shows another aspect of an example graphical user interface 1700, according to certain embodiments. The graphical user interface 1700 can show a plurality of selectable space object indicators 1730a-c. The selectable space object indicators 1730a-c may be inside or outside one or more images 1704a-c. A user may be able to select one or more of the selectable space object indicators 1730a-c. The user may be able to generate and/or display a predicted trajectory (e.g., orbit) of the selected object. For example, as shown, a user has selected a selected space object indicator 1734 and displayed a selected space object trajectory indicator 1738. The user may provide an input to calculate and/or display the selected space object trajectory indicator 1738. The selected space object trajectory indicator 1738 can provide a visual indicator of where an object is expected to be at a future time and/or at a past time. For example, the user may select the timing selector 1724 to see where along the selected space object trajectory indicator 1738 the selected space object indicator 1734 is as the user moves the timing selector 1724. Additionally or alternatively, as the user moves the timing selector 1724 the graphical user interface 1700 update locations of the other selectable space object indicators 1730a-c. A user may instruct the system to generate a stacked image of the selected space object indicator 1734. The stacked imagery may be based on a static frame of reference for each of the images and/or based on a moving frame of reference (e.g., based on the calculated trajectory of the selected space object trajectory indicator 1738).

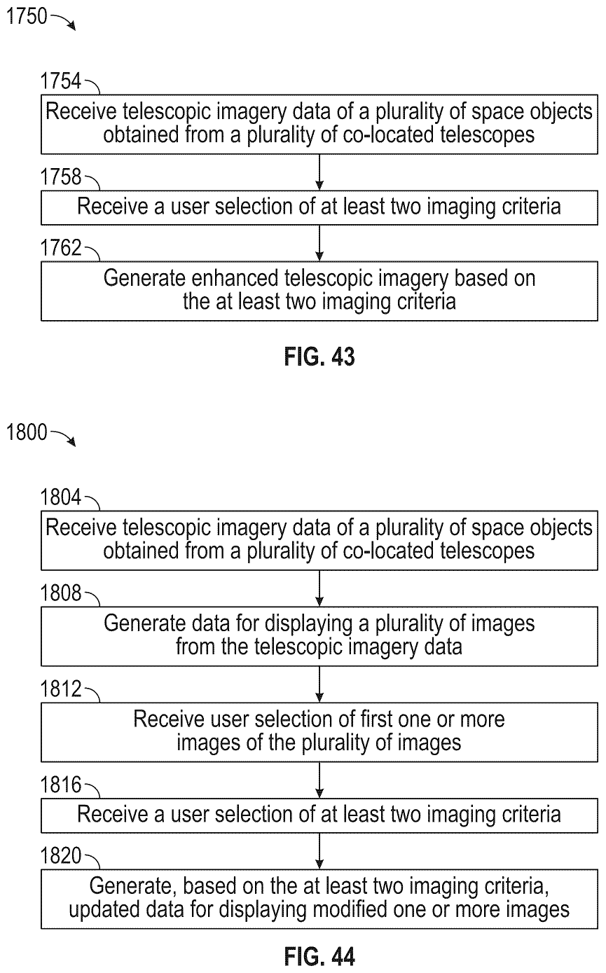

FIGS. 43-51 show various flow charts of additional methods that can be performed by one or more of the systems described herein (e.g., the telescopic imagery system 1300). FIG. 43 shows an example method 1750 performable by a system herein, such as the telescopic imagery system 1300 and/or the visualization system 190. The method 1750 can allow a user or system to determine how the sensors are to generate their data and/or to generate imagery using specific telescopic imagery. At block 1754, the system can receive telescopic imagery data of a plurality of space objects obtained from a plurality of co-located telescopes. The plurality of co-located telescopes may include a network of sensors, such as the co-located telescope network 1316. At block 1758, the system can receive (e.g., a user selection the via the interactive graphical user interface) at least two imaging criteria. The imaging criteria can include any criteria described herein, such as a target signal sensitivity comprising a minimum signal to noise ratio (SNR), a target number of spectral bands (e.g., a minimum number of spectral bands), a spectral range associated with one or more of the spectral bands, a location of the plurality of co-located telescopes, a target data cadence (e.g., a minimum number of frames per minute, a minimum image data integration time, a minimum image data download time, etc.), a target number of space objects to be tracked, a target minimum spatial resolution, and/or another criteria discussed herein. In some embodiments, the system may transmit instructions to the plurality of telescopes based on the selected imaging criteria. The selection of the imaging criteria may update the image data that is captured by the co-located telescopes, such as increasing the SNR of the imagery, deselecting and/or selecting one or more of the telescopes to improve a spatial resolution, spectral range of sensing, determine updated position and/or velocity information associated with at least one space object (e.g., within the received telescopic imagery). Other updates are possible, such as those described herein.

The system may generate enhanced telescopic imagery using telescopic imagery of the plurality of space objects received from the plurality of telescopes. This may include updating already-received imagery data based on the imaging criteria. For example, certain of the imagery data may be modified and/or some imagery data may be omitted to achieve improved imagery data of the space objects.

FIG. 44 shows another example method 1800, according to some embodiments. The method 1800 can allow a user or system to determine how the sensors are to generate their data and/or to generate imagery using specific telescopic imagery. At block 1804, the system can receive telescopic imagery data of a plurality of space objects. At block 1808, the system can generate data for displaying (e.g., via a user interface, such as the visualization display 100, the visualization display 200, the user interface 1308) a plurality of images from the telescopic imagery data. The data may be displayed on the user interface 1308 or some other (e.g., remote) user interface. The system at block 1812 can receive selection (e.g., user selection, selection from the machine learning model) of one or more images of the plurality of images. At block 1816, the system can receive selection of one or more imaging criteria described herein. At block 1816, the system may generate, based on the at least two imaging criteria, the updated data for displaying the modified one or more images. The updated data may include, for example, a stacked image from a plurality of raw and/or registered images.

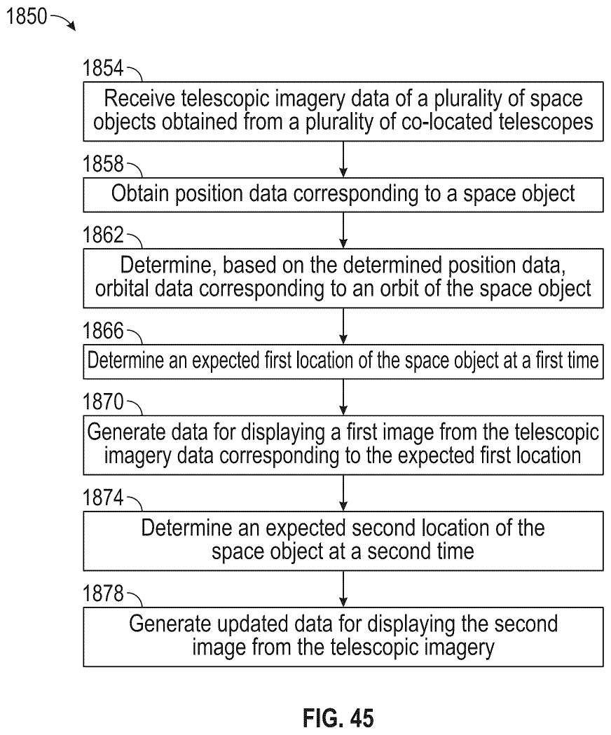

FIG. 45 shows another example method 1850, according to some embodiments. The method 1850 can allow a user or system to determine a trajectory and use the trajectory to track in image using co-located sensors. At block 1854, the system can receive telescopic imagery data of a plurality of space objects. At block 1858, the system can obtain position data corresponding to one or more space objects. At block 1862 the system can determine, based on the determined position data, orbital data corresponding to one or more orbits of the one or more space objects. Additionally or alternatively, the orbital data and/or the position data may be based in part on an identifier of the one or more space objects, such as a name, owner, associated country or organization, size, and/or other identifier described herein. The orbital data and/or position data may be obtained from a look-up table (e.g., from a published table of satellites) or from previously calculated data within the system (e.g., see above regarding orbit determination).

At block 1866 the system can determine an expected initial location or position of the one or more space objects at some initial time. This initial location and initial time can correspond to initial conditions for calculating additional details about the space objects, such as a trajectory (e.g., orbit) or determining a maneuver. The system at block 1870 can generate data for displaying one or more images from the telescopic imagery data corresponding to the expected initial location. The location may be a three-dimensional coordinate (e.g., x-y-z, r-Θ-φ) in real space or a two-dimensional coordinate (e.g., x-y, r-Θ) in the display interface. At block 1874 the system can determine one or more expected locations of the one or more space objects at another (e.g., later) time. The initial and expected locations may be determined based on the determined orbital data. At block 1878, the system can generate updated data for displaying one or more additional images from the telescopic imagery corresponding to the expected location of the one or more space objects.

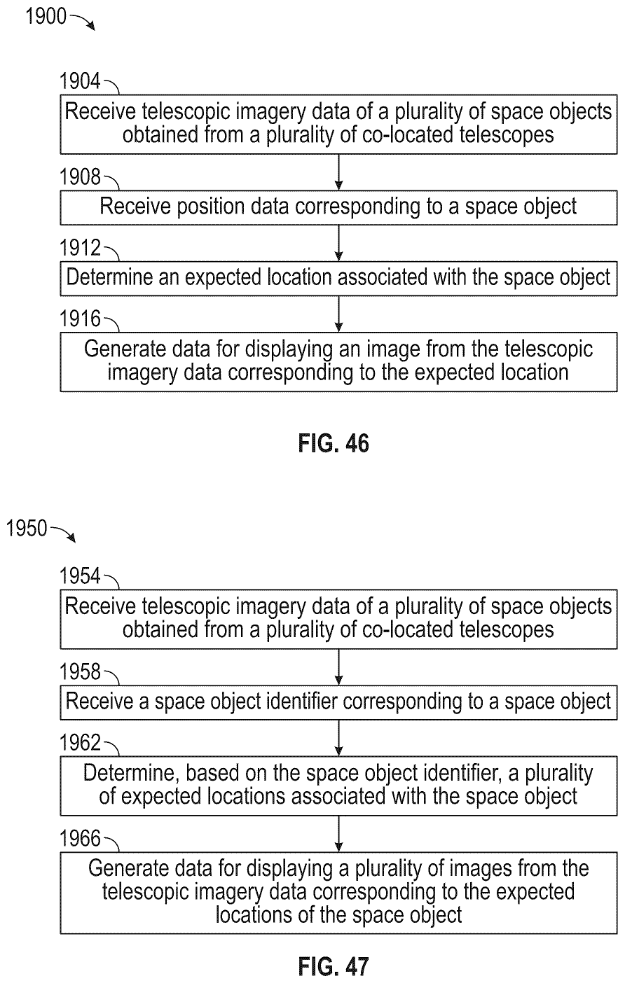

FIG. 46 shows another example method 1900, according to some embodiments. The method 1900 can allow a user to track one or more space objects using selected initial conditions (e.g., velocity, location, time, etc.). At block 1904, the system can receive telescopic imagery data of a plurality of space objects. At block 1908, the system can receive position data corresponding to one or more space objects. At block 1912, the system can determine one or more expected locations (e.g., future locations, previous locations) associated with the one or more space objects. Determining expected locations can involve calculating an orbit, calculating a maneuver, or calculating some other movement of the one or more space objects, as described above. At block 1916, the system can generate data for displaying the image from the telescopic imagery data corresponding to the expected location.

FIG. 47 shows another example method 1950, according to some embodiments. The method 1950 can allow a user or the system to track multiple “hypotheses.” Hypotheses can refer to estimated or predicted locations of a space object that may not yet have been imaged and/or at future times. Thus, the system may allow for using groups of co-located sensors (e.g., telescopes) to image multiple locations simultaneously. At block 1954, the system can receive telescopic imagery data of a plurality of space objects. At block 1958, the system can receive one or more space object identifiers corresponding to respective one or more space objects. At block 1962, the system can determine, based on the one or more space object identifiers, a plurality of expected locations associated with the space object. The expected location may additionally or alternatively be based on a determined orbit or other object trajectory. At block 1966 the system can generate data for displaying a plurality of images from the telescopic imagery data corresponding to the respective expected locations of the one or more space objects. The images may have been captured previously or may be captured in real time. The space object identifier may include a velocity vector, position, time, and/or any other identifier described herein. In some embodiments, the determination of the expected locations may include calculating an error level based on a known uncertainty in the imaging. For example, if the SNR is lower, the uncertainty may be higher. Additionally or alternatively, if the SNR is higher, the uncertainty may be lower. In some embodiments, the system can identify a plurality of images corresponding to a single expected location in order to include the expected location and surrounding areas based on the uncertainty. In some embodiments, the error level may be received via a user interface and/or a data interface.

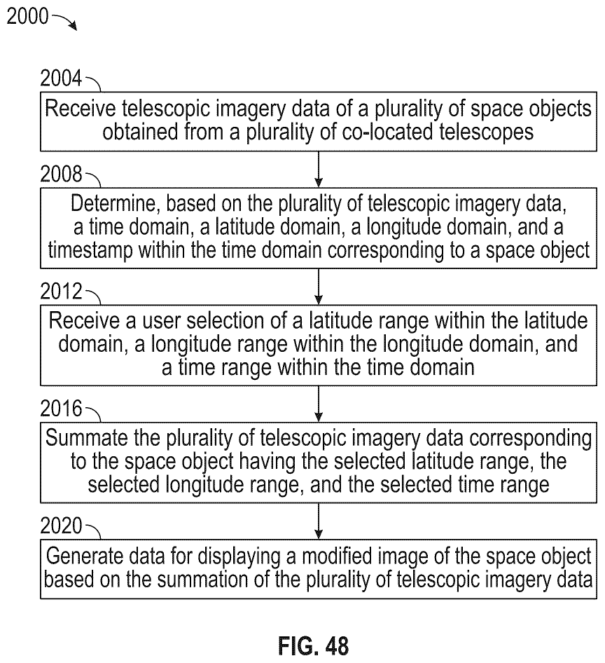

FIG. 48 shows another example method 2000, according to some embodiments. The method 2000 can allow pixel-level stacking from images obtained from multiple telescopes (e.g., using a combination of different wavelengths). At block 2004, the system can receive telescopic imagery data of a plurality of space objects. At block 2008, the system can determine, based on the plurality of telescopic imagery data, a time domain, a latitude domain, a longitude domain, and a timestamp within the time domain corresponding to a space object. At block 2012, the system can receive a user selection of a latitude range within the latitude domain, a longitude range within the longitude domain, and/or a time range within the time domain. At block 2016, the system can summate the plurality of telescopic imagery data corresponding to the space object having the selected latitude range, the selected longitude range, and the selected time range. The summation may be based on the user selections. The summation of telescopic imagery may use a single wavelength range or may include different wavelength ranges (e.g., from different telescopes/sensors at the specified wavelength range). Additional details for image summation is described herein. At block 2020, the system can generate data for displaying a modified image of the space object based on the summation of the plurality of telescopic imagery data. As discussed above, the summated or stacked image may clearer, have higher spatial resolution, have higher SNR, and/or have some other improved attribute than a single image (raw or registered) of the space object. The system may indicate where the object is, indicate the object elsewhere on the display, and/or provide other markings or indications.

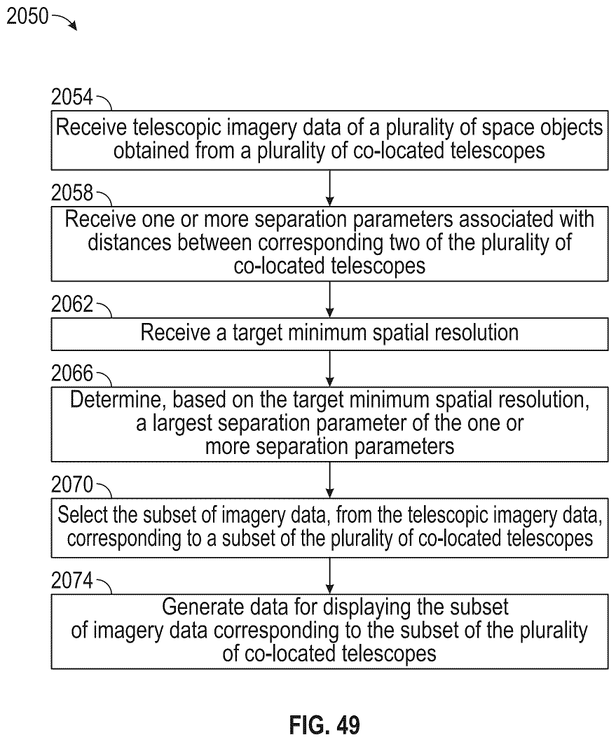

FIG. 49 shows another example method 2050, according to some embodiments. The method 2050 can allow pixel-dependent determination of which telescopes can be used, based for example on a target SNR or spatial resolution. At block 2054, the system can receive telescopic imagery data of a plurality of space objects. At block 2058, the system can receive one or more separation parameters associated with distances between corresponding two of the plurality of co-located telescopes. The separation parameter may be an indication of a maximum separation distance that exists between the furthest separated sensors/telescopes. This selection may be important for determining spatial resolution since the maximum spatial resolution may be based on the separation parameter. The system can at block 2062 receive a target minimum spatial resolution. At block 2066 the system can determine a largest separation parameter of the one or more separation parameters based on the target minimum spatial resolution. The largest separation parameter may correspond to a subset of the plurality of co-located telescopes that are separated by no more than the largest separation parameter. At block 2070, the system can select a subset of imagery data from the telescopic imagery data that corresponds to the subset of the plurality of co-located telescopes, based on the largest separation parameter. Thus, a user (or a machine model) may be able to identify which image data is available for making the target imagery, such as a stacked image. The selection may involve a tradeoff between lower intensity for higher spatial resolution or vice versa. At block 2074, the system can generate data for displaying the subset of imagery data corresponding to the subset of the plurality of co-located telescopes. The data may be displayed on one or more of the user interfaces described herein.

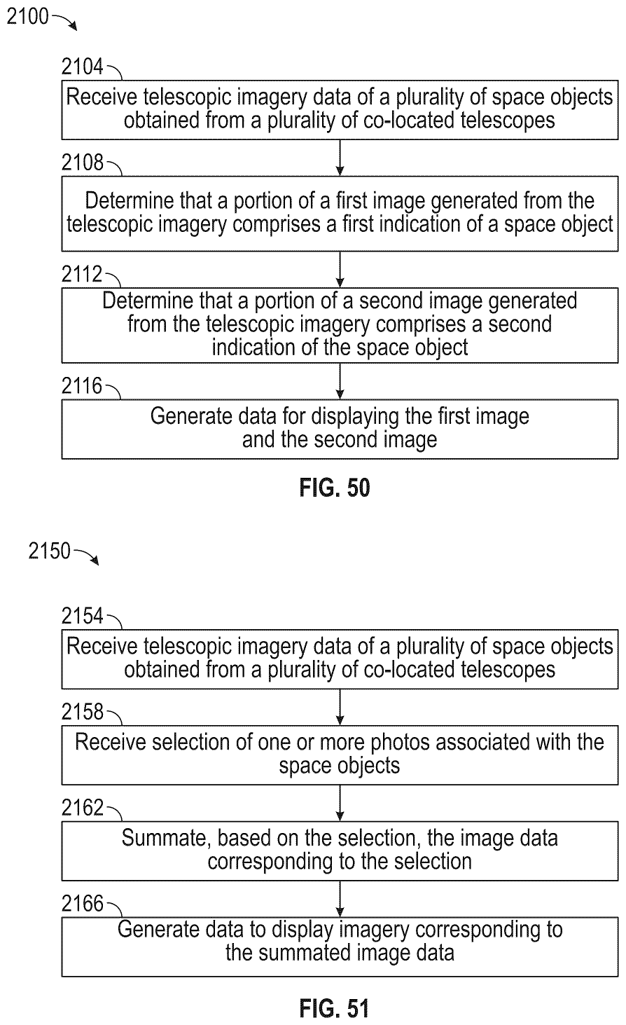

FIG. 50 shows another example method 2100, according to some embodiments. The method 2100 can allow a user to track movement of an object by selecting different subsections of an image as the space object moves. At block 2104, the system can receive telescopic imagery data of a plurality of space objects. At block 2108, the system can determine that a portion of a first image generated from the telescopic imagery comprises a first indication of a space object. The portion of the first image may be one or more image chips (e.g., image chips 1712) or some other subset of the image data. The system may be able to identify the objects automatically (e.g., using a machine model) or in response to user selection of the space object, as described herein. At block 2112, the system may determine that a portion of a second image generated from the telescopic imagery comprises a second indication of the space object. This may allow a user to track a space object within multiple images from a common network of co-located telescopes. In some embodiments, the tracking of images may be done across multiple images and/or poses/orientations of the sensors of the network of sensors. At block 2116, the system can generate data for displaying the first image and the second image. The images may be displayed together or sequentially. Additionally or alternatively, the images may be displayed within a larger image (e.g., the one of the images 1704a-e).

FIG. 51 shows another example method 2150, according to some embodiments. The method 2150 can allow the system to summate images using noncoherent light rather than coherent light (e.g., lasers). At block 2154, the system can receive telescopic imagery data of a plurality of space objects. The telescopic imagery data can include image data corresponding to photos obtained from noncoherent light. The system may be able to determine that the images have been obtained using noncoherent light. For example, the system may identify an attribute of the light that was obtained from the co-located telescopes, such as a wavelength range of the light and/or polarization of the light. The term “light” is used herein broadly to refer to any electromagnetic radiation that may be able to be sensed by co-located sensors, such as telescopes. At block 2158, the system can receive, via a user interface, selection of one or more photos associated with one or more space objects. At block 2162 the system can summate, based on the selection, the image data corresponding to the selection and, at block 2166, generate data to display imagery corresponding to the summated image data.

### Example Embodiments

Below are a number of nonlimiting example embodiments described above. These examples are for illustration purposes and should not be construed to limit the disclosure above in any way.

In a 1st Example, a system is disclosed for using a plurality of co-located telescopes to generate enhanced telescopic imagery of space objects, the system comprising: a data interface configured to receive telescopic imagery data of space objects obtained from the plurality of co-located telescopes; an interactive graphical user interface configured to receive user input; a non-transitory memory configured to store specific computer-executable instructions thereon; and a hardware processor in communication with the memory, wherein the instructions, when executed by the hardware processor, are configured to cause the system to: receive, via the data interface, the telescopic imagery data of the plurality of space objects obtained from the plurality of co-located telescopes; receive, via the interactive graphical user interface, a user selection of at least two of a plurality of imaging criteria, wherein the at least two of the plurality of imaging criteria comprise: a target signal sensitivity comprising a minimum signal to noise ratio (SNR); a target number of spectral bands comprising a minimum number of spectral bands; a spectral range associated with one or more of the spectral bands; a location of the plurality of co-located telescopes; a target data cadence comprising a minimum number of frames per minute; a target number of space objects to be tracked; or a target minimum spatial resolution; and generate, based on the least two of the plurality of imaging criteria, enhanced telescopic imagery using telescopic imagery of the plurality of space objects received, via the data interface, from the plurality of telescopes.

In a 2nd Example, the system of Example 1, generating the enhanced telescopic imagery comprises receiving the telescopic imagery of the plurality of space objects from the plurality of telescopes.

In a 3rd Example, the system of any of Examples 1-2, further comprising the plurality of co-located telescopes.

In a 4th Example, the system of any of Examples 1-3, wherein the instructions, when executed by the hardware processor, are further configured to cause the system to: determine, based on the at least two imaging criteria, updated position or velocity information associated with at least one space object within the telescopic imagery.

In a 5th Example, the system of any of Examples 1-4, wherein the instructions, when executed by the hardware processor, are further configured to cause the system to: transmit, via the data interface, instructions to the plurality of telescopes based on the plurality of imaging criteria.

In a 6th Example, a system for using a plurality of co-located telescopes to generate updated data for displaying modified one or more images, the system comprising: a data interface configured to receive telescopic imagery data of space objects obtained from the plurality of co-located telescopes; a non-transitory memory configured to store specific computer-executable instructions thereon; and a hardware processor in communication with the memory, wherein the instructions, when executed by the hardware processor, are configured to cause the system to: receive, via the data interface, the telescopic imagery data of the plurality of space objects; generate data for displaying, via a user interface, a plurality of images from the telescopic imagery data; receive, via the use interface, user selection of first one or more images of the plurality of images; receive, via the user interface, user selection of at least two of a plurality of imaging criteria, wherein the at least two of the plurality of imaging criteria comprise: a target signal sensitivity comprising a minimum signal to noise ratio (SNR); a target number of spectral bands comprising a minimum number of spectral bands; a spectral range associated with one or more of the spectral bands; a location of the plurality of co-located telescopes; a target data cadence comprising a minimum number of frames per minute; a target number of space objects to be tracked; or a target minimum spatial resolution; and generate, based on the at least two imaging criteria, the updated data for displaying the modified one or more images.

In a 7th Example, the system of Example 6, wherein the at least two imaging criteria comprise the target number of space objects to be tracked, and wherein the modified one or more images comprises a portion of the first one or more images.

In an 8th Example, the system of any of Examples 6-7, wherein the at least two imaging criteria comprise the target minimum spatial resolution.

In a 9th Example, the system of Example 8, wherein the modified one or more images correspond to a lower signal to noise ratio than the first one or more images based on the minimum spatial resolution.

In a 10th Example, the system of any of Examples 8-9, wherein generating the updated data for displaying the modified one or more images comprises reducing a frequency of image generation based on the target minimum spatial resolution.

In a 11th Example, a system for using a plurality of co-located telescopes to generate, based on orbital data, data for displaying images corresponding to expected locations of a space object, the system comprising: a space object data interface configured to receive telescopic imagery data of a plurality of space objects obtained from the plurality of co-located telescopes; a non-transitory memory configured to store specific computer-executable instructions thereon; and a hardware processor in communication with the memory, wherein the instructions, when executed by the hardware processor, are configured to cause the system to: receive, via the space object data interface, the telescopic imagery data of the plurality of space objects obtained from the plurality of co-located telescopes; obtain position data corresponding to a space object of the plurality of space objects; determine, based on the position data, orbital data corresponding to an orbit of the space object; determine an expected first location of the space object at a first time; generate data for displaying a first image from the telescopic imagery data corresponding to the expected first location; determine an expected second location of the space object at a second time, wherein the first and second locations are determined based on the determined orbital data; and generate updated data for displaying the second image from the telescopic imagery.

In a 12th Example, the system of Example 11, wherein generating the data for displaying the first image is based on the position data.

In a 13th Example, the system of any of Examples 11-12, wherein obtaining the position data corresponding to the first space object comprises determining respective time data corresponding to the position data.

In a 14th Example, the system of any of Examples 11-13, wherein obtaining the position data corresponding to the space object comprises receiving the position data via the space object data interface.

In a 15th Example, the system of any of Examples 11-14, further comprising a user interface configured to receive user input.

In a 16th Example, the system of Example 15, wherein obtaining the position data corresponding to the space object comprises receiving the position data via the user interface.

In a 17th Example, the system of any of Examples 15-16, wherein obtaining the position data corresponding to the space object comprises: receiving, via the user interface, a space object identifier associated with the space object; and determining, based on the space object identifier, the position data corresponding to the space object.

In a 18th Example, the system of any of Examples 15-17, wherein determining the orbital data comprises: receiving, via the user interface, user selection of an orbit determination selector.

In a 19th Example, the system of any of Examples 15-18, wherein the instructions, when executed by the hardware processor, are further configured to cause the system to: receive, via the user interface, a user selection of one or more imaging criteria.

In a 20th Example, the system of Example 19, wherein generating the updated data for displaying the second image from the telescopic imagery comprises generating enhanced telescopic imagery based on the one or more imaging criteria.

In a 21st Example, a system for using a plurality of co-located telescopes to generate data for displaying an image corresponding to an expected location, the system comprising: a space object data interface configured to receive telescopic imagery data of a plurality of space objects obtained from the plurality of co-located telescopes; an interactive graphical user interface configured to receive user input; a non-transitory memory configured to store specific computer-executable instructions thereon; and a hardware processor in communication with the memory, wherein the instructions, when executed by the hardware processor, are configured to cause the system to: receive, via the space object data interface, the telescopic imagery data of the plurality of space objects obtained from the plurality of co-located telescopes; receive, via the interactive graphical user interface, position data corresponding to a space object of the plurality of space objects; determine the expected location associated with the space object; and generate data for displaying the image from the telescopic imagery data corresponding to the expected location.

In a 22nd Example, a system for using a plurality of co-located telescopes to generate data for displaying a plurality of images corresponding to expected locations of a space object, the system comprising: a space object data interface configured to receive telescopic imagery data of a plurality of space objects obtained from the plurality of co-located telescopes; a non-transitory memory configured to store specific computer-executable instructions thereon; and a hardware processor in communication with the memory, wherein the instructions, when executed by the hardware processor, are configured to cause the system to: receive, via the space object data interface, the telescopic imagery data of the plurality of space objects obtained from the plurality of co-located telescopes; receive a space object identifier corresponding to the space object of the plurality of space objects; determine, based on the space object identifier, a plurality of expected locations associated with the space object; and generate the data for displaying the plurality of images from the telescopic imagery data corresponding to the respective expected locations of the space object.

In a 23rd Example, the system of Example 22, wherein the space object identifier is received via an interactive graphical user interface.

In a 24th Example, the system of any of Examples 22-23, wherein the space object identifier comprises position data corresponding to the space object.

In a 25th Example, the system of any of Examples 22-24, wherein the space object identifier comprises time data corresponding to the space object.

In a 26th Example, the system of any of Examples 22-25, wherein the space object identifier comprises a velocity vector corresponding to the space object.

In a 27th Example, the system of any of Examples 22-26, further comprising an interactive graphical user interface configured to receive user input.

In a 28th Example, the system of any of Examples 22-27, wherein the instructions, when executed by the hardware processor, are further configured to cause the system to: obtain an error level associated with the space object identifier.

In a 29th Example, the system of Example 28, wherein determining the plurality of expected locations is further based on the error level associated with the space object identifier.

In a 30th Example, the system of Example 29, wherein obtaining the error level associated with the space object identifier comprises receiving, via a user interface, the error level.

In a 31st Example, the system of any of Examples 22-30, wherein determining the plurality of expected locations associated with the space object comprises determining, based on the space object identifier, orbital data corresponding to an orbit of the space object.

In a 32nd Example, the system of Example 31, wherein determining the plurality of expected locations associated with the space object is based on the determined orbital data.

In a 33rd Example, a system for summing a plurality of telescopic imagery data corresponding to a space object obtained from a plurality of co-located telescopes, the system comprising: a space object data interface configured to receive a plurality of telescopic imagery data of a space object obtained from a plurality of co-located telescopes a non-transitory memory configured to store specific computer-executable instructions thereon; a hardware processor in communication with the memory, wherein the instructions, when executed by the hardware processor, are configured to: receive, via the space object data interface, the plurality of telescopic imagery data of the space object obtained from the plurality of co-located telescopes; determine, based on the plurality of telescopic imagery data, a time domain, a latitude domain, a longitude domain, and a timestamp within the time domain corresponding to a space object; receive a user selection of a latitude range within the latitude domain, a longitude range within the longitude domain, and a time range within the time domain; in response to the user selection, summate the plurality of telescopic imagery data corresponding to the space object having the selected latitude range, the selected longitude range, and the selected time range; and generate data for displaying a modified image of the space object based on the summation of the plurality of telescopic imagery data.

In a 34th Example, the system of Example 33, wherein the instructions, when executed by the hardware processor, are configured to cause the system to: display a marker indicating a location of the object within the modified image.

In a 35th Example, the system of any of Examples 33-34, wherein a first set of the telescopic imagery comprises a first wavelength range and wherein a second set of the telescopic imagery comprises a second wavelength range.

In a 36th Example, the system of Example 35, wherein the first set of the telescopic imagery comprises data from noncoherent light.

In a 37th Example, a system for generating data for displaying a subset of imagery data corresponding to a subset of a plurality of co-located telescopes, the system comprising: a data interface configured to receive telescopic imagery data of a plurality of space objects obtained from the plurality of co-located telescopes; a non-transitory memory configured to store specific computer-executable instructions thereon; and a hardware processor in communication with the memory, wherein the instructions, when executed by the hardware processor, are configured to cause the system to: receive, via the data interface, the telescopic imagery data of the plurality of space objects obtained from the plurality of co-located telescopes; receive, via the data interface, one or more separation parameters associated with distances between corresponding two of the plurality of co-located telescopes; receive a target minimum spatial resolution; determine, based on the target minimum spatial resolution, a largest separation parameter of the one or more separation parameters, the largest separation parameter corresponding to a subset of the plurality of co-located telescopes having no distance between any two of the subset of the co-located telescopes greater than the largest separation parameter; select the subset of imagery data, from the telescopic imagery data, corresponding to the subset of the plurality of co-located telescopes; and generate data for displaying the subset of imagery data corresponding to the subset of the plurality of co-located telescopes.

In a 38th Example, the system of Example 37, further comprising a user interface configured to receive user input.

In a 39th Example, the system of Example 38, wherein receiving a target minimum spatial resolution comprises receiving the target minimum spatial resolution via the user interface.

In a 40th Example, a system for determining that portions of first and second images comprise corresponding first and second indications of a space object using a plurality of co-located telescopes, the system comprising: a data interface configured to receive telescopic imagery data of a plurality of space objects obtained from the plurality of co-located telescopes; a non-transitory memory configured to store specific computer-executable instructions thereon; and a hardware processor in communication with the memory, wherein the instructions, when executed by the hardware processor, are configured to cause the system to: receive, via the data interface, the telescopic imagery data of the plurality of space objects obtained from the plurality of co-located telescopes; determine that the portion of a first image generated from the telescopic imagery comprises the first indication of the space object; determine that the portion of a second image generated from the telescopic imagery comprises the second indication of the space object; and generate data for displaying the first image and the second image.

In a 41st Example, the system of Example 40, wherein the instructions, when executed by the hardware processor, are further configured to cause the system to: determine a trajectory of the space object, wherein determining that the portions of the first and second images comprise the corresponding first and second indications of the space object is based on the determined trajectory of the space object.

In a 42nd Example, the system of Example 41, wherein determining the trajectory of the space object comprises determining position data associated with the space object at two or more times.

In a 43rd Example, the system of Example 42, wherein the instructions, when executed by the hardware processor, are further configured to cause the system to: generate data for displaying a first image from the telescopic imagery data corresponding to a first time of the two or more times; and generate data for displaying a second image from the telescopic imagery data corresponding to a second time of the two or more times.

In a 44th Example, the system of any of Examples 41-43, wherein determining the trajectory of the space object comprises determining an orbit of the space object.

In a 45th Example, a system for summating image data corresponding to noncoherent light obtained from imagery data corresponding to a subset of a plurality of co-located telescopes, the system comprising: a data interface configured to receive telescopic imagery data of a plurality of space objects obtained from the plurality of co-located telescopes; a non-transitory memory configured to store specific computer-executable instructions thereon; and a hardware processor in communication with the memory, wherein the instructions, when executed by the hardware processor, are configured to cause the system to: receive, via the data interface, the telescopic imagery data of the plurality of space objects obtained from the plurality of co-located telescopes, the telescopic imagery data comprising image data corresponding to photos obtained from noncoherent light; receive, via a user interface, selection of one or more photos associated with the space objects; summate, based on the selection, the image data corresponding to the selection; and generate data to display imagery corresponding to the summated image data.

In a 46th Example, the system of Example 45, wherein the instructions, when executed by the hardware processor, are further configured to cause the system to: identify, based on the summated image data, a space object within the imagery or within the one or more photos.

In a 47th Example, the system of Example 46, wherein the instructions, when executed by the hardware processor, are further configured to cause the system to: update the data to display an indication of the space object within the imagery.

In a 48th Example, a system for generating enhanced imagery, the system comprising: a plurality of co-located telescopes; a data interface configured to transmit enhanced imagery to a remote computing device; a non-transitory memory configured to store specific computer-executable instructions thereon; and a hardware processor in communication with the memory, wherein the instructions, when executed by the hardware processor, are configured to cause the system to: obtain, using the plurality of co-located telescopes, first and second subsets of telescopic imagery of a plurality of space objects, the first and second subsets of the telescopic imagery having respective first and second measurable attributes; determine respective arrangements of the first and second subsets of the telescopic imagery; modify the arrangement of the first subset of the telescopic imagery to match an arrangement of the second subset of the telescopic imagery; generate the enhanced imagery by summating the first and second subsets of the telescopic imagery based on the arrangements of the first and second subsets of the telescopic imagery, wherein the enhanced imagery has an enhanced measurable attribute greater than both the first and second measurable attributes; and transmit, via the data interface, the enhanced imagery of the target space object to a remote computing device.

In a 49th Example, the system of Example 48, wherein the instructions, when executed by the hardware processor, are further configured to cause the system to: identify an indication of a target space object in each of first and second subsets of the telescopic imagery, wherein the enhanced imagery comprises an enhanced indication of the target space object.

In a 50th Example, the system of Example 49, wherein the enhanced measurable attribute comprises at least one of: a signal to noise ratio (SNR) or a spatial resolution of the target space object.

In a 51st Example, the system of any of Examples 48-50, wherein modifying the arrangement of the first subset of the telescopic imagery to match the arrangement of the second subset of the telescopic imagery comprises modifying an orientation of the first subset of the telescopic imagery.

In a 52nd Example, the system of any of Examples 48-51, wherein modifying the arrangement of the first subset of the telescopic imagery to match the arrangement of the second subset of the telescopic imagery comprises modifying a magnification level of the first subset of the telescopic imagery.

In a 53rd Example, the system of any of Examples 48-52, wherein the instructions, when executed by the hardware processor, are further configured to cause the system to: identify a set of indications of stars within the first or second subsets of the telescopic imagery; and subtract imagery data corresponding to the set of indications of the stars.

In a 54th Example, the system of any of Examples 48-53, wherein the instructions, when executed by the hardware processor, are further configured to cause the system to: receive, via the data interface, one or more imaging criteria, wherein the one or more imaging criteria comprise: a target signal sensitivity comprising a minimum signal to noise ratio (SNR); a target number of spectral bands comprising a minimum number of spectral bands; an optical spectral range associated with one or more of the spectral bands; a location of the plurality of co-located telescopes; a target data cadence comprising a minimum number of frames per minute; a target number of space objects to be tracked; and a target minimum spatial resolution.

In a 55th Example, the system of any of Examples 48-54, wherein summating the first and second subsets of the telescopic imagery is further based on the one or more imaging criteria.

### Other Considerations

Reference throughout this specification to “some embodiments” or “an embodiment” means that a particular feature, structure or characteristic described in connection with the embodiment is included in at least some embodiments. Thus, appearances of the phrases “in some embodiments” or “in an embodiment” in various places throughout this specification are not necessarily all referring to the same embodiment and may refer to one or more of the same or different embodiments. Furthermore, the particular features, structures or characteristics may be combined in any suitable manner, as would be apparent to one of ordinary skill in the art from this disclosure, in one or more embodiments.

As used in this application, the terms “comprising,” “including,” “having,” and the like are synonymous and are used inclusively, in an open-ended fashion, and do not exclude additional elements, features, acts, operations, and so forth. Also, the term “or” is used in its inclusive sense (and not in its exclusive sense) so that when used, for example, to connect a list of elements, the term “or” means one, some, or all of the elements in the list.

Similarly, it should be appreciated that in the above description of embodiments, various features are sometimes grouped together in a single embodiment, figure, or description thereof for the purpose of streamlining the disclosure and aiding in the understanding of one or more of the various inventive aspects. This method of disclosure, however, is not to be interpreted as reflecting an intention that any claim require more features than are expressly recited in that claim. Rather, inventive aspects lie in a combination of fewer than all features of any single foregoing disclosed embodiment. Accordingly, no feature or group of features is necessary or indispensable to each embodiment.

Embodiments of the disclosed systems and methods may be used and/or implemented with local and/or remote devices, components, and/or modules. The term “remote” may include devices, components, and/or modules not stored locally, for example, not accessible via a local bus. Thus, a remote device may include a device which is physically located in the same room and connected via a device such as a switch or a local area network. In other situations, a remote device may also be located in a separate geographic area, such as, for example, in a different location, building, city, country, and so forth.

Methods and processes described herein may be embodied in, and partially or fully automated via, software code modules executed by one or more general and/or special purpose computers. The word “module” refers to logic embodied in hardware and/or firmware, or to a collection of software instructions, possibly having entry and exit points, written in a programming language, such as, for example, C or C++. A software module may be compiled and linked into an executable program, installed in a dynamically linked library, or may be written in an interpreted programming language such as, for example, BASIC, Perl, or Python. It will be appreciated that software modules may be callable from other modules or from themselves, and/or may be invoked in response to detected events or interrupts. Software instructions may be embedded in firmware, such as an erasable programmable read-only memory (EPROM). It will be further appreciated that hardware modules may comprise connected logic units, such as gates and flip-flops, and/or may comprise programmable units, such as programmable gate arrays, application specific integrated circuits, and/or processors. The modules described herein may be implemented as software modules, or may be represented in hardware and/or firmware. Moreover, although in some embodiments a module may be separately compiled, in other embodiments a module may represent a subset of instructions of a separately compiled program, and may not have an interface available to other logical program units.

In certain embodiments, code modules may be implemented and/or stored in any type of non-transitory computer-readable medium or other non-transitory computer storage device. In some systems, data (and/or metadata) input to the system, data generated by the system, and/or data used by the system can be stored in any type of computer data repository, such as a relational database and/or flat file system. Any of the systems, methods, and processes described herein may include an interface configured to permit interaction with patients, health care practitioners, administrators, other systems, components, programs, and so forth.

A number of applications, publications, and external documents may be incorporated by reference herein. Any conflict or contradiction between a statement in the body text of this specification and a statement in any of the incorporated documents is to be resolved in favor of the statement in the body text.

Although described in the illustrative context of certain preferred embodiments and examples, it will be understood by those skilled in the art that the disclosure extends beyond the specifically described embodiments to other alternative embodiments and/or uses and obvious modifications and equivalents. Thus, it is intended that the scope of the example embodiments which follow should not be limited by the particular embodiments described above.

What is claimed:

1. A system for using a plurality of co-located telescopes to generate enhanced telescopic imagery of a plurality of space objects, the system comprising:
a data interface configured to receive telescopic imagery data of space objects obtained from the plurality of co-located telescopes;
an interactive graphical user interface configured to receive user input;
a non-transitory memory configured to store specific computer-executable instructions thereon; and
a hardware processor in communication with the non-transitory memory, wherein the instructions, when executed by the hardware processor, are configured to cause the system to:
receive, via the data interface, the telescopic imagery data of the plurality of space objects obtained from the plurality of co-located telescopes;
receive, via the interactive graphical user interface, a user selection of at least two imaging criteria of a plurality of imaging criteria, wherein the plurality of imaging criteria comprise:
a target signal sensitivity comprising a minimum signal to noise ratio (SNR);
a target number of spectral bands comprising a minimum number of spectral bands;
an optical spectral range associated with one or more of the target number of spectral bands;
a location of the plurality of co-located telescopes;
a target data cadence comprising a minimum number of frames per minute;
a target number of space objects to be tracked; and
a target minimum spatial resolution; and
generate, based on the at two least imaging criteria, enhanced telescopic imagery using telescopic imagery of the plurality of space objects received, via the data interface, from the plurality of telescopes.

2. The system of claim 1, wherein generating the enhanced telescopic imagery comprises receiving the telescopic imagery of the plurality of space objects from the plurality of telescopes.

3. The system of claim 1, further comprising the plurality of co-located telescopes.

4. The system of claim 1, wherein the instructions, when executed by the hardware processor, are further configured to cause the system to:
determine, based on the at least two imaging criteria, updated position or velocity information associated with at least one space object within the telescopic imagery.

5. The system of claim 1, wherein the instructions, when executed by the hardware processor, are further configured to cause the system to:
transmit, via the data interface, instructions to the plurality of telescopes based on the plurality of imaging criteria.

6. The system of claim 1, wherein the instructions, when executed by the hardware processor, are further configured to cause the system to:
receive, via the interactive graphical user interface, user selection of a space object of the plurality of space objects,
wherein the at least two imaging criteria comprise the target number of space objects to be tracked, and wherein the enhanced telescopic imagery comprises a portion of the telescopic imagery associated with the space object.

7. The system of claim 6, wherein the instructions, when executed by the hardware processor, are configured to cause the system to:
display a marker indicating a location of the space object within the enhanced telescopic imagery.

8. The system of claim 6, wherein the instructions, when executed by the hardware processor, are further configured to cause the system to:
determine a trajectory of the space object.

9. The system of claim 8, wherein the instructions to determine the trajectory of the space object, when executed by the hardware processor, are further configured to cause the system to:
determine position data associated with the space object at two or more times, wherein the position data is determined based on the telescopic imagery.

10. The system of claim 1, wherein the enhanced telescopic imagery corresponds to a lower signal to noise ratio than the telescopic imagery data.

11. The system of claim 1, wherein a first set of the telescopic imagery comprises a first wavelength range and wherein a second set of the telescopic imagery comprises a second wavelength range.

12. The system of claim 11, wherein the first set of the telescopic imagery comprises data from noncoherent light.

13. The system of claim 1, wherein the plurality of co-located telescopes is determined to be co-located based on each telescope of the plurality of telescopes being located within a threshold distance of a neighboring telescope of the plurality of telescopes.

14. The system of claim 13, wherein the threshold distance is determined based in part on a desired minimum pixel size over a field of view.

15. The system of claim 13, wherein the threshold distance is determined based in part on an altitude of a target space object.

16. A method for using a plurality of co-located telescopes to generate enhanced telescopic imagery of space objects, the method comprising:
receiving, via a data interface, telescopic imagery data of a plurality of space objects obtained from the plurality of co-located telescopes;
receiving, via an interactive graphical user interface, a user selection of at least two imaging criteria of a plurality of imaging criteria; and
generating, based on the at least two imaging criteria, enhanced telescopic imagery using telescopic imagery of the plurality of space objects received, via the data interface, from the plurality of telescopes.

17. The method of claim 16, wherein the plurality of imaging criteria comprises:
a target signal sensitivity comprising a minimum signal to noise ratio (SNR);
a target number of spectral bands comprising a minimum number of spectral bands;
an optical spectral range associated with one or more of the target number of spectral bands;
a location of the plurality of co-located telescopes;
a target data cadence comprising a minimum number of frames per minute;
a target number of space objects to be tracked; and
a target minimum spatial resolution.

18. The method of claim 16 further comprising:
determining, based on the at least two imaging criteria, updated position or velocity information associated with at least one space object within the telescopic imagery.

19. The method of claim 16 further comprising:
transmit, via the data interface, instructions to the plurality of telescopes based on the plurality of imaging criteria.

20. The method of claim 16 further comprising:
receiving, via the interactive graphical user interface, user selection of a space object of the plurality of space objects,
wherein the at least two imaging criteria comprise a target number of space objects to be tracked, and wherein the enhanced telescopic imagery comprises a portion of the telescopic imagery associated with the space object.

21. The method of claim 20 further comprising:
displaying, via the interactive graphical user interface, a marker indicating a location of the space object within the enhanced telescopic imagery.

22. The method of claim 20 further comprising:
determining a trajectory of the space object.

23. The method of claim 22, wherein determining the trajectory of the space object further comprises:
determining position data associated with the space object at two or more times, wherein the position data is determined based on the telescopic imagery.

24. The method of claim 16, wherein the enhanced telescopic imagery corresponds to a lower signal to noise ratio than the telescopic imagery data.

25. The method of claim 16, wherein a first set of the telescopic imagery comprises a first wavelength range and wherein a second set of the telescopic imagery comprises a second wavelength range.

26. The method of claim 25, wherein the first set of the telescopic imagery comprises data from noncoherent light.
